(19) United States
(12) Patent Application Publication
(10) Pub. No.: US 2025/0278783 A1
(43) Pub. Date: Sep. 4, 2025

(54) SYSTEMS AND METHODS FOR CLEARANCE PLATFORM OPERATIONS

(71) Applicant: GRAINCHAIN, INC., McAllen, TX (US)

(72) Inventor: Fernando Campos, McAllen, TX (US)

(21) Appl. No.: 19/034,419

(22) Filed: Jan. 22, 2025

Related U.S. Application Data
(60) Provisional application No. 63/623,795, filed on Jan. 22, 2024.
(60) Provisional application No. 63/697,742, filed on Sep. 23, 2024.

(51) Int. Cl. G06Q 40/02; G06Q 20/38; G06Q 20/40; G06Q 20/42

(52) U.S. Cl. CPC G06Q 40/02; G06Q 20/3825; G06Q 20/401; G06Q 20/42

(57) ABSTRACT

This disclosure provides systems, methods, and apparatuses, including computer programs encoded on computer storage media, for implementing a clearance service. In some aspects, a method includes obtaining first agreement data associated with an agreement between a first user and a second user. The method further includes verifying that the agreement data is valid based on a first input associated with the first user, a second input associated with the second user, or a combination thereof. The method also includes, after verification of the agreement, sending a request to create, at an institution server, a financial account associated with the agreement. The method includes storing, at a database, entry information at an entry associated with the agreement. The entry information indicates the first user, the second user, the agreement data, the financial account, or a combination thereof.

### CROSS-REFERENCE TO RELATED APPLICATIONS

This application claims the benefit of U.S. Provisional Application No. 63/623,795, filed Jan. 22, 2024, and titled “SYSTEM AND METHODS FOR CLEARANCE PLATFORM OPERATIONS”, and U.S. Provisional Application No. 63/697,742, filed Sep. 23, 2024, and titled “SYSTEM AND METHODS FOR CLEARANCE PLATFORM OPERATIONS”, the contents of each of which is incorporated into the present application by reference in its entirety.

### TECHNICAL FIELD

Aspects of the present disclosure relate generally to implementing a clearance functionality and more particularly, but not by way of limitation, to systems and methods for implementing a clearance platform system. Some features may enable and provide for increased security, increased data integrity and transparency, information and/or document verification, immutable records, decentralization, smart contracts, verification (e.g., enhanced verification), reduced counterparty risks, efficient dispute resolution, data encryption, reduced operational risk, traceability, or a combination thereof.

### BACKGROUND

For a conventional forward contract, a producer executes a forward contract with an offtaker, such as a forward contract to deliver a future commodity at a certain price at a certain date. The producer may need one or more resources (e.g., one or more inputs) to produce an output associated with the contract. For example, if the output is a commodity, such as a crop, the producer may need to acquire seeds, fertilizer, equipment, or a combination thereof, to produce the crop. The producer may purchase the one or more resources from a provider. In some situations, the producer may lack sufficient funds or credit to purchase the one or more resources from the provider. In some such situations, the producer may offer a lien instrument, a reassignment of payment, or a combination thereof, to the provider. The lien instrument, the reassignment of payment, or both may be associated with or correspond to the forward contract and may enable the provider to receive payment from the offtaker for the one or more resources that the producer purchases from the provider. The offtaker may charge a fee, such as a percentage of the purchase amount of the one or more resources, and the fee may be taken out of the purchase amount.

The process for the conventional forward contact may suffer from a variety of issues. For example, the provider must determine the authenticity and validity of the forward contract between the producer and the offtaker. As a further example, the offtaker may set and/or adjust the fee to be taken out of the purchase price and the producer/provider may have limited or no negotiating power or enforcement power. As another example, the provider must rely on the offtaker to make the payment to the provider based on delivery/receipt of the commodity. If the offtaker does not provide payment to the provider, the provider has to waste time and resources to receive payment. As yet another example, in some situations, multiple providers may execute multiple lien instruments and/or multiple reassignments of payment with respect to the same forward contract and the providers may not be informed of the other providers. As another example, the executed forward contract, the lien instrument, and/or the assignment of payment may become lost or misplaced and result in a delay of payment or non-payment to the producer or the provider. Additionally, payments made based on the forward contract, the lien instrument, and/or the assignment of payment may be made through use of a bank (or a banking system) which has little to no insight or understanding of the underlying contractual obligations. Thus, the conventional forward contract process may include or result in a lack of data/information security, a lack of data integrity and transparency, fraud or lack of document retention, high counterparty risks, expensive and costly dispute resolution, lack of data encryption and data safeguards, operational risk, lack of traceability, or a combination thereof.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method, performed by a first computing device, for implementing a clearance service. The method includes obtaining first agreement data associated with a first agreement between a first user and a second user. The method further includes verifying that the first agreement data associated with the first agreement is valid based on a first input received from a first device associated with the first user, a second input received from a second device associated with the second user, or a combination thereof. The method also includes, after verification of the first agreement, sending a request to create, at an institution server, a financial account associated with the first agreement. The method includes storing, at a database, first entry information at a first entry associated with the first agreement. The first entry information indicates the first user, the second user, the first agreement data, the financial account, or a combination thereof.

Another innovative aspect of the subject matter described in this disclosure can be implemented in an electronic device, such as a server. The electronic device includes at least one processor and a memory coupled with the at least one processor. The memory stores processor-readable instructions that, when executed by the at least one processor, cause the at least one processor to obtain first agreement data associated with a first agreement between a first user and a second user. The instructions, when executed by the at least one processor, further cause the at least one processor to verify that the first agreement data associated with the first agreement is valid based on a first input received from a first device associated with the first user, a second input received from a second device associated with the second user, or a combination thereof. The instructions, when executed by the at least one processor, also cause the at least one processor to, after verification of the first agreement, send a request to create, at an institution server, a financial account associated with the first agreement. The instructions, when executed by the at least one processor, cause the at least one processor to store, at a database, first entry information at a first entry associated with the first agreement. The first entry information indicates the first user, the second user, the first agreement data, the financial account, or a combination thereof.

Another innovative aspect of the subject matter described in this disclosure can be implemented in a non-transitory computer-readable medium that stores instructions. The instructions, when executed by a processor, cause the processor to perform operations that include obtaining first agreement data associated with a first agreement between a first user and a second user. The operations further include verifying that the first agreement data associated with the first agreement is valid based on a first input received from a first device associated with the first user, a second input received from a second device associated with the second user, or a combination thereof. The operations also include, after verification of the first agreement, sending a request to create, at an institution server, a financial account associated with the first agreement. The operations also include storing, at a database, first entry information at a first entry associated with the first agreement. The first entry information indicates the first user, the second user, the first agreement data, the financial account, or a combination thereof.

Another innovative aspect of the subject matter described in this disclosure can be implemented in a method, performed by a first computing device, for implementing a clearance service. The method includes identifying a financial account at an institution server, the financial account associated with a first agreement between a first user and a second user. The first user is a beneficiary of the financial account and an entity associated with the first computing device has agency over the financial account. The method also includes identifying a transfer made to the financial account. The method further includes, after identification of the transfer, sending, to the institution server, a request to perform one or more disbursements from the financial account, the one or more disbursements determined based on a first entry in a database. The first entry is associated with the first agreement and indicates the first user, the second user, first agreement data associated with the first user, the financial account, or a combination thereof. The method also includes sending a notification that indicates a first disbursement to a first account associated with the first user.

Another innovative aspect of the subject matter described in this disclosure can be implemented in an electronic device, such as a server. The electronic device includes at least one processor and a memory coupled with the at least one processor. The memory storing processor-readable instructions that, when executed by the at least one processor, cause the at least one processor to identify a financial account at an institution server, the financial account associated with a first agreement between a first user and a second user. The first user is a beneficiary of the financial account, and an entity associated with the electronic device has agency over the financial account. The instructions, when executed by the at least one processor, also cause the at least one processor to identify a transfer made to the financial account. The instructions, when executed by the at least one processor, further cause the at least one processor to, after identification of the transfer, send, to the institution server, a request to perform one or more disbursements from the financial account, the one or more disbursements determined based on a first entry in a database. The first entry is associated with the first agreement and indicates the first user, the second user, first agreement data associated with the first user, the financial account, or a combination thereof. The instructions, when executed by the at least one processor, also cause the at least one processor to send a notification that indicates a first disbursement to a first account associated with the first user.

Another innovative aspect of the subject matter described in this disclosure can be implemented in a non-transitory computer-readable medium that stores instructions. The instructions, when executed by a processor, cause the processor to perform operations that include identifying a financial account at an institution server, the financial account associated with a first agreement between a first user and a second user. The first user is a beneficiary of the financial account and an entity associated with a core server has agency over the financial account. The operations also include identifying a transfer made to the financial account. The operations further include, after identification of the transfer, sending, to the institution server, a request to perform one or more disbursements from the financial account, the one or more disbursements determined based on a first entry in a database. The first entry is associated with the first agreement and indicates the first user, the second user, first agreement data associated with the first user, the financial account, or a combination thereof. The operations also include sending a notification that indicates a first disbursement to a first account associated with the first user.

Another innovative aspect of the subject matter described in this disclosure can be implemented in a system. The system includes a clearance server configured to obtain first agreement data associated with a first agreement between a first user and a second user. The clearance server is also configured to verify that the first agreement data associated with the first agreement is valid based on a first input received from a first device associated with the first user, a second input received from a second device associated with the second user, or a combination thereof. The clearance server is further configured to, after verification of the first agreement, send a request to create, at an institution server, a financial account associated with the first agreement. The clearance server is configured to store, at a database, first entry information at a first entry associated with the first agreement. The first entry information indicates the first user, the second user, the first agreement data, the financial account, or a combination thereof. In some implementations, the system that includes the clearance server also includes a core server, the institution server, the database, or a combination thereof.

Some details associated with the implementations are described above, and others are described below. Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

A further understanding of the nature and advantages of the present disclosure may be realized by reference to the following drawings. The following drawings illustrate by way of example and not limitation. In the appended figures, similar components or features may have the same reference label.

FIG. 1A is a block diagram of an example clearance system according to one or more aspects.

FIG. 1B is a block diagram of another example clearance system according to one or more aspects.

FIG. 2 is a flow diagram illustrating an example process that supports operation of a clearance system according to one or more aspects.

FIGS. 3-8 are diagrams of example graphical user interfaces (GUIs) to illustrate operation of a clearance system according to one or more aspects.

FIG. 9 is a flow diagram illustrating another example process that supports operation of a clearance system according to one or more aspects.

FIGS. 10-17 are diagrams of example GUIs to illustrate operation of a clearance system according to one or more aspects.

FIGS. 18-23 illustrate operations of a clearance system according to one or more aspects.

FIG. 24 is a block diagram of an example clearance system according to one or more aspects.

FIG. 25 is a block diagram of an example of a system according to one or more aspects.

FIG. 26 is a flow diagram illustrating another example process that supports operation of a clearance system according to one or more aspects.

FIG. 27 is a ladder diagram illustrating an example of operations associated with a clearance system according to one or more aspects.

FIG. 28 is a ladder diagram illustrating an example of operations associated with a clearance system according to one or more aspects.

FIG. 29 is a flow diagram of an example process of a server that supports operation of a clearance system according to one or more aspects.

FIG. 30 is a flow diagram of another example process of a server that supports operation of a clearance system according to one or more aspects.

FIGS. 31-37 are diagrams of example GUIs to illustrate operation of a clearance system according to one or more aspects.

FIG. 38 is a block diagram of an example of a database of a clearance system according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatuses, methods, and computer-readable media for implementing a clearance system, such as a transitional payment account system. The clearance system (e.g., the transitional payment account system) is configured to operate with a financial institution, such as a banking system. For example, the clearance system may interact with the financial institution to provide services associated with a business chain, such as an agribusiness chain. In some implementation, the clearance system may be configured to enhance the settlement of term contracts through dynamic account creation, secure user authentication, and efficient financial transactions, leveraging both a banking infrastructure and innovative technology solutions.

In some implementations, the clearance system includes a clearance server that is configured to verify multiple users and confirm an agreement between two or more of the multiple users. The clearance server may generate an entry at a database based on the confirmed agreement. For example, the database may include a blockchain ledger and the clearance server may create an entry at the blockchain ledger. In some implementations, the clearance server generates a smart contract based on the agreement and the smart contract is stored as part of the entry. The clearance server may also initiate creation of a financial account (e.g., a fiduciary account) at a financial institution, such as a bank. In some implementations, the clearance server may provide the option to a user to select which financial institution (of multiple financial institutions) to use to create the financial account. The financial account may be associated with the agreement (e.g., the entry at the blockchain). The financial account may receive funds associated with the agreement and the clearance server may initiate a disbursement of the funds to one or more of the multiple users. For example, the clearance server may determine one or more disbursements based on the entry at the blockchain.

In some implementations, the clearance system includes a core server. The core server may be part of the clearance server or may be distinct from the clearance server. The core server is configured to provide a payment service associated with the transaction. For example, the core server may establish a transfer account (e.g., a payment transit account) that is configured to receive funds (e.g., a payment) associated with the agreement (e.g., the entry at the blockchain). The core server may provide the funds to the financial account and may initiate one or more distributions of the funds from the financial account to one or more user accounts of the multiple users. In some implementations, the core server is also configured to determine and/or deduct one or more fees associated with the funds received at the transfer account. The one or more fees may include a service fee, a regulatory fee, or a combination thereof, as illustrative, non-limiting examples.

In some implementations, a clearance system (e.g., the clearance server and/or the core server) may provide a technical solution for large financial institutions to manage lending and disbursement associated with agreements, such as forward contracts, with improved security, improved success rate, and/or heightened visibility as compared to other systems. For example, the clearance system may limit or resolve issues associated with conventional forward contracts, such as counterparty and default risks, fees, lack of transparency, etc. Additionally, or alternatively, in some implementations, the clearance system may include a self-serve platform (e.g., a third-party platform) in which there is limited interaction with a financial institution. While having limited interaction, the financial institution may have greater and more trusted visibility over an underlying transaction, e.g., know who the parties and/or counterparties are to one or more agreements.

Additionally, or alternatively, in some implementations, the clearance system can be configured to provide document management services, contract management services, or a combination thereof. The clearance system may be configured to register users and store user data, store account data (e.g., bank account data), classify and/or store document/agreement data, link different stored data, and generate and store executable applications (e.g., smart contracts). The data stored by the clearance server may be stored at a database and, optionally, may be immutably stored. The database may include a ledger, such as a blockchain. In some implementations, the clearance server is configured to receive document data from users in which the documents have different data formats, different document types, different types of data items, different data encodings, or a combination thereof. The clearance system can be configured to store the received document data (e.g., in an original format) and generate standardized document data for use in generating smart contracts. To illustrate, the clearance system may be configured to identify data items (e.g., information) included in the received documents, and to standardize the data items (e.g., the different formats, the different document types, the different types of data items, the different data encodings, or a combination thereof) to facilitate generation and/or storage of the standardized document data. The clearance system may be configured to facilitate data access to and sharing of the original document data and the standardized document data. In some implementations, the clearance server may also receive inputs from users that include or indicate data items that may also be stored at the database in a standardized format. Based on the standardized data (e.g., the standardized document data and/or the standardized input data times) stored at the database, the clearance system may generate one or more smart contracts.

Additionally, or alternatively, the clearance system may be configured to receive sensor data from one or more sensors, such as sensors related to an agribusiness supply chain, which have different sensor data formats, different sensor data types, different sensor data encodings, or a combination thereof. The clearance system can be configured to store the received sensor data (e.g., in an original format) and generate standardized sensor data for use as input to one or more smart contracts. To illustrate, the clearance system may be configured to identify sensor data items (e.g., information) included in the sensor data and to generate standardized sensor data (e.g., to standardize the different sensor data formats, the different sensor types, the different types of sensor data items, the different sensor data encodings, or a combination thereof) for storage. In some implementations, the standardized sensor data may be used as an input to a smart contract to trigger execution of at least a portion of the smart contract.

Additionally, or alternatively, the clearance system and/or the database may include one or more application programming interfaces (APIs) that enable access (e.g., authorized or permission-based access) to data stored at the database. In some implementations, the clearance system may be configured to identify a user and an authorization/access level of the user. For example, different users may have different read/write access with respect to the database and/or the clearance system. The clearance system may generate a data output for the user based on the authorization/access level of the user. Accordingly, different users of the clearance system may receive different data from the clearance system based on the authorization/access level of the user. In some implementations, a first user can request authorization or access to data associated with a second user and/or the second user can grant access to the first user to the data associated with the second user. Additionally, or alternatively, the clearance system may send notifications to different users that include data that is accessible based on the authorizations/access levels of the different users. In some examples, the notifications are based on an event, a change in status, time sensitive information, or a combination thereof. In some implementations, the notifications (e.g., push notifications) can be sent to a device, such as a smart phone, of a user. The notifications may include one or more portions of the standardized data that the respective user is authorized to access. Additionally, or alternatively, the clearance system may provide an application (e.g., a software application such as a mobile application or a desktop application) to a device of a user to enable the user to access the clearance system in a secure manner. Such applications may be configured to enable user access according to the authorization/access level of the user.

In some implementations, the clearance system is configured to generate one or more reports based on the data stored at the database. For example, a report may be generated based on the standardized data stored at the database. The report generated by the clearance system may be user-specific, transaction specific, a regulatory report, a timeline report of events or actions associated with a user or a transaction, or a combination thereof. The clearance system may also be able to determine (e.g., calculate) one or more metrics based on the standardized data. The one or more metrics may be provided to one or more users and/or used by the clearance system or a user to make a determination or a selection. For example, the clearance system may select a fee for a user based on one or more metrics associated with the user, select a server to offer or provide to the user based on the one or more metrics, or a combination thereof.

Particular implementations of the subject matter described in this disclosure can be implemented to realize one or more of the following technical advantages. In some aspects, the techniques of the present disclosure related to a clearance functionality provide a technical advantage of enhanced device interoperability, improved data processing efficiency, data validation and data integrity, and enhanced data security. For example, a clearance system may provide a process for user verification, agreement verification, standardizing data communication, fee calculation, standardizing/formatting data and/or reporting of status information, standardizing communication between devices of the clearance system, or a combination thereof. By standardizing the formatting, encoding, or both, of data related to an agreement, the clearance server may be configured to enhance an interoperability among devices associated with users that are parties to the agreement, thereby improving data coordination among multiple devices and across multiple platforms without requiring specific hardware or targeted software solutions. Additionally, the processes implemented by the clearance system may enhance data processing efficiency, data integrity, data transparency, and/or data security.

Additionally, in some implementations, the clearance system may include or enable blockchain-enabled transparency, which can improve data integrity and increase trust in automated performance of smart contracts. For example, the clearance system may include or correspond to a white label product that empowers the participants of an existing forward payment contract (in any industry) by increasing transparency for the bank and counterparties in a secure, permissioned manner. In some implementations, the clearance system is blockchain-enabled and integrated into the core banking system to drive operations.

The clearance system may also provide a scalable solution. For example, the clearance system may be applied to existing small, medium and large-scale ecosystems having supply chains with multiple participants where forward contracts are used. Additionally, or alternatively, the clearance system may allow a trusted third-party institution, such as a core banking service, a payment system/service, or a combination thereof, to facilitate transactions, improving trust and reducing risks amongst the participants while facilitating lending opportunities by financial institutions, improving underwriting capabilities with the added data points offered through the solution, or a combination thereof. Accordingly, the clearance system may also be configured to provide revenue opportunities.

The clearance system may provide a variety of improvements, such as technology improvements, that increase transparency, reduce overhead, improve data integrity, improve overall security, generate new data structures, and leverage APIs (such as REST APIs or webhooks). Use of one or more APIs may provide standardized integration points and/or specify data formats or protocols that enable interoperability between different users/entities (e.g., different devices and/or different systems). Additionally, or alternatively, the clearance system may be configured to integrate with financial institutions to enable/grant lending partners comprehensive visibility into transactions and contract specifics, thereby enhancing their capacity to offer tailored services. Such integration may also enable lending partners to benefit from increased cash flow, providing more value and innovation to the agricultural industry, and ultimately attracting new customers. In some implementations, the clearance system may enable payment recipient assurance that guarantees payment receipt through bank-administered fund allocation upon deposit into the payment clearing account. For sellers, the clearance system may facilitate loan applications for any user (e.g., sellers or buyers). To illustrate, the clearance system may facilitate loan applications for a user using future income projections (post-payment clearing account setup). Additionally, or alternatively, for offtakers, the clearance system may streamline the payment process by automating the disbursement to various parties, thereby simplifying the offtaker's role.

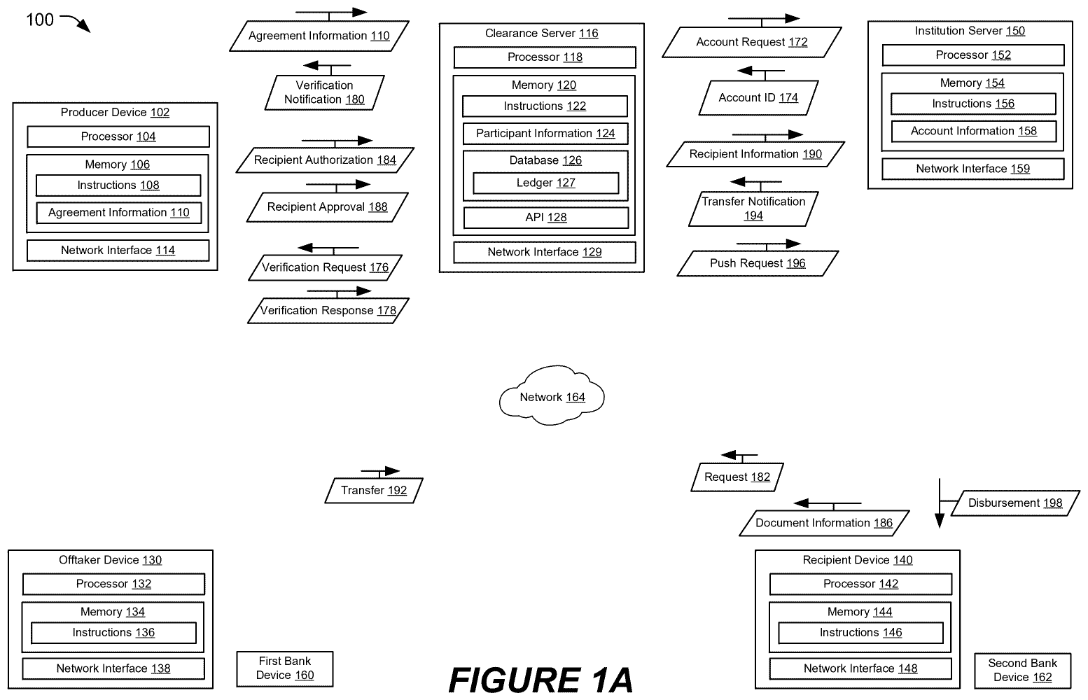

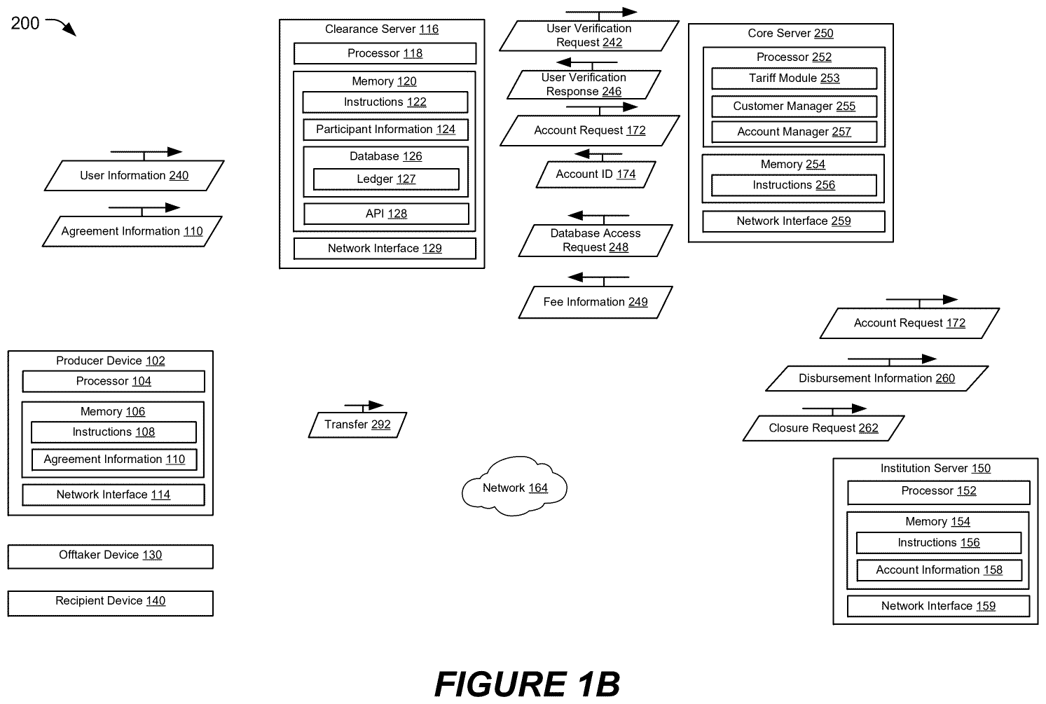

Referring to FIG. 1A, a block diagram of an example clearance system 100 according to one or more aspects is depicted. System 100 includes user devices (such as a producer device 102, an offtaker device 130, and a recipient device 140), a clearance server 116 (e.g., a clearance platform), and an institution server 150. In some implementations, system 100 may also include one or more bank devices (or servers), such as a first bank device 160, a second bank device 162, or a combination thereof. It is noted that in some implementations, the institution server 150 may be a bank device (e.g., a bank server). The producer device 102, the clearance server 116, the offtaker device 130, the recipient device 140, the institution server 150, the first bank device 160, the second bank device 162, or a combination thereof, may include or correspond to an electronic device, such as a server or computer, as illustrative, non-limiting examples. In some implementations, the institution server 150 may include or correspond to a financial institution, such as a bank.

The producer device 102 includes a processing system. The processing system includes one or more processors 104 (collectively referred to as the “processor 104”), one or more memories 106 (collectively referred to as the “memory 106”), or a combination thereof. Additionally, the producer device 102 includes a network interface 114. Although not depicted, the producer device 102 may include one or more input/output (I/O) devices, such as a mouse, touchscreen, keyboard, monitor, other interface, or a combination thereof, configured to receive inputs from a user, to provide outputs to the user, or both. Different device and/or computer architectures can be utilized to implement the producer device 102, and the producer device 102 is not limited to a particular architecture provided that the hardware implementing producer device 102 supports the functions of the clearance system disclosed herein.

The processor 104 may include a central processing unit (CPU) or microprocessor, a graphics processing unit (GPU), microcontroller, or a combination thereof, that has been programmed to perform the functions of the producer device 102. Implementations described herein are not restricted by the architecture of the processor 104 provided that the processor 104, whether directly or indirectly, supports the operations described herein. The processor 104 may be one component or multiple components that may execute the various described logical instructions, such as the instructions 108. The present disclosure is not restricted by the architecture of the processor 104, provided that the processor 104 supports modules, configurations, or operations as described herein. Further, as will be understood by those of skill in the art, a “module” can include an application-specific integrated circuit (ASIC), an electronic circuit, a processor (shared, dedicated, or group) that executes one or more of software or firmware, a combinational logic circuit, and/or other suitable components that provide the described functionality. In some implementations, a module is “[a] self-contained hardware or software component that interacts with a larger system.” Alan Freedman, “The Computer Glossary” 268 (8th ed. 1998).

The memory 106 includes or is configured to store the instructions 108 and/or the agreement information 110. The instructions 108 may include or correspond to object code, source code, firmware, or combinations thereof that, when executed by the processor 104, cause the processor 104 to perform operations according to aspects of the present disclosure, as described herein. The agreement information 110 may include or correspond to a contract (e.g., a forward contract), a purchase agreement, a lien instrument, a reassignment of payment, or a combination thereof. In some implementations, the agreement information 110 may be associated with a contract (e.g., a forward contract) for an exchange of a good (e.g., an object, a product, a commodity, etc.) or a service. As illustrative, non-limiting examples, the good (e.g., a commodity) may include corn, wheat, coffee, soybeans, apples, bananas, meat, pigs, cows, dirt, gravel, fabric, clothes, corn, oats, rough rice, rapeseed, soybean meal, soybean oil, milk, cocoa, coffee C, cotton No. 2, sugar No. 11, sugar No. 14, frozen concentrated orange juice, adzuki bean, an energy resource (e.g., oil, coal, gas) or any other type of commodity.

The network interface 114 may be adapted to couple the producer device 102 to a network 164, which can be one or more of a local area network (LAN), a wide area network (WAN), and/or the Internet. Therefore, in some implementations, the producer device 102 may be accessed via an online portal. In some implementations, the network interface 114 includes a transceiver configured to send and receive signals, such as electronic signals. Although described as a transceiver, the network interface 114 may alternatively include a receiver, a transmitter, or both. In some implementations, the network interface 114 includes a wireless interface such as a long range (LoRa) interface, a Wi-Fi interface (e.g., an IEEE 802.11 interface), a cellular interface, a Bluetooth interface, a Bluetooth low energy (BLE) interface, a Zigbee interface, another type of low power network interface, or the like.

The clearance server 116 (also referred to as a management server) may be associated with a platform, such as a platform that is configured to perform one or more functions. For example, the clearance server 116 may be configured to provide supply chain digitization (e.g., digitize supply chain information). To further illustrate, as an illustrative, non-limiting example, the clearance server 116 may facilitate transactions between farmers, buyers and financial institutions. Through the use of smart contracts and a blockchain, the clearance server 116 automates transactions, ensuring that parties fulfill their contractual obligations in a transparent and secure manner. In some such implementations, the clearance server 116 may include or communicate with a payment service, such as a payment microservice, that includes a platform that is agnostic to a platform of a financial institution (e.g., the financial institution associated with the institution server 150). In other implementations, the platform associated with the payment service is included in or controlled/administered by the financial institution associated with the institution server 150. The payment service (such as a payment microservice) may be configured to accommodate payments, such as traditional fiat currencies, cryptocurrencies, stable coins, Central Bank Digital Currencies (CBDCs), and/or tokenized assets.

In some examples, the payment service can be a payment service-based core system (e.g., a payment microservice-based core system) in which the core system can enable a variety of functionality, such as permitting a customer/user to authorize the clearance server 116 to operate on one or more (or all) banking resources of that customer, thereby allowing the clearance server 116 to see or access balances and/or transactions, and/or issue outbound transfers. The core system can also utilize one or more application programming interfaces (APIs) that allow the clearance server 116 to execute operations for near real-time transfer of funds and/or high value transactions. The core system may include or correspond to the core server 250 (e.g., a payment server or a transaction server) described further herein at least with reference to FIG. 1B. In some implementations, an entity that operates/administers the core system is a different entity than an entity that operates the clearance server 116.

Additionally, the clearance server 116 may be configured to reduce fraud and increase trust associated with the transactions managed by the clearance server 116. To illustrate, through use of a blockchain to record transactions (as described further herein), each step of the transaction is recorded immutably, significantly reducing the possibility of fraud. This increases trust between all parties/users, from farmers to banks and buyers, as illustrative, non-limiting examples. The clearance server 116 may also improve liquidity and access to credit for one or more users of the clearance server 116. For example, the clearance server 116 allows producers (e.g., farmers) to sell their products efficiently and access faster payments, improving liquidity. Furthermore, the clearance server 116 facilitates access to credit by providing a lender (e.g., a recipient associated with the recipient device 140) with verifiable and transparent data of one or more transactions (e.g., one or more agricultural transactions), thereby increasing the likelihood of lenders to issue credit or increasing the speed of such transactions. The clearance server 116 may operate in conjunction with one or more institution servers 150 (e.g., financial institutions) to enable access to a financial institution through the clearance server 116. For example, the clearance server 116 may perform or facilitate trust account management, user authentication and bank account verification, any or all of which is performed in accordance with local rules and regulations of the financial institution.

The clearance server 116 includes a processing system including one or more processors 119 (collectively referred to as the “processor 118”), one or more memories 120 (collectively referred to as the “memory 120”), or a combination thereof. Additionally, clearance server 116 includes a network interface 129. Although not depicted, the clearance server 116 may include one or more I/O devices, such as a mouse, keyboard, a touchscreen, monitor, other interface, or a combination thereof configured to receive inputs from a user and to provide outputs to the user. Different server and computer architectures can be utilized to implement the clearance server 116, and the clearance server 116 is not limited to a particular architecture provided that the hardware implementing the clearance server 116 supports the functions of the management system disclosed herein. For example, the clearance server 116 can include one or more servers, a decentralized platform, or a cloud-based computing platform configured to perform operations or execute the steps described herein.

The processor 118, the memory 120, and the network interface 129 of the clearance server 116 may correspond to (e.g., be analogous to) the processor 104, the memory 106, and the network interface 114 of the producer device 102. Accordingly, the processor 118, the memory 120, and the network interface 129 may include similar or the same features to those described with reference to the processor 104, the memory 106, and the network interface 114.

The memory 120 may be configured to store instructions 122, participant information 124 (e.g., user information, bank account information, etc.), a database 126, an API 128, or a combination thereof. In some implementations, the instructions 122, the participant information 124, the database 126, the API 128, or a combination thereof, may be stored externally from (e.g., remotely to) the clearance server 116. The instructions 122 may include or correspond to object code, source code, firmware, or combinations thereof that, when executed by the processor 118, cause the processor 118 to perform operations according to aspects of the present disclosure, as described herein.

The participant information 124 may include information associated with or corresponding to one or more users or entities, such as a producer, an offtaker, a recipient, an institution, a bank, a core entity, or a combination thereof. For example, the participant information 124 may store producer data associated with or corresponding to an operator or owner of the producer device 102. As another example, the participant information 124 may store offtaker data associated with an operator or owner of the offtaker device 130. As another example, the participant information 124 may store recipient data associated with an operator or owner of the recipient device 140.

In some implementations, for a user or an entity, the participant information 124 includes or indicates a name, a company, a birthday, a nationality, a government identification number, a tax ID, an email address, a phone number, a fax number, an address, account information, sustainability information, or a combination thereof. The account information may include or indicate a bank account, a bank name that provides the bank account, a routing number associated with third bank account, an account type of the bank account, a holder name of the bank account, or a combination thereof. The sustainability information may include or indicate sustainable farming practices, certifications or sustainable metrics (e.g., organic standards, carbon footprint), environmental, social, and governance (ESG) indicators, or a combination thereof.

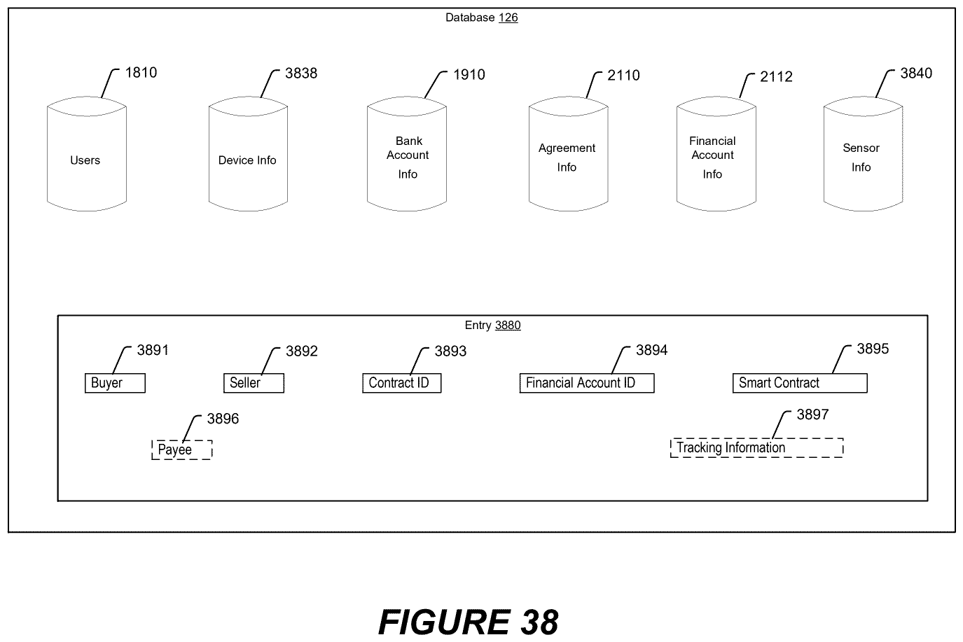

The database 126 may store a ledger 127, such as one or more data structures and/or a block chain ledger. The ledger 127 (e.g., a block chain ledger) may be a secured data structure that enables users of a distributed computing system to rely on the accuracy of data included in the block chain ledger. For example, the ledger 127 (e.g., the block chain ledger) is a data structure stored using storage resources of the distributed computing system. The ledger 127 (e.g., the block chain ledger) may include an accounting or record of the transactions facilitated by the clearance server 116. The API 128 may include one or more interfaces. Although the database 126 and the ledger 127 are described as being included in the clearance server 116, in other implementations, the database 126 and the ledger 127 may be separate from the clearance server 116 and may be accessible to the clearance server 116. For example, the database 126 and the ledger 127 may be included in the same remote server that is distinct from the clearance server 116. As another example, the database 126 may be included in a first remote server and the ledger 127 may be included in a second remote server. In some implementations, the database 126 (e.g., the ledger 127) indicates or records one or more transactions (e.g., payments, transfers, disbursements, etc.) associated with an agreement between multiple users. An example of the database 126 is described further herein at least with reference to FIG. 38.

The API 128 may include one or more interfaces that enable interfacing or communication with the clearance server 116 by other devices or applications. For example, the API 128 (e.g., the one or more interfaces) may be accessible by one or more devices, such as the producer device 102, the clearance server 116, the offtaker device 130, the recipient device 140, the institution server 150, the first bank device 160, the second bank device 162, a core server (as described at least with reference to FIG. 1B), or a combination thereof. In some implementations, the clearance server 116 and/or the database 126 may include the API 128 or an interface layer that provides a user or an entity with the ability to access at least a portion of the database 126. For example, the API 128 or the interface layer may provide read-only access or limited write/transaction privileges to the user or entity.

The recipient device 140 includes a processing system including one or more processors 142 (collectively referred to as the “processor 142”), one or more memories 144 (collectively referred to as the “memory 144”), or a combination thereof. Additionally, the recipient device 140 includes a network interface 148.

The processor 142, the memory 144, and the network interface 148 may correspond to (e.g., may be analogous to) the processor 104, the memory 106, and the network interface 114, respectively, of the producer device 102. Accordingly, the processor 142, the memory 144, and the network interface 148 may include similar features or the same features as those described with reference to the processor 104, the memory 106, and the network interface 114, respectively. The processor 142 may be configured to execute instructions 146 stored in the memory 144 to perform one or more operations described herein.

The institution server 150 includes a processing system that includes one or more processors 152 (collectively referred to as the “processor 152”), one or more memories 154 (collectively referred to as “memory 154”), or a combination thereof. Additionally, the institution server 150 includes a network interface 159.

The processor 152, the memory 154, and the network interface 159 may correspond to (e.g., may be analogous to) the processor 104, the memory 106, and the network interface 114, respectively, of the producer device 102. Accordingly, the processor 142, the memory 144, and the network interface 148 may include similar features or the same features as those described with reference to the processor 104, the memory 106, and the network interface 114, respectively. The processor 152 may be configured to execute instructions 156 stored in the memory 154 to perform one or more operations described herein. The memory 154 may also include or store account information 158, such as one or more financial accounts (e.g., a fiduciary account).

In some implementations, the institution server 150 includes or supports one or more APIs. Each API of the one or more APIs may enable another device, such as the clearance server 116, to interact with the institution server 150. To illustrate, the one or more APIs may include a first API to enable the clearance server 116 to create a new bank account (e.g., for declaring payments) and obtain the account details. The one or more APIs may additionally or alternatively include a second API to enable another device to transfer funds from another bank account to an account of the institution server 150. The one or more APIs may additionally or alternatively include a third API to enable another device (e.g., the clearance server 116 or a user device) to obtain notifications of any deposits into an account of the institution server 150. The one or more APIs may additionally or alternatively include a fourth API to enable another device (e.g., the clearance server 116 or a user device) to push money out from an account of the institution server 150 to another account at institution server 150 or another financial institution.

The first bank device 160, the second bank device 162, or both, may include one or more components as described herein with reference to the institution server 150. In some implementations, the first bank device 160 and/or the second bank device 162 include, respectively, one or more servers, a decentralized platform, or a cloud-based computing platform. Additionally, or alternatively, the first bank device 160, the second bank device 162, or both, may be configured to perform one or more operations described herein with reference to the institution server 150. In some implementations, the first bank device 160 is associated with a first account owned by the same entity that owns or operates the offtaker device 130. For example, an offtaker associated with the offtaker device 130 may have a first account at an entity (e.g., a bank or financial institution) associated with the first bank device 160. Additionally, or alternatively, the second bank device 162 may be associated with a second account owned by the same entity associated with (e.g., that owns or operates) the recipient device 140. For example, a recipient associated with the recipient device 140 may have a first account at an entity (e.g., a bank or financial institution) associated with the second bank device 162. In some implementations, the owner or operator of the offtaker device 130 additionally or alternatively has an account at the financial institution associated with (e.g., that owns or operates) the institution server 150. Additionally, or alternatively, the owner or operator of recipient device 140 additionally or alternatively has an account at the institution associated with (e.g., that owns or operates) the institution server 150.

The concepts described herein are not limited to the architecture of the producer device 102, the clearance server 116, the offtaker device 130, the recipient device 140, the institution server 150, the first bank device 160, the second bank device 162, a core server (as described with reference to FIG. 1B), or any combination thereof. Rather, the foregoing are provided as examples of computing devices that can be adapted to perform the functions of the devices as described herein. In particular, any suitable processor-based device can be utilized including, without limitation, personal data assistants (PDAs), computers, laptops, tablet computers, smartphones, computer game consoles, multi-processor servers, and the like, as illustrative, non-limiting examples. Additionally, or alternatively, while the clearance server 116 and the institution server 150 are illustrated as physically distinct systems, in some implementations, the clearance server 116 and the institution server 150 may be implemented on a single system that includes a processor (e.g., the processor 118 and/or the processor 152), a memory (e.g., the memory 120 and/or the memory 154), and a network interface (e.g., the network interface 129 and the network interface 159).

Although described as having a single institution server 150 that interacts with the clearance server 116, the system 100 may include multiple institution servers (e.g., the institution server 150) configured to interact with the clearance server 116. To illustrate, each institution server of the multiple institution servers may be associated with a different institution (e.g., a different bank), and each respective institution server may be communicatively coupled to the clearance server 116 (e.g., via the network 164). In some implementations, the institution server 150 can include one or more servers, a decentralized platform, or a cloud-based computing platform configured to perform operations or execute the steps described herein.

Moreover, the systems and methods of the present disclosure can be implemented on application specific integrated circuits (ASIC), very large scale integrated (VLSI) circuits, or other circuitry. Additionally, it should be appreciated that the devices described herein, or certain components thereof, may reside at, or be installed in, different locations within the system 100. In some implementations, the devices of system 100 can include one or more servers, a decentralized platform, or a cloud-based computing platform configured to perform operations or execute the steps described herein. For example, the clearance server 116, the institution server 150, and/or a core server may include a cloud-based computing platform or a decentralized platform. Accordingly, any of the devices of the system 100 may include a particular purpose computing system designed, configured, or adapted to perform and/or initiate operations, functions, processes, and/or methods described herein and can be communicatively coupled with a number of end user devices, which can be, e.g., a computer, tablet, smartphone, or other similar end user computing device, as illustrative, non-limiting examples. Users can interact with any of the devices of the system 100 using a device via one or more networks, such as network 164, which itself can include one or more of a local intranet, a LAN, a WAN, a virtual private network (VPN), and the like. Communicative coupling between different devices of system 100 can be provided by, e.g., one or more of wireless connections, a synchronous optical network (SONET) connection, a digital T1, TN, E1 or E3 line, Digital Data Service (DDS) connection, DSL (Digital Subscriber Line) connection, an Ethernet connection, and the like, as illustrative, non-limiting examples.

The network 164, such as a communication network, may facilitate communication of data among components of the system 100. For example, the network 164 may facilitate communication of data among the producer device 102, the clearance server 116, the offtaker device 130, the recipient device 140, the institution server 150, the first bank device 160, the second bank device 162, a core server, or a combination thereof. The network 164 may include a wired network, a wireless network, or a combination thereof. For example, the network 164 may include any type of communications network, such as a direct PC-to-PC connection, a LAN, a WAN, a modem-to-modem connection, the Internet, intranet, extranet, cable transmission system, cellular communication network, any combination of the above, or any other communications network now known or later developed within which permits two or more electronic devices to communicate.

In some implementations, the clearance server 116, or another server—e.g., a core server 250, is associated with or hosts an application (also referred to herein as an “app”), such as a mobile application and/or a web platform. The application includes a computer program that is configured to operate as a user interface for one or more users to interact with and/or perform one or more operations with or via the clearance server 116. In implementations where the application includes a mobile application, at least a portion may be stored at a device of the user and may be operable or available to the user in an on-line mode.

During operation of the system 100, the producer device 102 may log into or access the clearance server 116. For example, a producer (e.g., an entity or individual) associated with the producer device 102 may have login credentials associated with a service provided by the clearance server 116, such as login credentials associated with a clearance service.

The producer device 102 may send the agreement information 110 (e.g., agreement data) to the clearance server 116. The agreement information 110 sent by the producer device 102 may include or indicate the agreement information 110 stored at the producer device 102, which may represent a contract (e.g., a forward contract) between the producer and an offtaker (e.g., a buyer). The offtaker may be an individual or an entity that is associated with the offtaker device 130.

Additionally, or alternatively, the producer device 102 may request that the clearance server 116 initiate or request the institution server 150 to create an account associated with the producer, the agreement information 110, or a combination thereof. In some implementations, the producer device 102 may indicate which financial institution (e.g., a bank) the account should be created with. For example, the producer device 102 may indicate a financial institution where the producer already has an existing personal account. Additionally, or alternatively, the clearance server 116 may request the producer device 102 to select the financial institution from multiple financial institutions. Based on the request, the clearance server 116 may send an account request 172 to institution server 150. The account request 172 may include the agreement information 110, information (e.g., name, address, phone number, email address, etc.) about the producer, information (e.g., name, address, phone number, email address, etc.) about the offtaker, or a combination thereof.

Based on the account request 172, the institution server 150 may generate or create a clearance account, such as a financial account (e.g., an escrow account or a fiduciary account). For example, the institution server 150 may generate account information 158 associated with the clearance account. The account information 158 associated with the clearance account may include an account ID 174 of the clearance account. The institution server 150 may send an account ID 174 to the clearance server 116, the producer device 102, or a combination thereof.

Based on receipt, by the clearance server 116, of the agreement information 110, the request to create an account, the account ID 174, or a combination thereof, the clearance server 116 may send a verification request 176 to the offtaker device 130. The verification request 176 may request that the offtaker verify that the offtaker is a party to the agreement associated with the agreement information 110. In some implementations, the offtaker may be provided with an option to send agreement information that is in the possession of the offtaker as part of the verification process.

The offtaker device 130 may send a verification response 178 to the clearance server 116. The verification response 178 may include or indicate whether or not the offtaker verifies that the offtaker is a party to the agreement associated with the agreement information 110. Additionally, or alternatively, the verification response 178 (or an additional response/message) may include or indicate agreement information that is in the possession of the offtaker. In some implementations, the verification response 178 (or an additional response/message) may include or indicate an account acknowledgement that indicates that the offtaker acknowledges that that the account at the institution associated with the institution server 150 has been established on behalf of the producer in relation to the agreement information 110 that the offtaker is a party to. In some implementations, when the clearance server 116 receives the agreement information 110 from the producer device 102 and also receives agreement information from the offtaker device 130, the clearance server 116 may perform a comparison to determine whether the agreement information 110 from the producer device 102 and the agreement information from the offtaker device 130 match—e.g., determine whether or not there is a discrepancy.

The clearance server 116 may send a verification notification 180 to the producer device 102. The verification notification 180 may be sent based on and/or indicate a result of the verification response 178. In some implementations, the clearance server 116 may also send the verification notification 180 to the institution server 150. The verification notification 180 may indicate that a valid agreement (e.g., a forward contract) is established between the producer and the offtaker, and that the offtaker will pay the producer via the financial account established (in relation to the agreement) at the institution.

Based on the valid and verified agreement, the producer may purchase or acquire one or more resources (e.g., one or more inputs) to produce an output associated with the agreement. The producer may purchase or acquire the one or more resources from a provider (also referred to as a recipient). However, rather than pay for the purchase of the one or more resources upfront, the producer may offer a lien instrument, a reassignment of payment, or a combination thereof, to the provider such that the provider will become a recipient of a portion of a payment (associated with the agreement information 110) that the offtaker makes to the producer via the institution. In some examples, the producer may purchase seeds, fertilizer, equipment (e.g., a tractor), or the like, to enable production of the contracted output. Additionally, or alternatively, the producer may acquire a loan and receive money from the recipient, and the producer may use the money to pay for farm labor (e.g., farm workers), logistics-related labor (e.g., a driver), an insurance product, or another product or service.

Based on the lien instrument, the reassignment of payment, or a combination thereof, that the recipient receives from the producer, the recipient may need to be approved by the producer to receive the portion of the payment via the institution. In some implementations, the producer may initiate an approval process to enable the recipient to submit a request (e.g., an invoice) for payment. For example, the producer device 102 may send the lien instrument, the reassignment of payment, or a combination thereof, to the clearance server 116 in relation to the agreement information 110, the account ID 174, or a combination thereof. The clearance server 116 may then send a notification to the recipient device 140 to notify the recipient that the recipient may submit a request for payment to be approved by the producer. The request for payment by the provider (e.g., the recipient) is described further herein.

In some implementations, the recipient (using the recipient device 140) may initiate authorization and/or approval by the producer to receive the portion of the payment via the institution. To illustrate, the recipient device 140 may access the clearance server 116 and perform a search to identify the producer, the agreement information 110, the account ID 174, or a combination thereof, and to authorize or approval of a portion of the payment related to the agreement. In some implementations, the recipient device 140 may send a request 182 (e.g., a search request) to the clearance server 116 to initiate the search.

Based on the request 182, the clearance server 116 may identify the producer, the producer device 102, the agreement information 110, the account ID 174, or a combination thereof. The clearance server 116 may send the recipient device 140 search result information to enable the recipient device 140 to select a search result and request access to the agreement information 110.

The recipient device 140 may send a request (e.g., the request 182 or another request) to the clearance server 116 to access the agreement information 110 based on the search result information. Based on the request from the recipient device 140, the clearance server 116 may send an access request to the producer device 102.

The producer device 102 may accept or reject the access request to grant access to the agreement information 110 for the recipient (e.g., the recipient device 140). If the producer device 102 rejects the access request, the producer device 102 may send a recipient authorization denial to the clearance server 116. The recipient authorization denial may include or indicate a reason for rejection. The clearance server 116 may send at least a portion of the recipient authorization denial to the recipient device 140. Alternatively, the producer device 102 may send a recipient authorization 184 to the clearance server 116 to approve access to the agreement information 110. The clearance server 116 may notify the recipient device 140 that access is granted and the recipient device 140 may be able to view the agreement information 110.

Once the recipient (e.g., recipient device 140) has access to the agreement information 110, recipient device 140 may send a request for payment to the producer via the clearance server 116. In some implementations, the recipient device 140 may send document information 186, a request amount, account information for the provider (e.g., the recipient), or a combination thereof, to the clearance server 116. The document information 186 may include or indicate the lien instrument, the reassignment of payment, or a combination thereof. In some implementations, the document information 186 may also include the request amount and/or a request for approval by the provider.

It is noted that different recipients may interact with the producer during different stages of production and/or delivery of a commodity in association with the first agreement. To illustrate, a first recipient may sell seeds to the producer, a second recipient may provide planning services for the producer, a third recipient may sell fertilizer to the producer, a fourth recipient may spread the fertilizer, a fifth recipient may harvest a produced good (e.g., an object, an output, a crop, a commodity, etc.), a sixth recipient may transport the commodity, or a combination thereof, as illustrative, non-limiting examples. Each recipient may provide respective documentation information to the clearance server 116, and the documentation information may be stored at the database 126.

Based on the document information 186, the clearance server 116 may send an approval request to the producer device 102. The producer device 102 may accept or reject the approval request. If the producer device 102 rejects the approval request, the producer device 102 may send a recipient denial to the clearance server 116. The recipient denial may include or indicate a reason for rejection. The clearance server 116 may send at least a portion of the recipient denial, such as an indication of denial, a reason for denial, or both, to the recipient device 140. Alternatively, the producer device 102 may send a recipient approval 188 (e.g., an approval message) to the clearance server 116 to approve payment by the institution server 150. The clearance server 116 may notify the recipient device 140 that the recipient has been approved for payment by the institution server 150. Additionally, the clearance server 116 may send recipient information 190 to the institution server 150. The recipient information 190 may include or indicate that the recipient is approved to receive at least a portion of the payment, the amount of the portion, the account information for the provider (e.g., the recipient), or a combination thereof.

Based on the agreement information 110 and performance (e.g., delivery) by the producer, the offtaker may provide a payment to the clearance account at the institution server 150. For example, the offtaker device 130 may initiate the first bank device 160 to send a transfer 192 (e.g., the payment) to the clearance account for the producer at the institution server 150. The payment may include a traditional fiat currency, cryptocurrencies, stable coins, Central Bank Digital Currencies (CBDCs), and/or tokenized assets.

Institution server 150 may receive the transfer 192 and may hold the transfer amount (e.g., the payment). The institution server 150 may send a transfer notification 194 to the clearance server 116. The transfer notification 194 may indicate that the transfer 192 is received by the institution server 150 and ready to be distributed.

The clearance server 116 may access the database 126 and determine or confirm how the transfer 192 is to be allocated between one or more parties, such as the producer, the recipient, the institution, an entity associated with the clearance server 116, another entity, or a combination thereof. For example, the clearance server 116 may confirm that the transfer corresponds to the agreement information 110, the account ID 174, the producer, the offtaker, or a combination thereof. Additionally, or alternatively, as another example, the clearance server 116 may determine one or more disbursements, such as a first portion (e.g., a first amount) to be provided to an account associated with the producer, a second portion (e.g., a second amount) to be provided to an account associated with the recipient, and a third portion (e.g., a third amount) to be provided to an account associated with the clearance server 116. The clearance server 116 may send a push request 196 to the institution server 150 to disburse one or more portions of the transfer 192.

Based on the push request 196, the institution server 150 may disburse the one or more portions of the transfer 192. For example, the institution server 150 may disburse a first portion of the transfer 192 to the account (e.g., the clearance account) associated with the producer, a second portion of the transfer 192 to a second bank device 162 associated with the recipient, or a combination thereof. To illustrate, institution server 150 may send the second portion as a disbursement 198 to second bank device 162. Additionally, or alternatively, the institution server 150 may disburse a third portion to an account that corresponds to an entity associated with clearance server 116. In some implementations, the third portion may be associated with a fee (e.g., a service fee) for one or more services provided by the clearance server 116 in association with at least the agreement information 110 (e.g., the contract).

After disbursement of the one or more portions of the transfer 192, the institution server 150 may send a confirmation message to the clearance server 116 to confirm that the one or more portions of the transfer 192 were disbursed based on the push request 196. The clearance server 116 may update the database 126 based on or in response to the confirmation message.

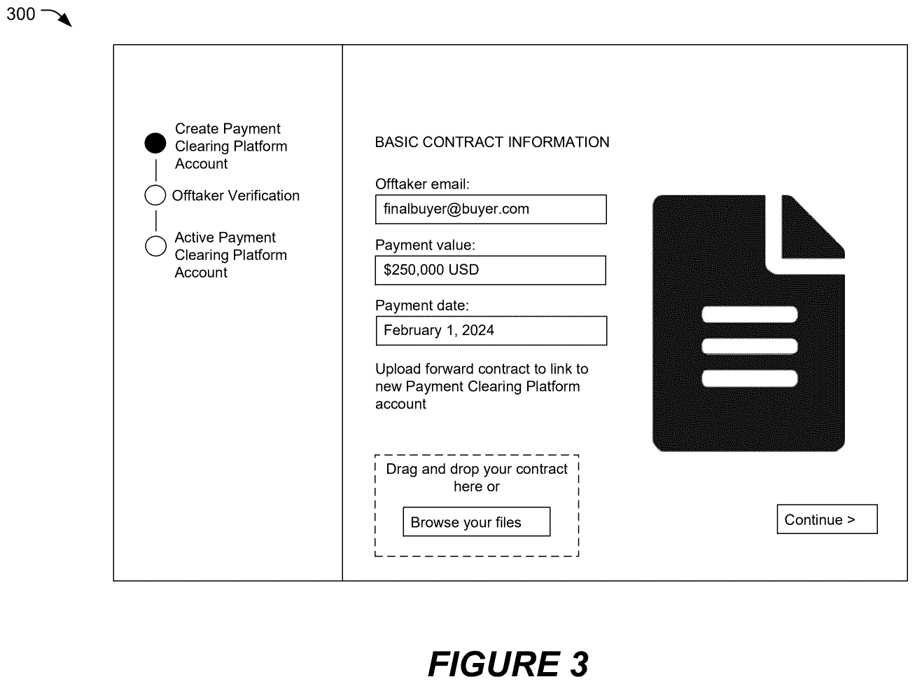

It is noted, that the clearance server 116 may update the database 126 to reflect the different operations (e.g., disbursements) performed by the clearance server 116 and/or information received or generated by the clearance server 116. Additionally, or alternatively, the clearance server 116 may send notifications of a status change to one or more parties/entities (e.g., the producer, the offtaker, the recipient, the institution, etc.). Each party may be able to establish an account or credentials with the clearance server 116 and view information that the party is authorized to view. For example, each party may be able to access a GUI, such as a dashboard GUI, that provides information that the party is authorized to view. Examples of GUIs are described further herein at least with reference to FIGS. 3-8 and 10-17.

After the disbursements and after the database 126 (e.g., the ledger 127) is updated to reflect the disbursements, the clearance server 116 may determine whether the agreement is completed or satisfied based on the database 126. Based on a determination that the agreement is completed or satisfied, the clearance server may request that the clearance account at the institution server 150 be closed, that the information in ledger 127 associated with the agreement is archived, or a combination thereof.

In some implementations, the system 100 may be configured for self-service contract management, integration with one or more additional services (e.g., one or more additional services provided by an entity associated with the clearance server 116), a versatile implementation, API functionality, or a combination thereof. The self-service contract management may enable counterparties to autonomously create, manage, and execute transaction contracts within the platform (e.g., the clearance server 116). For example, the platform (e.g., the clearance server 116) may serve as an entry point to a broader array of products and/or services, which may leverage critical supply chain data to improve or optimize payment clearing processes. For example, the products and/or services may include or correspond to one or more products or services provided in association with a supply chain, such as an agribusiness supply chain. The one or more products or services may include seed procurement and tracking, logistics management, inventory tracking and management, or a combination thereof, as illustrative, non-limiting examples. The versatile application/implementation of the platform may enable any entity (e.g., a business or an individual) involved in transactions with future payment receivables, regardless of location. The API-driven functionalities of the platform may be engineered to perform key functions via API integrations, including account creation for payment clearing, generating deposit receipts, real-time deposit notifications, and outbound payments, as described above.

In some implementations, the clearance server 116 and/or the database 126 is configured to receive supply chain data, such as sensor data (e.g., Internet-of-Things (IoT) data) from one or more sensors. Collecting real-time data (e.g., from sensors on farm equipment, storage facilities, delivery trucks, etc.) provides tracking and transparent proof of commodity status (e.g., a status of a good associated with the agreement), which can prevent disputes over quantity or quality. Additionally, or alternatively, the sensor data may determine a characteristic of a good (e.g., a physical object), such as a commodity. The sensor data may be received by the clearance server 116 and/or the database 126 and may indicate one or more measurements, such as a temperature, a global positioning satellite (GPS) coordinate, a color, a water content, or another objective measurement. Additionally, the sensor may generate signatures, or other types of data structures, that enable the accuracy of the sensor data to be validated. The sensor may send the sensor data and a signature generated by a sensor that generated the sensor data. In some implementations, the sensor may send the sensor data and/or the signature along with or in association with an identifier of an agreement, such as an agreement ID (e.g., a contract ID). The clearance server 116 and/or the database 126 may receive the sensor data and the signature, and validate, based on the signature, the accuracy of the first data. In this manner, the system 100 may prevent fraud and/or incorrect data from being stored at the database 126. Additionally, the clearance server 116 and/or the database 126 may receive and store, at the database 126, certification results of a sensor, lab certification and/or test results, or a combination thereof to ensure that sensor data and/or a commodity meets agreed-upon standards of an agreement.

In some implementations, sensor data, testing data, or other data, received by the clearance server 116 and/or the database 126 may be stored at the database 126. For example, such data may be stored in a respective entry or at an entry related to an agreement. To illustrate, sensor data from a first sensor may be stored in the database 126 at an entry that corresponds to the first sensor. In some examples, a portion of the sensor data may be linked to an entry that is associated with an agreement. As another example, the sensor data that is received may include or indicate an identifier of an entry associated with an agreement and may be stored at the entry. If the sensor data is stored at the entry associated with the agreement, the sensor data may be used to update a status of the agreement, which may trigger a partial payment or a final payment associated with the agreement.

In some implementations, the clearance server 116 and/or the database 126 may be configured to receive data from a device associated with an authorized local representative. The authorized local representative may be authorized to monitor and/or verify farm conditions, crop conditions, commodity conditions, storage conditions, or a combination thereof. Information collected by the authorized local representative may be sent to the clearance server 116 to be stored at the database 126.

In some implementations, the clearance server 116 includes a compliance module. Agricultural commodities often trade internationally, requiring compliance with multiple jurisdictions' regulations. The compliance module is configured to update information as laws and regulations shift over time. The information in the compliance module may be applied to an agreement, a contract formation process, one or more fee calculations, one or more reporting operations, lien enforcement, dispute resolution, or a combination thereof, based on a relevant country or region.

In some implementations, the clearance server 116 enables adjustments to contract terms, volumes, or deadlines. For example, the clearance server 116 may enable a process for a user or entity associated with an agreement to request a modification to an agreement. The request may include a field to be modified, such as a price, a quantity, or a delivery date, as illustrative, non-limiting examples. The clearance server 116 may obtain signatures from all parties impacted by the modification and record the modification and signatures to the entry associated with the agreement. Such information may be stored at the entry (e.g., the database 126) to track, verify, and authenticate amendments without losing the original contract's integrity.

In some implementations, the clearance server 116 may register one or more devices to communicate with the clearances server 116, the database 126, a core server (e.g., the core server 250 of FIG. 1B), or a combination thereof. For example, a user of the system 100, the clearance server 116 may register a device associated with or identified by the user. In some examples, the device is the producer device 102 associated with the producer. To register the device, the clearance server 116 may obtain (e.g., receive) a device identifier from the device. The clearance server 116 may generate a registered device ID, such as a unique identifier and/or a certificate, that is associated with the device. The clearance server 116 may store the registered device ID at the database 126. For example, the registered device ID, the device identifier, or both may be stored at the database 126—e.g., as part of user information associated with the user. The clearance server 116 may send the registered device ID to the device. In some implementations, the clearance server 116 may limit a user to registering a single device. Alternatively, a user may be able to register multiple devices with the clearance server 116, and each device may receive a respective registered device ID that is unique to the device.

The user may use the device having the registered device ID to access (e.g., login to) the clearance server 116 and/or the database 126. For example, during a login procedure performed with the clearance server 116 with the device, the device may provide a copy of the registered device ID or a portion of the registered device ID, or a value generated based on the registered device ID, to the clearance server 116. Additionally, or alternatively, the device may use the registered device ID to generate a value (e.g., a signature) to the clearance server 116. In some implementations, the device of the user may send at least a portion of the device ID and/or the value (e.g., the signature) to the clearance server 116 as part of a communication from the device to the clearance server 116. In some implementations, each operation (e.g., read operation or write operation) performed between the clearance server 116 (or the database 126) and the device may be recorded (and indicate the registered device ID. The portion of the registered device ID and/or the value may enable the clearance server 116 to confirm that source of the communication, prevent fraud, or misuse of the clearance server 116.

In some implementations, the clearance server 116 may set user rights for the user based on whether or not the user accesses the clearance server 116 and/or the database 126 using a device having a registered device ID. For example, if the user performs a login operation to the clearance server 116 using a device having a registered device ID, the user may have the user's full read access permission and write access permissions while using the device having a registered device ID. Alternatively, if the user performs a login operation to the clearance server 116 using another device that does not have a registered device ID (e.g., a registered device ID for a device that linked to the user), the user may have reduced read access permission and write access permissions as compared to the user's full read access permission and write access permissions. For example, while using the other device, the user may have the user's full read access permission but may not have write permissions. As another example, the user may have reduced read access permissions and may only be able to view documents or information provided by the user. Additionally, or alternatively, the user may not have any write access permissions while using the other device. In this manner, the clearance server 116 may provide additional security and reduce fraud or unauthorized access to the system.

In some implementations, the clearance server 116 may facilitate a purchase of a property (e.g., farmland) by a user, such as the producer. To purchase the farmland, the producer may provide a downpayment (for the purchase) that is a portion of a purchase price and that is paid to a seller of the property. Traditionally, a buyer of farmland (e.g., the producer) would enter into an arrangement with the seller to pay the remainder of the purchase price based on proceeds from future harvests. Such an arrangement can span multiple harvest seasons, requiring detailed tracking of crop sales and revenue allocations by the producer for the benefit of the seller. Alternatively, the producer may obtain a loan (e.g., a mortgage) from the financial institution (associated with the institution server 150) to pay the remainder or the entirety of the purchase price to the seller. The producer may then make regular (e.g., monthly) payments to the financial institution, or may enter into an arrangement to pay the remainder of the loan based on the proceeds from future harvests from the property.

In some such implementations, the clearance server 116 may enable a buyer (e.g., the producer) to secure a bank loan from a financial institution (e.g., a bank or lender) for at least a portion of the purchase of the property. The financial institution becomes both the lien holder on the property and a recipient (e.g., a payee of the buyer) within the clearance platform supported by the clearance server 116. The clearance server 116 may be configured to designate the financial institution as a payee (e.g., automatically designate or designate based on buyer selection of the financial institution as a payee) for crop revenues generated based on the farmland, where purchase agreements for the harvests from the farmland utilize the clearance server 116.

In some such implementations, the clearance server 116 may enable the buyer to request and/or secure the loan with the financial institution through interactions with the clearance server 116. Because the clearance server 116 provides a transparent, automated mechanism for tracking and directing crop revenue, the financial institution (e.g., the bank) can streamline an underwriting process by reducing the number of requirements and simplifying collateral verification. Accordingly, a loan provided through use of the clearance server 116 may be less complex to acquire than a traditional loan process (e.g., a traditional loan application process). This increased efficiency benefits all parties: the seller receives payment more predictably, the buyer enjoys a smoother financing experience, and the lender gains improved visibility and lower risk through the real-time data tracking provided through the clearance server 116.

In some implementations, the clearance server 116 may aggregate data on contracts, payment milestones, and lien instruments, thereby offering real-time dashboards and historical summaries. These descriptive analytics enable stakeholders to monitor key performance indicators (KPIs) and generate periodic reports. The historical summaries and reports may be generated to have a standardized format. The standardized format of such historical summaries and/or reports enables such information to be accessed via an API. In some implementations, the clearance server 116 may include a predictive modeling engine that employs machine learning (e.g., artificial intelligence (AI)) to forecast yield outputs, identify potential defaults, and provide risk scores. The predictive modeling engine (e.g., an AI component) may also detect anomalies (e.g., irregular lien patterns, abnormal payment delays) by comparing real-time data to historical patterns.

For example, referring to FIG. 1B, a block diagram of another example clearance system 200 according to one or more aspects is shown. As compared to the system 100, the system 200 includes a core server 250 in addition to components of the system 100. The core server 250 may include one or more servers, a decentralized platform, or a cloud-based computing platform. In some implementations, the core server 250 (e.g., a core banking server) is configured to provide one or more processing services, such as one or more payment processing services, as described further herein. The system 200 includes the producer device 102, the clearance server 116 (e.g., a clearance platform), the offtaker device 130, the recipient device 140, the institution server 150, and the core server 250. Additionally, the system 200 may include the first bank device 160, the second bank device 162, or both.

Although the core server 250 is described as being separate from the clearance server 116, in other implementations, the clearance server 116 may include at least a portion or an entirety of the core server 250. For example, one or more operations described with reference to the core server 250 may be performed by the clearance server 116. Additionally, or alternatively, one or more operations described with reference to the clearance server 116 may be performed by the core server 250. It is noted that each of the clearance server 116 and the core server 250 is separate from the institution server 150.

The core server 250 (also referred to as a facilitation server, an administration server, a processing server, or a monitoring server) may be configured to perform one or more operations associated with administration or monitoring of a financial account (e.g., a fiduciary account) created within a financial institution (FI), such as a financial institution associated with the institution server 150. In some implementations, the financial account may be a digital account that is a transitional account (or a trust account) designated to receive a payment that is then distributed according to terms of an agreement (e.g., a contract). The financial account may be configured to hold funds in a beneficiary's name, may be linked to a master account associated with a user, and/or may be programmatically controlled by the clearance server 116 (and/or the core server 250). In some implementations, the financial account may be configured to receive funds via a credit card transaction. The core server 250 may also be configured to register one or more participants/users, register one or more parties/entities associated with a participant or user, perform or coordinate intermediary transactions and/or a final settlement of payments, coordinate or request closure of a financial account, or a combination thereof. In some implementations, the core server 250 provides efficient integration between the clearance server 116 and the institution server 150 to ensure secure and transparent transactions that are compliant with regulations thereby maximizing efficiency and customer satisfaction. In some implementations, the core server 250 may be configured to interact with a financial institution (e.g., the institution server 150). For example, the core server 250 can be configured to perform or facilitate operations previously performed in Payment Transit Accounts (which may also be referred to as pass-through accounts) before final settlement in a financial account at a financial institution.

The core server 250 includes a processing system that includes one or more processors 252 (collectively referred to as the “processor 252”), one or more memories 254 (collectively referred to as the “memory 254”), or a combination thereof. Additionally, the core server 250 includes a network interface 259.

The processor 252, the memory 254, and the network interface 259 may correspond to (e.g., may be analogous to) the processor 104, the memory 106, and the network interface 114, of the producer device 102, respectively. Accordingly, the processor 252, the memory 254, and the network interface 259 may include similar features or the same features as those described with reference to processor 104, memory 106, and network interface 114, respectively. The processor 252 may be configured to execute instructions 256 stored in the memory 254 to perform one or more operations described herein.

In some implementations, the processor 252 includes one or more modules, such as a tariff module 253, a customer manager 255, and an account manager 257. Although described as modules, in some implementations, the tariff module 253, the customer manager 255, and the account manager 257 may be associated with execution of the instructions 256 (e.g., code) that cause the processor 252 to perform one or more operations described with reference to the tariff module 253, the customer manager 255, the account manager 257, or a combination thereof.

The tariff module 253 (also referred to as a fee module) is configured to control different fees applied to transactions with the system 200. For example, the tariff module 253 may be configured to calculate fees associated with a transaction based on a pricing policy (e.g., a service fee) and/or local regulations (e.g., tariffs), ensuring that all fees are applied correctly before proceeding to settlement. In some implementations, the tariff module 253 may enable the core server 250 (and/or the clearance server 116 via the core server 250) to flexibly establish and adjust service costs according to market and operational needs. Additionally, the tariff module 253 can provide users, such as the producer, the offtaker, and/or the receiver, with a clear and detailed view of the fees applied to their transactions, which helps maintain customer trust and satisfaction.

The customer manager 255 is configured to act or operate as a centralizer of records for all participants and helps manage the data of users, such as producers (e.g., farmers), offtakers (e.g., buyers), receivers (e.g., lenders), etc. The customer manager 255 can support complementary registration, links and socioeconomic information and corporate structures of companies and groups involved in contracts, which supports processes such KYC (know your customer) and credit assessment and can help achieve compliance and security in transactions. In some implementations, the customer manager 255 is configured to support customer identification and verification (e.g., KYC operations), which may be performed in association or partnership with a government-approved ID system, an e-KYC portal, a financial institution which a user has an existing account, or a combination thereof. In some examples, the institution server 150 may be configured to provide an API for user verification, such as user verification using login credentials associated with the financial institution associated with the institution server 150. To illustrate, the clearance server 116 or the core server 250 may access the institution server 150 via the API to perform user verification. Additionally, or alternatively, the customer manager 255 can facilitate the collection, verification, and management of customer data, ensuring that all parties involved in transactions (e.g., sender, recipient, and assignee) are properly authenticated and compliant with current regulations. In some implementations, the customer manager 255 can offer personalized services to a user, such as automatic notifications about transaction status and payment reminders. For example, the customer manager 255 may be configured to notify a user about any deposits received in accounts linked to or associated with the user.

The account manager 257 is configured to perform one or more operations to create a transaction account, monitor or initiate one or more financial transactions, or a combination thereof. For example, the account manager 257 can be configured to perform account creation and administration. To illustrate, the account manager 257 (e.g., the core server 250) can automate the creation and/or configuration of financial accounts, such as fiduciary accounts, (at a financial institution) and other necessary accounts. In some implementations, the account manager 257 can be configured to enable a user to identify a main account of the user, such as an account to which all remaining resources not assigned at the end of a contract and owed to the user will be transferred. The account manager 257 can also perform ongoing management of a financial account (e.g., the fiduciary account), such as balance monitoring and monitoring for suspicious activity. Additionally, or alternatively, the account manager 257 can perform transaction pre-processing (e.g., before settlement at a financial institution), where preliminary checks are made to ensure compliance and accuracy of the values to be transferred. In some implementations, the account manager 257 is configured to ensure that funds are distributed correctly among participants after completing transactions on the platform, following the terms established by a contract (e.g., a smart contract).

In some implementations, the core server 250 may be configured to access the database 126 and/or the ledger 127. To illustrate, the core server 250 (e.g., the processor 252) may include a blockchain engine that is configured to access the database 126 and/or the ledger 127. The database 126 and/or the ledger 127 that is utilized by the clearance server 116 and/or the core server 250 can enable the system 200 (or the system 100) to provide a robust, performant, scalable and integrated solution that automates monetization, clearing and financial flow processes and meets the specific needs of a sector or industry (e.g., the agricultural sector) and beyond, and at the same time which improves the efficiency, security and transparency of financial transactions. The database 126 and/or the ledger 127 may enable and support maintenance (e.g., by the clearance server 116 and/or the core server 250) of a clear contractual chain of title for traceability and accessibility of all transaction histories and changes.

The clearance server 116 and/or the core server 250 may be configured to provide financial account management (e.g., fiduciary account management) and rule-based transfers. One or more APIs may be used and/or developed with respect to one or more integration aspects for the clearance server 116 and/or the core server 250 to interact or operate with each other, the institution server 150, the ledger 127, or a combination thereof. In some implementations, devices of the system 200 may interact to perform a user authentication in which a secure user authentication process is validated by the financial institution (e.g., the institution server 150). The user authentication process can be integrated with an API of the financial institution (e.g., the institution server 150) for seamless user verification. Additionally, or alternatively, the system 200 may be configured to perform automated transitory account management in which accounts that will hold funds on behalf of a beneficiary are programmatically created, and can be operated on programmatically on behalf of the beneficiary through the system 200. An additional aspect may include being able to mark the accounts as deleted so they cannot receive additional funds—e.g., once a contract is completed. The system 200 (e.g., the clearance server 116 and/or the core server 250) may enable or support funds acceptance and notifications capabilities in which accounts are allowed to receive funds from any institution on a banking system (e.g., a national banking system), accompanied with webhooks or events that trigger execution of rules based on predefined parameters. Some aspects may include creating a QR code, such as a PIX QR code (PIX is a real-time payment system), to streamline the payment process so that an individual or entity that sends or transfers money can make payments more efficient. The clearance server 116 and/or the core server 250 may also be able to automate the disbursement of funds. For example, the clearance server 116 and/or the core server 250 may be able to send transfer instructions authorized by the user to send money to any participant of the platform or to any account in the banking system.

During operation of the system 200, a user, such as a producer, an offtaker, a recipient, or another user, may register with the clearance server 116. For example, the user (e.g., the producer) may send user information 240 from the producer device 102 to the clearance server 116. The user information 240 may include contact information (e.g., name, address, phone number, email address), ID information (e.g., a driver's license number, a passport number, a military ID number, a state or federal ID number, etc.), business information (e.g., a business name, a business address, a business phone number, a business registration number, etc.), bank account information (e.g., a bank name, an account number, a routing number, a balance amount, a deposit amount, an account open date), or a combination thereof. The clearance server 116 may store the user information 240, or a portion thereof, at the database 126. For example, the clearance server 116 may store the contact information, the ID information, the business information, or a combination thereof at a first portion of the database 126 and may store the bank account information at a second portion of the database 126. In some implementations, the first portion of the data database and the second portion of the database 126 are separate databases, entries, or data structures. The portion of the user information 240 stored at the first portion of the database 126 may be linked to the other portion of the user information 240 stored at second portion of the database 126, such as by linking one or more fields of the portions of the databases, including a pointer to another portion of the database in data stored at a different portion of the database, or the like. In some implementations, the clearance server 116 registers the producer, the offtaker, the recipient, or a combination thereof.

To register (e.g., onboard) the user, the clearance server 116 may verify the user information 240. For example, the clearance server 116 may perform or initiate a verification process, such as a know your customer (KYC) process, which may enable regulatory compliance (e.g., with an anti-money laundering law), minimize risk of fraud or criminal activity, or a combination thereof. The verification process may verify the user information 240 using trusted information, such as government records. To illustrate, to verify the user information 240, a KYC resource at an external device, such as the institution server 150 or another server that provides KYC processing, may be used to perform the KYC processing. In some implementations, the KYC resource at the external device may be accessible via an API of the external device (e.g., the institution server 150).

To verify the user information 240, the clearance server 116 may generate and/or send a user verification request 242 to another device. The user verification request 242 may include a portion or an entirety of the user information 240. In some implementations, the clearance server 116 sends the user verification request to the KYC resource at the external device (e.g., the institution server 150). In other implementations, the clearance server 116 sends the user verification request 242 to the core server 250 (e.g., the customer manager 255), and the core server 250 (e.g., the customer manager 255) sends a request (that includes the user verification request 242 or a portion thereof) to the external device (e.g., the institution server 150).

The clearance server 116 receives a user verification response 246 from another device based on the verification process. For example, the clearance server 116 may receive the user verification response 246 from the external device (e.g., the institution server 150) and/or from the core server 250. The clearance server 116 may determine whether or not the user has been verified based on the user verification response 246. If the user verification response 246 indicates that the user information 240 is not verified, the user may not be registered with the clearance server 116 and/or additional verification processing may be performed with the user to remedy one or more deficiencies indicated by the user verification response 246. If the user verification response 246 indicates that the user information 240 is verified, the user may be registered with the clearance server 116. In some implementations, the clearance server 116 may indicate to the user that the user has been verified. In implementations in which the core server 250 sends the request to the external device to verify the user, the core server 250 may receive the user verification response 246 from the external device and determine whether or not the user has been verified based on the user verification response 246 and the customer manager 255 may store an indication at the database 126 or the memory 254 that the user is registered. Additionally, or alternatively, the clearance server 116 may send an indicator to the core server 250 (e.g., the customer manager 255) that indicates that the user is registered.

In some implementations, the clearance server 116 may determine whether or not the user has a bank account that the user can use to send or receive funds. If the user has a bank account, the clearance server 116 may confirm the bank account by initiating one or more deposits to the account and querying the user for value(s) of the one or more deposits. If the user provides the correct value(s) of the one or more deposits, the clearance server 116 confirms the bank account. If the user does not have a bank account, the clearance server 116 may direct the user to establish a bank account with a financial institution. In some implementations, the clearance server 116 may facilitate the user to establish a bank account with a financial institution associated with the institution server 150.

After the user is verified and registered with the clearance server 116, the user, such as the purchaser, provides the agreement information 110 to the clearance server 116. The agreement information 110 may be associated with or correspond to an agreement (e.g., a purchase transaction or sales transaction) of goods and/or services. For example, the agreement may be associated with the producer selling a future commodity (e.g., a crop) to an offtaker. As another example, the agreement may be associated with the sale of a piece of equipment to another party, such as the offtaker or the recipient. As another example, the producer may purchase equipment or materials from a company, such as an agricultural company, and payment is to be made after or upon delivery of the equipment or materials to the producer.

The clearance server 116 may confirm the existence of the agreement associated with the agreement information 110. For example, the clearance server 116 may perform one or more operations as described herein at least with reference to FIG. 1A. To illustrate, the clearance server 116 may confirm the agreement with each party to the agreement. In some implementations, if a party to the agreement is not registered with the clearance server 116, the clearance server 116 may perform one or more operations to register the respective party (e.g., the respective user) as described herein.

Based on confirmation of the agreement associated with the agreement information 110, the clearance server 116 stores the agreement at the database 126. For example, the clearance server 116 store the agreement information 110 at a third portion (e.g., entry or data structure) of the database 126, and the agreement information 110 stored at the third portion of the database 126 may be linked or associated with the first portion of the database 126 that stores the contact information, the ID information, the business information, or a combination thereof. Additionally, or alternatively, the clearance server 116 may generate an entry (associated with the agreement) at the ledger 127 (e.g., a blockchain). It is noted that the ledger 127, such as a permissioned blockchain or a public blockchain, may include immutable records, such as records that utilize or leverage cryptographic hashing, block linking, or a combination thereof. Cryptographic hashing utilizes cryptographic hash functions (e.g., secure hash algorithm (SHA)-256) to generate unique hashes for each block. Any alteration in the block data of a block alters the corresponding hash for the block, signaling tampering with the block has occurred. Block linking is used such that each block contains the hash of a preceding block in the blockchain, creating a chain. Accordingly, altering a single block requires recalculating links for all subsequent blocks, which is a computationally prohibitive task. In implementations that include use of a blockchain, the decentralized, cryptographic nature of the blockchain may reduce risk of lost documents or manipulation of a document due to the immutability of the records. Additionally, cryptographic mechanisms (e.g., hashing and/or digital signatures) can be used to verify document authenticity and province. Storing agreement information, document information, assignment information, etc., on in the database in an immutable manner may provide tamper-proof and time-stamped records that enable real-time access and prevent fraud. The ability to access the database 126 and receive real-time access may foster trust between different users and between the different users and the entities that operate the clearance server 116 and the institution server 150.

The entry at the ledger 127 that is associated with the agreement may include or indicate the agreement information 110, user information. contact information (e.g., name, address, phone number, email address), ID information (e.g., a driver's license number, a passport number, a military ID number, a state or federal ID number, etc.), business information (e.g., a business name, a business address, a business phone number, a business registration number, etc.), bank account information (e.g., a bank name, an account number, a routing number, a balance amount, a deposit amount, an account open date), or a combination thereof) of each user associated with the agreement. Additionally, or alternatively, entry of the ledger 127 may include a smart contract generated by the clearance server 116 based on the agreement—e.g., the agreement information 110. The smart contract can be configured to release payments to the provider upon proof of delivery of the commodity or completion of certain milestones. For example, the clearance server 116 may receive verifiable data (e.g., from a sensor) that is recorded in the database 126 and that is associated with the first agreement. The verifiable data (e.g., sensor data) may indicate that a commodity was delivered and one or more characteristics of the commodity. Based on the verifiable data, the smart contract may determine that one or more conditions of the first agreement are satisfied and may authorize a disbursement of funds from the financial account.

In some implementations, the clearance server 116 may send an indication of the entry at the ledger 127 to the core server 250 (e.g., the account manager 257). The core server 250 (e.g., the account manager 257) may then be able to access the entry from the ledger 127 to read from or write to the entry. For example, the core server 250 may send a database access request 248 to the clearance server 116 to access the entry. Additionally, the core server 250 (e.g., the account manager 257) can receive verified user data from the customer manager 255, such as user data for one or more users associated with the agreement.

In some implementations, the tariff module 253 may determine one or more fees based on the entry in the ledger 127, and the one or more fees may be represented by fee information 249. The one or more fees represented by the fee information 249) may include a service fee, a regulatory fee, or a combination, as illustrative, non-limiting examples. The tariff module 253 may provide the fee information 249 to the account manager 257, the clearance server 116, the database 126, or a combination thereof. In some implementations, the tariff module 253 sends the fee information 249 to the account manager 257 and the account manager 257 updates the entry in the ledger 127 with the fee information 249 using the database access request 248. In some implementations, the clearance server 116 or the core server 250 is configured to generate or provide payment status summary information associated with the agreement (e.g., the entry in the ledger 127). The payment status information may include or indicate an amount paid, an amount owed, a payor, a payee, the fee information 249 (e.g., a service fee or a regulatory fee), a payment due date, an agreement ID of the agreement, an agreement status, or a combination thereof, as illustrative, non-limiting examples.

In some implementations, the clearance server 116 may receive an additional agreement related to the original agreement (e.g., the entry at the ledger 127). For example, the additional agreement may include or correspond to an assignment, a cession agreement, a lien instrument, a reassignment of payment, or a combination thereof, that is related to the original agreement. The clearance server 116 may confirm existence of the additional agreement as described herein at least with reference to FIG. 1A. Additionally, the clearance server 116 may update the entry at the ledger 127 and/or send an indication to the core server 250 (e.g., the account manager 257). In some such implementations, the core server 250 may update the fee information 249 associated with the agreement based on receiving notification of the additional agreement. For example, the account manager 257 may cause the fee manager (e.g., the tariff module 253) to determine updated fee information.

The clearance server 116 may send an account request 172 to the core server 250, the institution server 150, or a combination thereof. The account request 172 may request the core server 250, the institution server 150, or both, to open one or more accounts associated with the agreement (e.g., the entry in the ledger 127). In some implementations, the clearance server 116 sends the account request 172 to the core server 250 and the core server 250 sends at least a portion of the account request to the institution server 150. For example, the account manager 257 may send the account request 172 (or another request based on the account request 172) to the institution server 150.

The core server 250 may, based on the account request 172, establish a transfer account (e.g., a payment transit account) that is associated with the agreement (and/or the entry in the ledger 127). The transfer account may have a transfer account ID, such as an account number, a routing number, a code, a barcode, a QR code, or a combination thereof. Additionally, or alternatively, the institution server 150 may, based on the account request 172, establish a financial account, such as a fiduciary account, that is associated with the agreement (and/or the entry in the ledger 127). The financial account may include or correspond to the account information 158 of FIG. 1A. The financial account may include a financial account ID, such as an account number, a code (e.g., a QR code), or a combination thereof, and the institution server 150 may send such information to the core server 250, the clearance server 116, or both.

In some implementations, the transfer account (e.g., the payment transit account) is configured to clear payments and receipts through one bank account and then apply them to a specific bank account during bank statement processing. For example, a transfer 292 (e.g., a payment) associated with the agreement may be initiated by a payor and the transfer account may receive the payment from an account of the payor and apply the payment to the financial account at the institution server 150.

The clearance server 116 may receive the account ID 174 from the core server 250, the institution server 150, or both. The account ID 174 may include or indicate account information for the transfer account, the financial account, or both. In some implementations, the account ID 174 includes a code (e.g., a QR code) that corresponds to the transfer account or the financial account. The clearance server 116, the core server 250, or both may send the QR code to one or more users associated with the agreement (e.g., the entry in the ledger 127).

In some implementations, after the transfer account, the financial account, or both are opened, the clearance server 116 and/or the core server 250 may monitor transactions associated with the transfer account, the financial account, or both. Additionally, or alternatively, the clearance server 116 and/or the core server 250 may communicate with one or more user devices, such as the producer device 102, the offtaker device 130, or the recipient device 140, to provide information associated with the agreement (e.g., the entry in the ledger 127), such as a status update. For example, a user may use a user application (e.g., a web platform or a mobile app) associated with the clearance server 116 or the core server 250 to access an account of the user and obtain the information associated with the agreement, such as an account status or status update.

The core server 250 may receive or identify the transfer 292 (e.g., a payment) associated with the agreement. In some implementations, the transfer 292 is received by the core server 250 and the core server 250 manages receipt of the transfer 292 to the transfer account, as well as managing the sending of the transfer 292 from the transfer account to the financial account at the institution server 150. For example, a payment processing portion of the core server 250 may receive the transfer 292 associated with the transfer account and provide an amount to the financial account at the institution server 150. The provided amount may be equal to the amount of the transfer 292 minus one or more fees associated with the agreement (e.g., the entry in the ledger 127). In other implementations, the core server 250 identifies that transfer 292 occurred at the financial account at the institution server 150 based on accessing the financial account at the institution server 150.

The core server 250 may determine one or more disbursements (e.g., account and amount) associated with the funds in the financial account. For example, the core server 250 (e.g., the account manager 257) may determine the one or more disbursements based on the database 126 (e.g., the entry in the ledger 127). To illustrate, based on the transfer account and/or the financial account, the core server 250 may identify the entry in the ledger 127 and access the entry. The core server 250 (e.g., the account manager 257) may generate disbursement information 260 that indicates the one or more disbursements and send the disbursement information 260 the institution server 150 to cause the funds of the financial account to be disbursed. In some implementations, the core server 250 may confirm that the funds are disbursed and/or may send a notification to one or more users that the funds have been disbursed. Additionally, or alternatively, the core server 250 (e.g., the account manager 257) may update the entry in the ledger 127 to indicate completion of the one or more disbursements.

The clearance server 116 and/or the core server 250 (e.g., the account manager 257) may determine that the agreement has been completed. For example, the core server 250 (e.g., the account manager 257) may access the entry in the ledger 127 and determine that all user accounts have been settled and that no additional payment(s) are due. Based on a determination that the agreement has been completed, the clearance server 116 and/or the core server 250 (e.g., the account manager 257) may send a closure request 262 to the institution server 150 to close the financial account. Additionally, or alternatively, based on a determination that the agreement has been completed, the core server 250 may close the transfer account—e.g., such that the transfer account is no longer able to receive payments. Additionally, the clearance server 116 and/or the core server 250 (e.g., the account manager 257) may identify or designate the entry in the ledger 127 as archived.

In some examples of operation of the system 200, a user (e.g., a producer) may engage in a purchase/sale transaction of equipment or supplies. To illustrate, an agricultural company (the recipient) may sell equipment (a tractor) or supplies to another company (the producer). Payment is to be made after equipment/supply delivery and is managed through a financial account provided by the financial institution associated with the institution server 150. The clearance server 116, operating in conjunction with the core server 250, may be positioned as a third party that is configured to facilitate and monitor the transaction process.

To facilitate and monitor the transaction process, the clearance server 116 may perform an onboarding operation with a user, such as the producer associated with the producer device 102, the recipient associated with the recipient device 140, or both. The clearance server 116 (or the core server 250) may use a KYC process to ensure regulatory compliance and minimize risks. For example, the clearance server 116 may notify the core server 250 to perform the KYC process for the user, and the core server 250 (e.g., the customer manager 255) may perform the KYC processing using a KYC resource located at an external device, such as the institution server 150. In some implementations, the customer manager 255 may be used to centrally register qualified and validated participants, corresponding profile information, connections, and specific parameters. As part of the onboarding, the user may designate or create a master account, such as a banking account that is under the control of the user. In some implementations, the user may elect to create a master account at a financial institution associated with the institution server 150, and the clearance server 116 may facilitate or assist in the opening of the master account.

The producer and the recipient may enter into a sales contract that includes a promissory note. The clearance server 116 (or the core server 250) may digitally record and store the contract at the ledger 127, thereby ensuring easy access and management of agreed terms. For example, the clearance server 116 may receive a copy of the contract from one of the producer or the recipient, and the clearance server 116 may confirm the contract with the other of the producer or the recipient. In some implementations, a back-office team (e.g., support staff associated with an entity that provides services associated with the clearance server 116) can assist the producer and/or the recipient in verifying the documents related to the contract and helping obtain digital signatures through an application of the clearance server 116 that is used by the producer and/or the recipient. The clearance server 116 may generate (e.g., automatically or manually generate) a smart contract (e.g., executable code) based on the terms of the contract.

The core server 250 may create a payment transit account at the core server 250 to manage transactions and payments. Additionally, or alternatively, the core server 250 (e.g., the account manager 257) may initiate or request the institution server 150 to open a financial account (e.g., a fiduciary account) associated with the contract. For example, the account manager 257 may ensure that all account parameters are correctly configured by the institution server 150 prior to opening of the financial account. In some implementations, the payment transit account and/or the financial account may be opened after confirmation of the contract by the producer and the recipient.

In some embodiments, the producer may finance part of the payment through another party (e.g., an assignee), such as a financial institution. In such embodiments, a payment assignment agreement can be established between the producer, the recipient, and the assignee, allowing part of the payment to be directly transferred to the assignee from the financial account. The core server 250 can subsequently initiate distribution the funds using the account manager 257 (e.g., the account management module) to cause final settlement operations occur in the financial accounts at the financial institution.

The clearance server 116 may facilitate the issuance of the credit assignment notification and payment assignment agreement. For example, the clearance server 116 may ensure that these documents are prepared, reviewed, and stored in the ledger 127 (e.g., a Blockchain system), in addition to coordinating the obtaining of digital signatures through the application of the clearance server 116.

Prior to settlement in the financial account, the core server 250 can monitor preparatory transactions, thereby applying the tariff module 253 (e.g., a fee module) to calculate and charge any associated fees, such as performing fund reservation and any fee for operation of or services provided by the clearance server 116, the core server 250, or a combination thereof.

Throughout the process, the producer (a user) and/or the recipient can use the application of the clearance server 116 to track a transaction status, verify documents, and/or communicate with support staff of the clearance server 116. Additionally, the core server 250 can provide, via the clearance server 116 and/or the application of the clearance server 116, all transaction information and operation and fee statements in real-time (or near real-time).

After the delivery of the equipment/supplies, payment can be initiated by the producer via the producer device 102 and processed by the core server 250. The core server 250 can ensure that funds are transferred from the producer's account to the financial account at the financial institution. Payment is then distributed from the financial account to the recipient and, if applicable, the assignee, as per the established agreements.

After payments are finalized and obligations met (e.g., a contract/agreement is completed), the core server 250 coordinates the closure of the financial account with the financial account, thereby ensuring that all final steps are properly documented and filed.

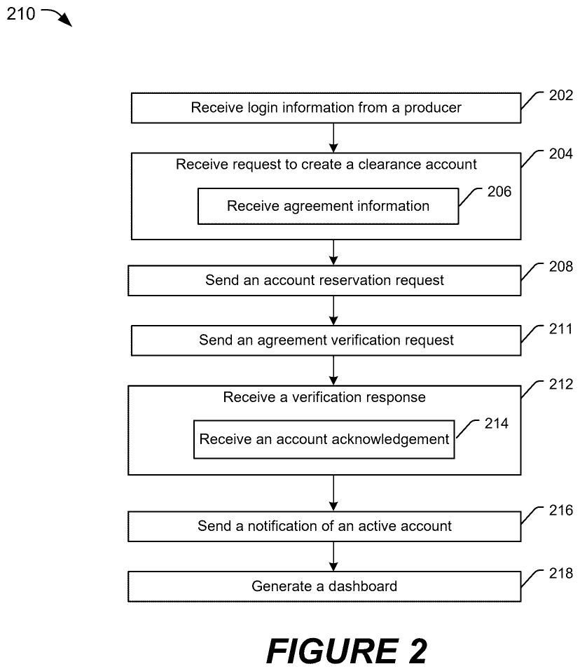

In the examples described above at least with reference to the system 200 FIG. 2, the core server 250 can advantageously ensure that the necessary funds are available and reserved for the transaction prior to settlement by the financial institution. Additionally, or alternatively, the core server 250 can ensure that all transactions meet the criteria established in the contract and that all necessary authorizations have been obtained. Accordingly, the core server 250 allows for efficient, secure, and transparent management of complex transactions, maximizing operational efficiency and customer satisfaction. The clearance server 116 and/or the core server 250 simplifies the management of complex financial transactions and offers a robust platform for continuous innovation of secure data structures for providing trackable and verifiable actions with respect to contracts and agreements.

In some implementations, the clearance server 116 and/or the application of the clearance server 116 may provide or support dynamic user profiles and dashboards that allow users to dynamically select and change profiles based on action(s) being performed within the system 100 or 200. Additionally, or alternatively, the clearance server 116 and/or the application of the clearance server 116 may provide or support document management and comparison, which may include features for uploading, digitizing, and comparing documents using optical character recognition (OCR) technology, supporting a variety of document types and formats, including a portable document file (PDF) format.

In some embodiments, the system 100 or 200 may include or utilize a payment platform (e.g., an instant payment platform), such as PIX. In some embodiments, the payment platform may include or correspond to the core server 250. It is noted that PIX is an instant payment platform that operates in Brazil. PIX allows merchants to collect funds in real time without the need for intermediaries. The instant payment platform (e.g., PIX) may be used as a transfer mechanism, linking a unique key (e.g., a PIX key) to an account to simplify transactions. The core server 250 (or the clearance server 116) may be configured to generate, at the time of creating the transitional accounts, a random key (e.g., a unique key, such as a PIX key) for the account, and the random key may be recorded for receipt and execution of payments. For example, the random key may include a QR code.

In some implementations, the core server 250 or the clearance server 116 may be configured to manage a contract dispute. For example, the core server 250 or the clearance server 116 may include functionalities for marking disputes and notifying all involved parties. In some implementations, the clearance server 116 is configured to initiate an arbitration process or a dispute resolution process in association with the dispute. The arbitration process or dispute resolution process may access, rely on, or interpret information included in the database 126 to rapidly render an enforceable ruling.

In the event of a dispute, fund transfers out of the financial account (e.g., the transitory account) may be restricted (e.g., to an undisputed portion or to a percentage of a total contract amount) or prohibited, such as by the clearance server 116 or the core server 250. In other implementations, all payments out of the financial account (e.g., the transitory account) may be suspended or put on hold by the clearance server 116 or the core server 250 until the dispute is resolved. Based on resolution of the dispute, funds may again be transferred out of the account based on the original agreement or based on a resolution agreement of the dispute. The resolution agreement of the dispute may be received by the clearance server 116 and stored at the database 126.

In some implementations, users or operators of the system 100 or 200 may have distinct access levels within the system. Different levels of access may cater to different management hierarchies within a financial institution or organization and ensure compliance with financial regulations. Various access levels may correspond to different parties to agreements, different types of devices used to access the clearance server 116, associations with financial entities or intermediaries, other characteristics, or a combination thereof. In some embodiments, each access level may provide access to a subset of documents or privileges, with a lowest level providing only access to view certain documents such as the agreement, and higher levels providing the ability to approve payments, add parties to agreements, confirm accounts, or the like.

In some implementations of the system 100 or 200, the clearance server 116 is configured to generate, based on one or more entries of the database 126, historical data associated with a user, such as the first user (e.g., the producer) or the second user (e.g., the offtaker), or an entity. The historical data may include an aggregation of data from the one or more entries, a result of one or more analysis of the one or more entries, or a combination there. Based on the historical data, user information associated with the user, or a combination thereof, the clearance server 116 may determine one or more metrics associated with the user. The one or more metrics may include a risk score (e.g., a liability score) associated with the user, an on-time delivery rate associated with the user, a number of defaults of the user, a total volume of product sold or received by the user, one or more quality indicators of the product produced by the user, or a combination thereof. In some implementations, the historical data and/or the one or more metrics may have a standard format, or the clearance server 116 may generate a report (e.g., a standardized report) that includes or indicates the historical data, the one or more metrics, or a combination thereof. Additionally, or alternatively, the clearance server 116 may provide the historical data, the one or more metrics, the user information, a user rating, a combination thereof, or a report thereof, to another entity, such as the user or another user, the core server 250, the financial institution, another entity (e.g., an insurance provider, a seller, a lender, etc.), or a combination thereof. For example, the clearance server 116 and/or the database 126 may include an API or enable an API call that enables a user or entity to access the historical data, the one or more metrics, the user information, a user rating, a combination thereof, or a report thereof, having a standardized format and/or data structure. In some implementations, the historical data, the one or more metrics, and/or a rating of a user may be updated periodically, such as hourly, daily, monthly, quarterly, yearly, based on completion of a contract, randomly, or a combination thereof.

In some implementations, the clearance server 116 may use the historical data, the one or more metrics, the risk score, the user information, or a combination thereof, to determine one or more fees associated with the user (e.g., the first user or the second user). For example, the lower the risk score, the lower a fee may be. As another example, the risk score may be used as a weight value that is applied to a standard fee to determine a fee for a user. As another example, frequent users of one or more services provided by the clearance server 116 may have a service fee reduced. Additionally, or alternatively, the clearance server 116 may, for at least one service of a set of services, determine a respective fee based on the one or more metrics associated with the user, and send, to a device of the user, an indication of the service and the respective fee. In some examples, the service may be an insurance product, such as an insurance product associated with the first agreement.

In some implementations, the clearance server 116 may request or enable a user to provide insurance information associated with an agreement to be recorded at the database 126. The insurance information may indicate, for an agreement (e.g., a contract) how premiums are calculated and disbursed. In some implementations, the clearance server 116 may also obtain and store weather data (e.g., sensor data) that may be submitted with an insurance claim.

In some implementations, the system 100 or 200 may support decentralized or consortium governance, such as formal processes for proposing and voting on updates that may ensure inclusive oversight. In such implementations, the system 100 or 200 may include a governance layer that logs proposals and votes on-chain (e.g., in entries of the blockchain), specifying how decisions affect the code or smart contract parameters. Additionally, or alternatively, farmer cooperatives, individual users, provider associations, and/or industry regulators may serve in an advisory capacity or auditing role having oversight (e.g., auditing the ledger, recommending fee changes, or mediating high-level disputes) associated with the system 100 or 200.

In some implementations, a server (e.g., the clearance server 116) includes at least one processor (e.g., the processor 118) and a memory (e.g., the memory 120) coupled with the at least one processor. The memory stores processor-readable instructions that, when executed by the at least one processor, cause the at least one processor to obtain first agreement data (e.g., the agreement information 110) associated with a first agreement between a first user and a second user. The instructions, when executed by the at least one processor, further cause the at least one processor to verify that the first agreement data associated with the first agreement is valid based on a first input received from a first device (e.g., the producer device 102) associated with the first user, a second input received from a second device (e.g., the offtaker device 130) associated with the second user, or a combination thereof. The instructions, when executed by the at least one processor, also cause the at least one processor to, after verification of the first agreement, send a request (e.g., the account request 172) to create, at an institution server (e.g., the institution server 150), a financial account (e.g., represented by the account information 158) associated with the first agreement. The instructions, when executed by the at least one processor, cause the at least one processor to store, at a database (e.g., the database 126), first entry information at a first entry associated with the first agreement. The first entry information indicates the first user, the second user, the first agreement data, the financial account, or a combination thereof.

In some implementations, a server (e.g., the core server 250) includes at least one processor (e.g., the processor 252) and a memory (e.g., the memory 254) coupled with the at least one processor. The memory stores processor-readable instructions that, when executed by the at least one processor, cause the at least one processor to identify a financial account (e.g., represented by the account information 158) at an institution server (e.g., the institution server 150). The financial account is associated with a first agreement between a first user and a second user. The first user is a beneficiary of the financial account, and an entity associated with a core server (e.g., the core server 250) has agency over the financial account. The instructions, when executed by the at least one processor, also cause the at least one processor to identify a transfer (e.g., the transfer 292) made to the financial account. The instructions, when executed by the at least one processor, further cause the at least one processor to, after identification of the transfer, send, to the institution server, a request (e.g., represented by the disbursement information 260) to perform one or more disbursements from the financial account. The one or more disbursements are determined based on a first entry in a database (e.g., the database 126). The first entry is associated with the first agreement and indicates the first user, the second user, first agreement data (e.g., the agreement information 110) associated with the first user, the financial account, or a combination thereof. The instructions, when executed by the at least one processor, cause the at least one processor to send a notification that indicates a first disbursement to a first account associated with the first user.

In some implementations, a system includes a clearance server (e.g., the clearance server 116) that is configured to obtain first agreement data (e.g., the agreement information 110) associated with a first agreement between a first user and a second user. The clearance server is also configured to verify that the first agreement data associated with the first agreement is valid based on a first input received from a first device (e.g., the producer device 102) associated with a first user, a second input received from a second device (e.g., the offtaker device 130) associated with the second user, or a combination thereof. The clearance server is further configured to, after verification of the first agreement, send a request (e.g., the account request 172) to create, at an institution server (e.g., the institution server 150), a financial account (e.g., represented by the account information 158) associated with the first agreement. The clearance server is configured to store, at a database (e.g., the database 126), first entry information at a first entry associated with the first agreement. The first entry information indicates the first user, the second user, the first agreement data, the financial account, or a combination thereof. In some implementations, the system that includes the clearance server also includes a core server (e.g., the core server 250), the institution server, the database, or a combination thereof.

The system 100 or 200 provides an ecosystem and supports a process to manage clearance of payment between parties in a secure and transparent manner that reduces fraud, improves efficiency, and provides secure communication. To illustrate, the system 100 or 200 may support a payment process and/or payment solution having security and compliance aspects. For example, the database 126 may enable sensitive contract terms, lien records, payment details, or a combination thereof to remain confidential. As another example, the system 100 or 200 may use end-to-end encryption and robust key management, specifying how different stakeholders are granted role-based permissions to access the platform of the clearance server 116 and/or the database 126. Accordingly, the system 100 or 200 provides a technical advantage by providing a verifiable, technological solution that is transparent, secure, and equitable in order to mitigate and resolve problems of improper data handling and recordkeeping, payment uncertainty, hidden liens, fraud, and the like.

Additionally, or alternatively, the system 100 or 200 may comply with relevant regulations and security protocols to protect funds and personal information of one or more users. For example, the system 100 or 200 may provide an auditable trail of contract events and payment flows that ensures compliance with local or international regulations (e.g., anti-money-laundering, financial reporting). To illustrate, the clearance server 116 may designate authorized regulators to access the database 126 and/or may generate reports to meet statutory requirements

One or more devices of the system 100 or 200 can implement security features via software and using processes according to Information Security Policies for all roles and positions needed to guarantee a secure operation. In some implementations, the system 100 or 200 has a zero-trust security posture. Additionally, or alternatively, the system 100 or 200 can implement a continuous compliance process that analyzes, notifies, and automatically configures resources to fulfill security policies.

In some implementations, one or more devices of the system 100 or 200 may be implemented using a cloud-based infrastructure. For example, one or more devices of the system 100 or 200 may have an infrastructure that is a cloud-based infrastructure, such as infrastructure(s) supported by AWS Data centers, that adhere to guidelines and regulations. For example, the cloud-based infrastructure can adhere to guidelines and regulations of a financial banking system (e.g., the Brazil banking system). Additionally, or alternatively, the system 100 or 200 may enable new or additional parties to use the system 100 or 200 without disturbing existing contractual relationships. For example, the system 100 or 200 may implement a microservices or modular approach, allowing each microservice or modular component (e.g., a payment service, an identity verification service, a contract authentication/validation service, or an arbitration service) to function independently yet integrate seamlessly.

The system 100 or 200 can store a minimal set of data such that enough information is available to tailor and monitor the quality of service and to execute the business logic of the features of the system 100 or 200 and adhere to local regulations, such as personally identifiable information (PII), know your customer (KYC) compliance, anti-money laundering (AML) compliance, and the like. Data, such as customer data or transaction data, of the system 100 or 200 can be encrypted (e.g., AWS encrypted) in transit and at rest. Additionally, or alternatively, the data may also be stored in a repository due to compliance or regulation needs.

The system 100 or 200 can have offline capabilities for a user entry point. For example, one or more devices or applications of the system 100 or 200 may have a monolith application (e.g., offline first data capture applications, that do not rely on a server). When the offline capabilities are not needed, an application can leverage auto scaling kubernetes-based microservice and micro frontends for scalable and fast responding features. Additionally, or alternatively, the system 100 or 200 can provide an offline mobile or SMS-based solutions that can capture transactions locally and sync later. For example, a mobile device, such as the producer device 102, may record event data that is cryptographically signed and stored temporarily, then synchronized with the database 126 and/or the clearance server 116 once connectivity is restored to the mobile device.

The system 100 or 200 (e.g., the infrastructure of the system 100 or 200) can ensure data ownership of different parties/entities, such as data owned by a financial institution (e.g., Banco do Brasil) and/or data managed by the clearance server 116, independent of each organizations' existing infrastructures. The system 100 or 200 (e.g., the infrastructure of the system 100 or 200) can adhere to security and compliance standards, including a zero-trust security posture and continuous compliance monitoring, such as with support from Prisma Cloud. The system 100 or 200 (e.g., the infrastructure of the system 100 or 200) may include or have access to Blockchain technology to enhance transaction security and transparency. In some implementations, the Blockchain technology may include or host the ledger 127. Additionally, or alternatively, the system 100 or 200 (e.g., the clearance server 116, the core server 250, or the institution server 150) may provide a web platform accessible via a desktop computer or a mobile device.

The system 100 as described with reference to FIG. 1A, and/or the system 200 as described with reference to FIG. 1B, confers numerous advantages. One such advantage may include providing access to verified and secured data related to contracts for additional parties for future obligations. Another advantage may include blockchain-enabled solutions. For example, the system 100 or 200 may incorporate blockchain technology to further enhance respective system capabilities, leveraging key features like: immutable records, decentralization, transparency, smart contracts, verification (e.g., enhanced verification), reduced counterparty risks, efficient dispute resolution, data encryption, reduced operational risk, traceability, or a combination thereof. Additionally, through collaboration with the institution server 150 (e.g., a financial institution) and adherence to stringent security and compliance standards, the system 100 or 200 can improve the technical field of clearance systems and significantly enhance the clearance capabilities within a business chain (e.g., the agribusiness chain), providing a robust, secure, and user-friendly platform for all stakeholders.

Use of blockchain may provide security, privacy, reliability, immutability, trust, or a combination thereof. In terms of security, a blockchain architecture is fully encrypted and includes multiple layers of security and is future proof making it an advantageous technology for contract management and settlement. For privacy, a forward contract may include sensitive information, and the owner of the contract is able to have granular control over who and when anyone else can view and/or access documents. Regarding reliability, the auto executing ability of a smart contract ensures that the rules of the contract are enforced, thereby helping to reduce and/or eliminate fraud. In terms of immutability, any changes to an account or terms of the contract are recorded in an immutable record which may enable enhanced trust and visibility. For trust, each of the properties of security, privacy, reliability, and/or immutability increases trust in the platform. Additionally, the use of the platform proposed transparency of user intentions and actions increase trust between counter parties.

Another advantage of the system 100 or 200, such as the database 126, may include improved data security and entry tracking due to using immutable records, such as records that utilize or leverage cryptographic hashing, block linking, or a combination thereof. Cryptographic hashing utilizes cryptographic hash functions (e.g., secure hash algorithm (SHA)-256) to generate unique hashes for each block. Any alteration in the block data alters its hash, signaling tampering. Block linking is used such that each block contains the hash of its predecessor, creating a chain. Altering a single block requires recalculating all subsequent blocks, a computationally prohibitive task.

Another advantage of the system 100 or 200, such as the database 126, may include decentralization, such as a distributed ledger, node consensus, or a combination thereof. The distributed ledger is configured to maintain the ledger across a network of nodes, thus eliminating single points of failure and decentralizing control. The node consensus implements consensus mechanisms, such as Proof of Work or Proof of Stake, for transaction validation, thereby ensuring no single entity controls the ledger's state.

Another advantage of the system 100 or 200, such as the database 126, may include transparency, such as a public ledger, an audit trail, or a combination thereof. The public ledger may allow all network participants to view the ledger, ensuring transparency in transactions and balances. The audit trail may maintain or provide a complete, verifiable, and unalterable history of transactions (e.g., all transactions) that is accessible for audit and verification.

Another advantage of the system 100 or 200, such as the database 126, may include the use of smart contracts, such as self-executing contracts, event-driven execution, or a combination thereof. The self-executing contracts may encode contract terms in programmable scripts, referred to smart contracts, that automatically execute based on predefined criteria, minimizing manual intervention and errors. The event-driven execution triggers contract execution based on predefined events, ensuring timely and objective contract fulfillment.

Another advantage of the system 100 or 200 may include verification (e.g., enhanced verification), such as digital signature, ID entity verification, or a combination thereof. Digital signatures are configured to employ cryptographic signatures, allowing parties to verifiably sign transactions and documents. ID entity verification integrates advanced identity verification protocols to authenticate users and counterparties.

Another advantage of the system 100 or 200 may include reduced counterparty risks, such as escrow mechanisms, real-time reconciliation, or a combination thereof. Escrow mechanisms utilize smart contracts to hold funds in escrow, releasing them only upon verified fulfillment of contract terms. Real-time reconciliation ensures immediate and transparent recording of transactions, mitigating delays and discrepancies.

Another advantage of the system 100 or 200 may include efficient dispute resolution, such as an immutable audit trail. The immutable audit trail may provide an indisputable record of transactions and interactions, simplifying dispute resolution.

Another advantage of the system 100 or 200 may include data encryption, such as end-to-end encryption, secure channels, or a combination thereof. The end-to-end encryption may secure data in transit and at rest using encryption, such as advanced encryption standards (AES) and/or Rivest-Shamir-Adleman (RSA). The secure channels may establish encrypted communication channels for data exchange, preserving confidentiality and integrity.

Another advantage of the system 100 or 200 may include reduced operational risk, such as resulting from automated processing, continuous monitoring, or a combination thereof. Automated processing may automate routine tasks and compliance checks, reducing human error and operational inefficiencies. The continuous monitoring may implement real-time monitoring and alerting systems to identify and mitigate risks promptly.

Another advantage of the system 100 or 200 may include traceability, such as timestamping, chain of custody, or a combination thereof. Timestamping may include recording exact time and sequence of transactions, providing a clear and traceable timeline. The chain of custody may maintain a transparent and traceable record of asset ownership and transfers throughout the asset lifecycle.

Referring to FIG. 2, a flow diagram illustrating an example process 210 that supports operation of a clearance system according to one or more aspects is depicted. Operations of the process 210 may be performed by a device or system, such as the system 100 or 200. Additionally, or alternatively, the device or system may include or correspond to a clearance platform. In some implementations, the clearance platform includes or corresponds to a server, such as the clearance server 116 described above with reference to FIG. 1A or 1B and/or the core server 250 described above with reference to FIG. 1B.

At block 202, the clearance platform receives login information from a producer. For example, the clearance server 116 may receive login information from the producer device 102. The producer device 102 may be associated with the producer. In some implementations, the producer may not have an account or login information established with the clearance platform. In such situations, the producer may establish the account or login information with the clearance platform prior to or as part of a login process for the producer to login to the clearance platform.

At block 204, the clearance platform receives a request to create a clearance account. For example, the clearance server 116 may receive the request from the producer device 102. In some implementations, the request is received from the producer (e.g., the producer device 102). The clearance account (e.g., a financial account) may be an account that is maintained or administered by an institution, such as an institution associated with the institution server 150. In some implementations, the clearance account may be associated with the producer, an agreement (e.g., agreement information), or a combination thereof. The agreement information may include or correspond to the agreement information 110. In some implementations, the request to create the clearance account may be received via a graphical user interface (GUI) as described further herein at least with reference to FIG. 3. Additionally, or alternatively, the clearance platform may receive a request to create a financial account (also referred to herein as a fiduciary account, a transfer account, a transit account, or a transitory account) that is maintained or administered by the core server 250.

In some implementations, at block 206, the clearance platform receives agreement information. For example, the clearance server 116 may receive the agreement information 110. In some implementations, the agreement information may be received as part of (e.g., included with) the request to create the clearance account after the request to create the clearance account. In some implementations, the agreement information may be received via a GUI as described further herein at least with reference to FIG. 3.

At block 208, the clearance platform sends an account reservation request based on receiving the request to create the clearance account. For example, the clearance server 116 may send the account request 172 to the institution server 150 and/or the core server 250. In some implementations, the account reservation request is sent via an API of the institution server 150. The account reservation request may cause the institution server 150 to generate an account for the producer and that is associated with the agreement information 110. Based on the account reservation request, the institution server 150 may generate account information (e.g., the account).

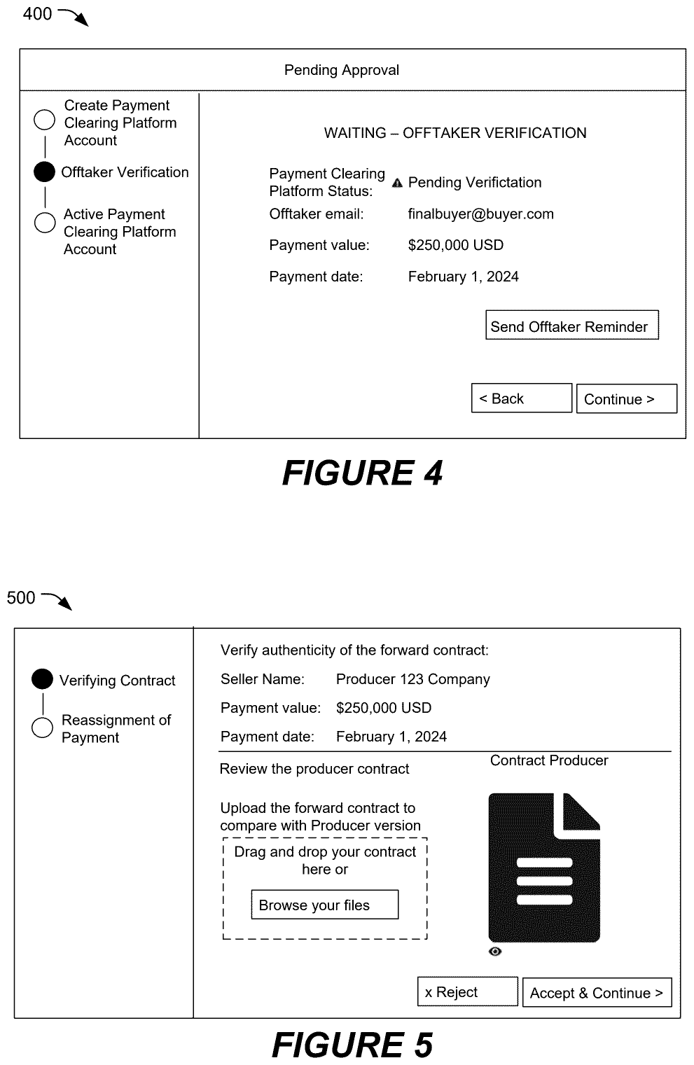

At block 211, the clearance platform sends an agreement verification request based on receiving the agreement information (e.g., based on the agreement information indicating that an entity, such as an offtaker, has entered into an agreement with the producer). For example, the clearance server 116 may send the verification request 176 to the offtake device 130. The offtaker device 130 may be associated with an offtaker that is associated with the producer based on the agreement information 110. In some implementations, the agreement verification request includes or indicates at least a portion of the agreement information 110. In some implementations, the agreement verification request may be sent based on an input received via a GUI, such as a GUI as described with reference to FIG. 3 or FIG. 4.

At block 212, the clearance platform receives a verification response based on sending the agreement verification request. For example, the clearance server 116 may receive the verification response 178 from the offtaker device 130. In some implementations, the verification response verifies the agreement information 110, which was provided to the clearance server 116 by the producer. Additionally, or alternatively, the verification response may include agreement information that is in the possession of the offtaker. Based on the agreement information received from the offtaker device 130, the clearance server 116 may compare the agreement information received from the producer device 102 and the agreement information received from the offtaker device 130. In some implementations, the verification response may be received via a GUI as described further herein at least with reference to FIG. 5.

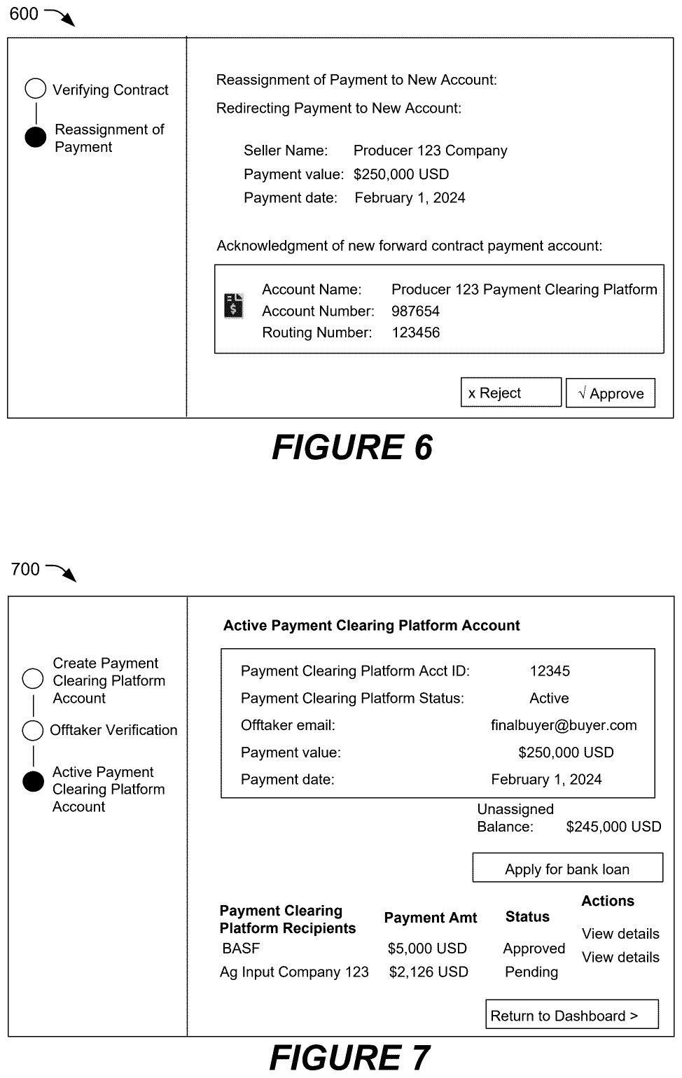

In some implementations, at block 214, the clearance platform receives an account acknowledgement. For example, the clearance server 116 may receive the account acknowledgement from the offtaker (e.g., the offtaker device 130) that indicates that the offtaker acknowledges that that the account at the institution has been established on behalf of the producer in relation to the agreement information 110. In some implementations, the account acknowledgement may be received via a GUI as described further herein at least with reference to FIG. 6.

At block 216, the clearance platform sends a notification of an active account. For example, the clearance server 116 may send the verification notification 180 to the producer device 102. Additionally, or alternatively, the clearance server 116 may send a similar or the same notification to the offtaker device 130, the institution server 150, or both. In some implementations, the notification may be sent via a communication, such as an email, a text message, or an automated phone call, or the notification may be received via a GUI, such as a GUI described further herein with reference to FIG. 7.

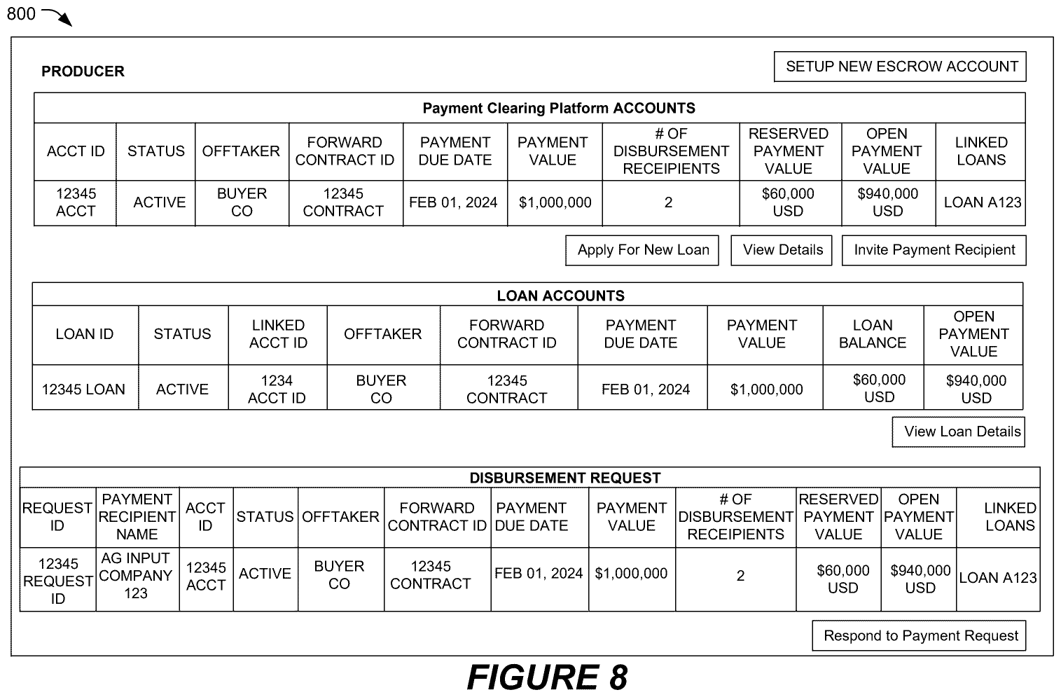

At block 218, the clearance platform generates a dashboard. For example, the clearance server 116 may generate a dashboard for the producer that includes information associated with the account at the institution, the agreement, or a combination thereof. In some implementations, the dashboard may include or correspond to a GUI, such as a GUI described further herein with reference to FIG. 8.

FIGS. 3-8 are diagrams of example graphical user interfaces (GUIs) to illustrate operation of a clearance system according to one or more aspects. FIGS. 3-8 may include or correspond to one or more GUIs that are associated with process 210. The one or more GUIs may be generated by clearance server 116 and/or displayed via another device, such as producer device 102 or offtaker device 130, respectively. In some implementations, the clearance server 116 may receive information from the database 126 and/or the core server 250 in order for one or more of the GUIs of FIGS. 3-8 to be generated.

FIG. 3 depicts an example of a GUI 300 to initiate a clearance account. During setup of a clearance account, a user, such as the producer, may fill out information associated with a contract, such as a forward contract. The information can include the offtaker e-mail address, the value of the contract, and the expected target payment date. Additionally, or alternatively, the producer may upload an existing contract (e.g., the agreement information 110) to start the process of creating a payment clearing account (e.g., a clearance account). For example, the producer uploads the contract which was executed with the offtaker to the platform to begin the process of creating a dedicated payment clearing account for the specific contract. Based on the uploaded forward contract, the institution associated with the institution server 150 may reserve a payment clearing account number that is associated with the producer, the forward contract, or a combination thereof.

FIG. 4 depicts an example of a GUI 400 to indicate that the producer is awaiting offtaker verification. For example, the producer may be on standby waiting for the offtaker to confirm the validity of the contract and binding agreement to pay the payment clearing account when settling the contract. At this point, the producer is in a holding pattern because action needs to take place from the offtaker in order for the process to continue. During this holding pattern (if the action is taking too long), the producer can send a reminder to the offtaker. The reminder may include or correspond to the verification request 176 of FIG. 1A.

An example of a GUI 500 to enable the offtaker to verify the contract, e.g., the forward contract. For example, verification of the contract via the GUI 500 may result in generation or transmission of the verification response 178 of FIG. 1A. The GUI 500 may provide the offtaker with the ability to verify and validate that this is a real contract and/or that the offtaker is a party to contract. For example, the offtaker may receive a request to verify the authenticity of the contract (e.g., the forward contract). The verification process can be done manually by the offtaker viewing the contract and verifying the contract based on observation. Alternatively, the verification process can be performed automatically if the offtaker is able to upload a copy of the contract (in the possession of the offtaker), so that a service running (e.g., executing) in the background can compare the uploaded contract to a contract provided by the producer to determine if the contracts match. In some examples, the service may be provided by the clearance server 116. In some implementations, the comparison may be performed between the two contracts to verify the terms. For example, a file match or an OCR match to may be performed to determine whether the uploaded by the offtaker matches the form of the contract provided by the producer. As another example, if the contract is uploaded by the producer, the offtaker can review the contract manually and indicate whether the contract is verified—e.g., a valid agreement exists between the producer and the offtaker.

FIG. 6 depicts an example of a GUI 600 to assign payment in association with the clearance account. For example, the offtaker may acknowledge and agree to pay the producer's dedicated payment clearing account when settling the forward contract via the GUI 600. Stated differently, the offtaker acknowledges and agrees to pay the payment clearing account associated with the producer and/or the contract when settling the contract. This acknowledgement may be legally binding.

FIG. 7 depicts an example of a GUI 700 to indicate that the clearance account set-up is complete and linked with the contract—e.g., the forward contract. For example, the producer may access and review the GUI 700 after the offtaker has verified that agreement and agreed to assign payment. In some implementations, the institution may also have visibility over the transaction.

FIG. 8 depicts an example dashboard GUI 800. The dashboard GUI 800 may correspond to a GUI through which the producer may review the status of one or more clearance accounts. The dashboard GUI 800 may enable the producer to have complete, real-time data on the payment clearing account, loans, and disbursements. Although the dashboard GUI 800 is described with reference to the producer, similar dashboard GUIs may also be generated for the offtaker, the recipient, another payee, another entity, etc.

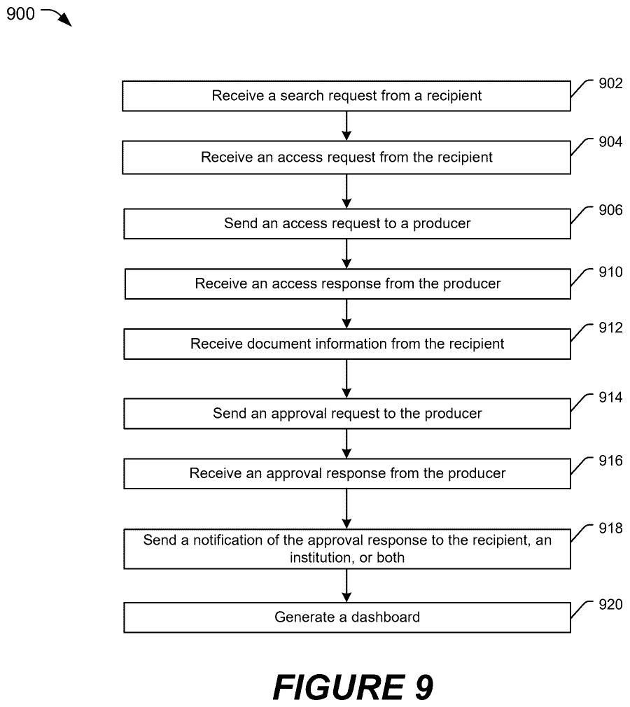

FIG. 9 is a flow diagram illustrating another example process 900 that supports operation of a clearance system according to one or more aspects. Operations of the process 900 may be performed by a device or a system, such as the system 100 or the system 200. Additionally, or alternatively, the device or the system may include or correspond to a clearance platform. In some implementations, the clearance platform includes or corresponds to the clearance server 116 described above with reference to FIG. 1A or 1B, or the core server 250 of FIG. 1B. In some implementations, one or more operations described with reference to the process 900 may occur after one or more operations performed as described with reference to the process 210 of FIG. 2.

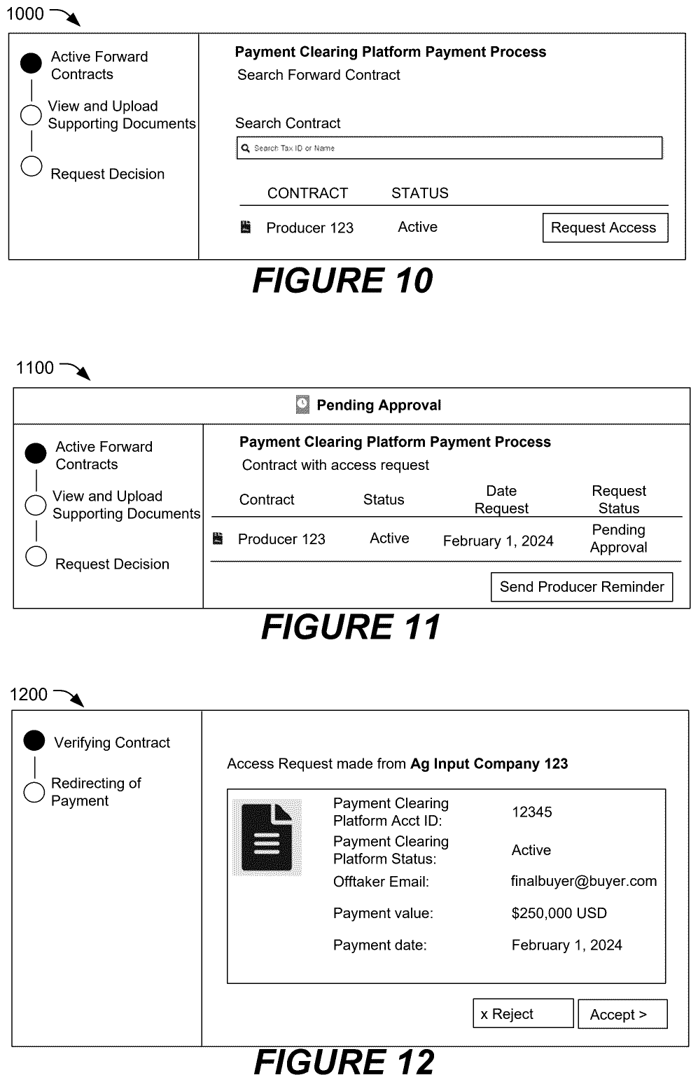

At block 902, the clearance platform receives a search request from a recipient. For example, the clearance server 116 may receive a search request from the recipient device 140. In some implementations, the search request may be received via a GUI, such as a GUI described further herein with reference to FIG. 10.

At block 904, the clearance platform receives an access request from the recipient. For example, the clearance server 116 may receive the request 182 from the recipient device 140. In some examples, the access request is received after search results are provided to the recipient based on receiving the search request, and the access request indicates one of the search results that is selected for access by the recipient. In some implementations, the access request may be received via a GUI, such as a GUI described further herein with reference to FIG. 11.

At block 906, the clearance platform sends an access request to a producer. For example, the clearance server 116 may send an access request to the producer device 102. The access request sent to the producer may indicate or correspond to a document, an agreement, a file, a data entry, or the like, that is indicated by the access request received from the recipient. In some implementations, the access request may be sent via a communication, such as an email, a text message, or an automated phone call, or may be received via a GUI, such as a GUI described further herein with reference to FIG. 12.

At block 910, the clearance platform receives an access response from the producer. For example, the clearance server 116 may receive the recipient authorization 184 from the producer device 102. The access response may indicate whether the producer grants access to the requested item to the recipient. In some implementations, the access response may be received via a GUI, such as a GUI described further herein with reference to FIG. 12.

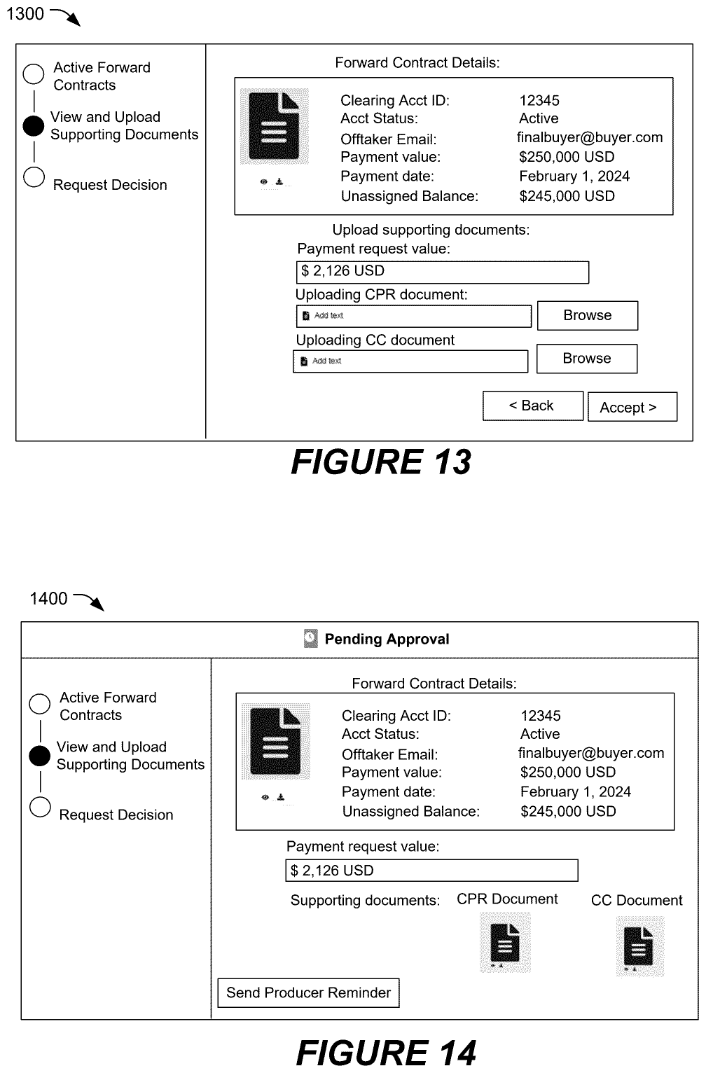

At block 912, the clearance platform receives document information from the recipient. For example, the clearance server 116 may receive the document information 186 from the recipient device 140. In some implementations, the document information may be received via a GUI, such as a GUI described further herein with reference to FIG. 13 or 14.

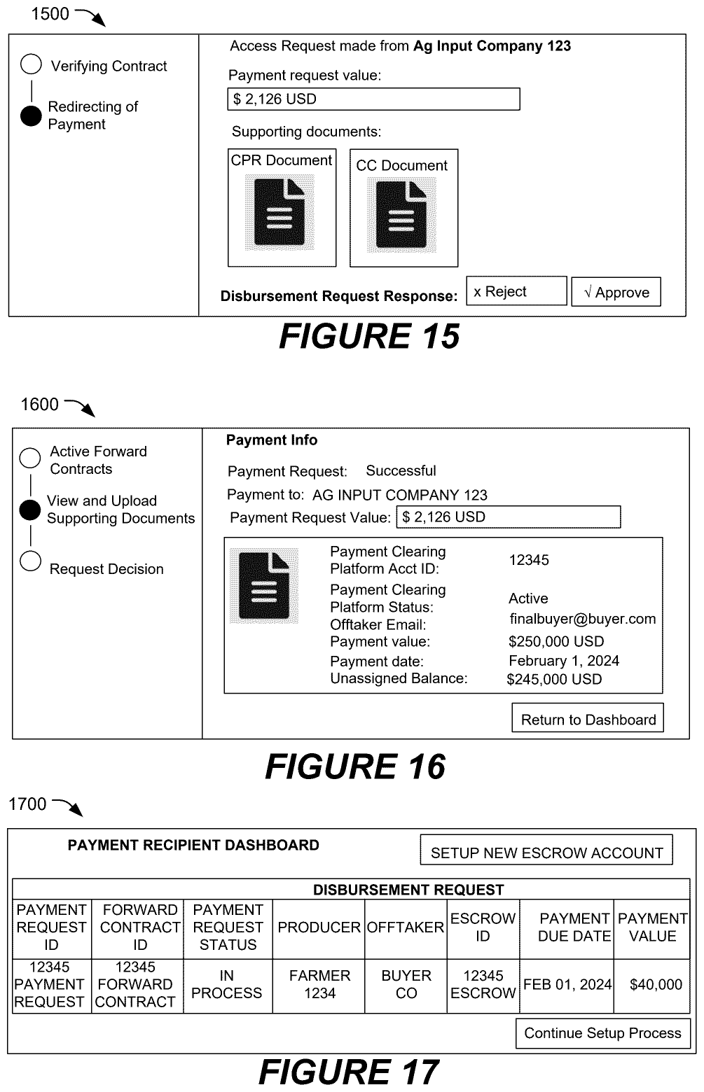

At block 914, the clearance platform sends an approval request to the producer. For example, the clearance server 116 may send an approval request to the producer device 102. The approval request may indicate a request that the producer approve or verify one or more documents represented by the document information received from the recipient. In some implementations, the approval request may be sent via a communication, such as an email, a text message, or an automated phone call, or may be received via a GUI, such as a GUI described further herein with reference to FIG. 15.

At block 916, the clearance platform receives an approval response from the producer. For example, the clearance server 116 may receive the recipient approval 188 from the producer device 102. The approval response may indicate whether the one or more documents represented by the document information received from the recipient are approved by the producer. In some implementations, the approval response may be received via a GUI, such as a GUI described further herein with reference to FIG. 15.

At block 918, the clearance platform sends a notification of the approval response to the recipient, an institution, or both. For example, the clearance server 116 may send the recipient information 190 to the recipient device 140, the institution server 150, or both. The approval response indicates whether the producer approved the one or more documents represented by the document data received from the recipient. In some implementations, the notification may be sent via a communication, such as an email, a text message, or an automated phone call, or may be received via a GUI, such as a GUI described further herein with reference to FIG. 16.

At block 920, the clearance platform generates a dashboard. For example, the clearance server 116 may generate a dashboard for the producer that includes information associated with the account (associated with the producer or the agreement information 110) at the institution, an account associated with the recipient, or a combination thereof. In some implementations, the dashboard may include or correspond to a GUI, such as a GUI described further herein with reference to FIG. 17.

FIGS. 10-17 and 31-37 are diagrams of example GUIs to illustrate operation of a clearance system according to one or more aspects. FIGS. 10-17 may include or correspond to one or more GUIs that are associated with the process 900. The one or more GUIs may be generated by the clearance server 116, generated by the core server 250, and/or displayed via another device, such as the producer device 102 or the offtaker device 130.

FIG. 10 depicts an example of a GUI 1000 to search for information associated with a producer. For example, the recipient may perform a search for a contract (e.g., a forward contract) using the producer's Tax ID or person/company name via the GUI 1000. Search results may allow the recipient to submit a request to the producer for permission to access and view forward contract details.

FIG. 11 depicts an example of a GUI 1100 to indicate that an offtaker is in standby waiting for a producer to respond to the permission request to access information of a forward contract. While the standby is indicated by the GUI 1100, the recipient can also send the producer a reminder to remind the producer to review a pending request.

FIG. 12 depicts an example of a GUI 1200 to enable a producer to approve a request for access to a specific forward contract. For example, the producer receives the request and decides whether to approve or deny the request to view contract information (e.g., forward contract information) from the offtaker via the GUI 1200.

FIG. 13 depicts an example of a GUI 1300 to enable the recipient to upload supporting documents and/or request payment. For example, after the recipient is granted access to view the contract (e.g., the forward contract), the GUI 1300 enables the recipient to upload supporting documents and request to receive a payment when the associated dedicated clearing account is funded—e.g., when the offtaker provides payment. Additionally, the recipient can view details pertaining to the contract, such as the payment date, the expected payment amounts, etc., via the GUI 1300. The recipient can select submit in the GUI 1300 and will then be in a holding pattern while waiting for the producer to verify and validate the information from the producer process flow.

FIG. 14 depicts an example of a GUI 1400 to indicate that the recipient is on standby waiting for a decision from the producer to approve a payment request (for the recipient) from the clearing account at time of offtaker payment. While the standby is indicated by the GUI 1400, the recipient can send a reminder to the producer via the GUI 1400.

FIG. 15 depicts an example of a GUI 1500 to enable the producer to make a decision on the payment request from the recipient. The producer may be provided with the documents that the recipient uploaded and may view the payment request, via the GUI 1500, to decide to either validate or reject the payment.

FIG. 16 depicts an example of a GUI 1600 to inform the recipient that the payment request is approved. Accordingly, the GUI 1600 represents that the recipient has an active pending disbursement that is scheduled to take place when the contract is settled. To illustrate, when the offtaker makes a payment to the clearance account (for the producer and associated with the contract) at the institution, the recipient will receive a portion of the payment.

FIG. 17 depicts an example dashboard GUI 1700. The dashboard GUI 1700 may correspond to a GUI via which the recipient may review the status of one or more clearance accounts. The dashboard GUI 1700 may enable the recipient to have complete, real-time data on the disbursements. It is noted that the dashboard GUI 1700 may enable the recipient to also manage other payment receipts from different participants.

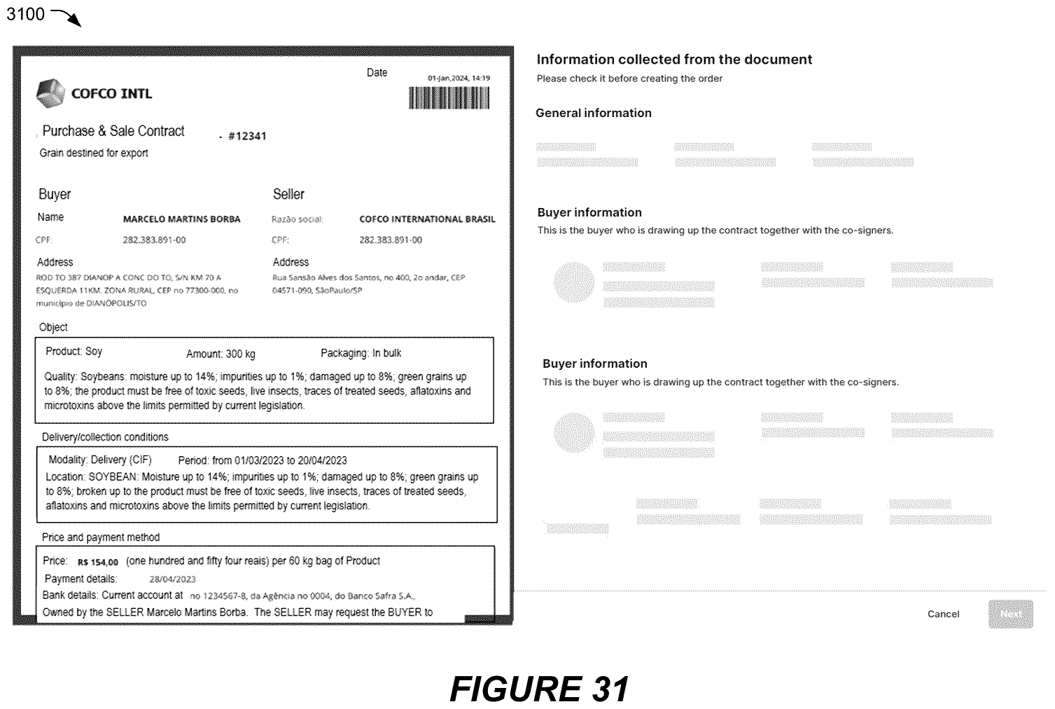

FIG. 31 depicts an example of a GUI 3100 to display an agreement. The GUI 3100 may include a first portion that displays (e.g., presents) agreement data, such as the agreement information 110 (e.g., agreement data), received from a first user. The agreement data may be associated with a first agreement between a first user and a second user. The GUI 3100 may include a second portion that indicates information to be collected from the displayed (e.g., presented) agreement data.

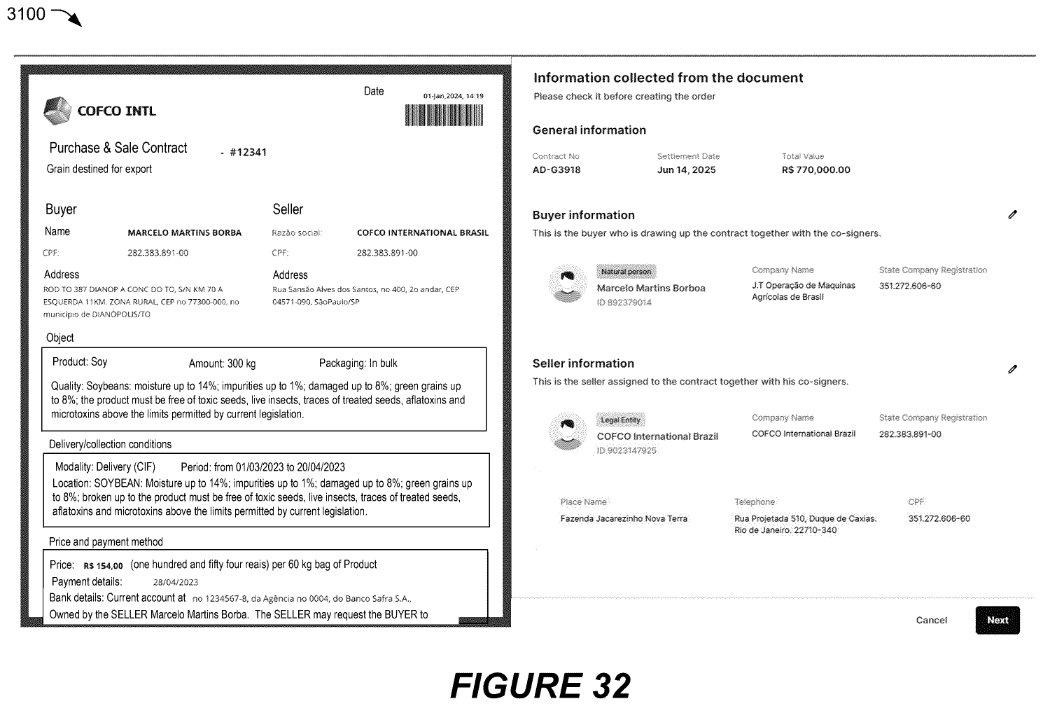

FIG. 32 depicts an example of a GUI 3200 to display information collected from an agreement. The GUI 3200 may include or correspond to the GUI 3100 after the information has been collected from the agreement data, which is presented in a first portion of the GUI 3200, and populated in a second portion of the GUI 3200. In some implementations, some of the information in the second portion of the GUI 3200 may be generated by a server (e.g., the clearance server 116). For example, the server may obtain user information from a database, such as the database 126, that is populated in the second portion of the GUI 3200. Additionally, or alternatively, the server may generate a unique ID, such as a contract number, to identify and/or track the agreement between the first user and the second user. The GUI 3200 may enable a user to edit the information that is displayed in the second portion.

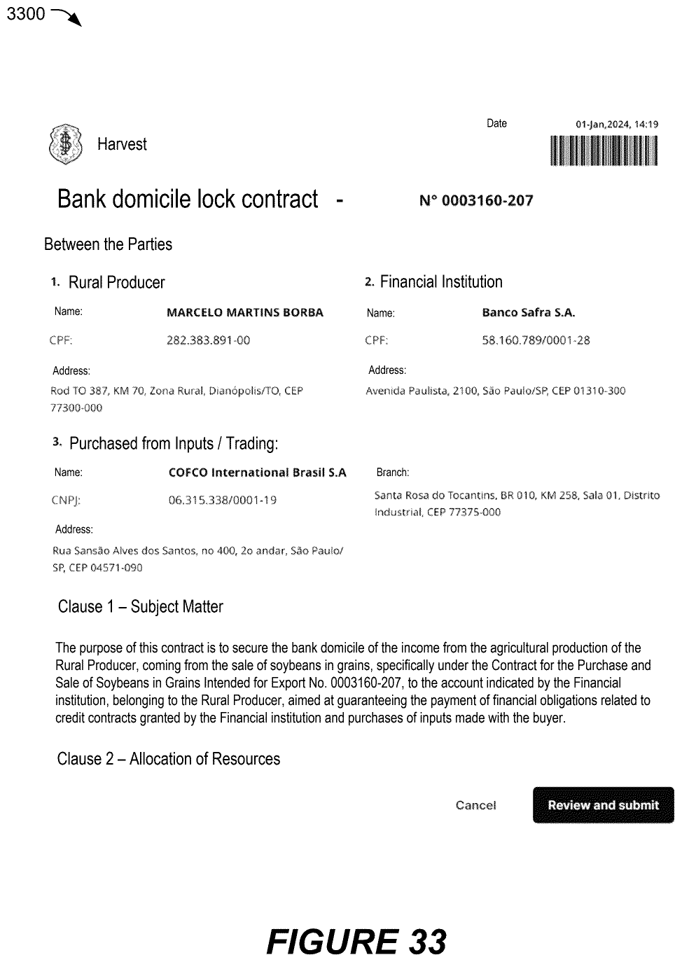

FIG. 33 depicts an example of a GUI 3300 to display another agreement. The other agreement, such as a second agreement, may be generated based on a first agreement (e.g., the agreement information 110), such as the agreement as described with reference to FIG. 31 or 32. The second agreement, which is displayed in the GUI 3300, may be between the first user, the second user, and an entity (e.g., a bank) that provides a financial account associated with the first agreement. The second agreement may indicate that the entity will provide the financial account and that the first and second users agree to use the financial account in association with the first agreement.

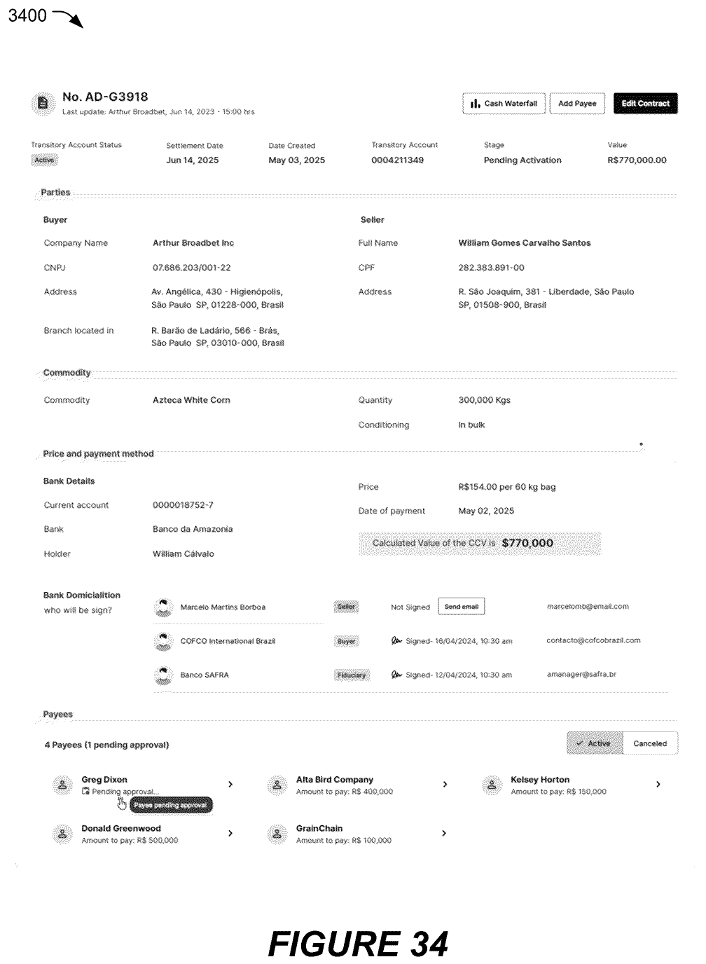

FIG. 34 depicts an example of a GUI 3400 to display a contract status. For example, the contract status may be represented by the agreement information 110. In some implementations, the contract status displayed or summarized in the GUI 3400 may indicate a status of the financial account (e.g., a transitory account), the parties to the contract, a commodity associated with the contract, a price and payment method, and one or more payees (e.g., recipients). The parties to the contract may include a seller (e.g., the producer) and a buyer (e.g., the offtaker). The price and payment method portion of the contract summary may be associated with an additional agreement between the buyer, the seller, and an entity (e.g., a bank) that provides a financial account associated with the contract. This additional agreement may indicate that the entity will provide the financial account and that the first and second users agree to use the financial account in association with the contract. In some implementations, the price and payment method portion of the contract summary may indicate a status of execution of the additional agreement. Additionally, or alternatively, the portion of the GUI 3400 that indicates the one or more payees may indicate a status or an amount to pay one or more of the indicated payees. A pending approval status may indicate that the payee has yet to be authorized or an invoice (e.g., the document information 186) has yet to be approved. Selection of a payee via the GUI 3400 may provide an additional GUI with payee information specific to the selected payee.

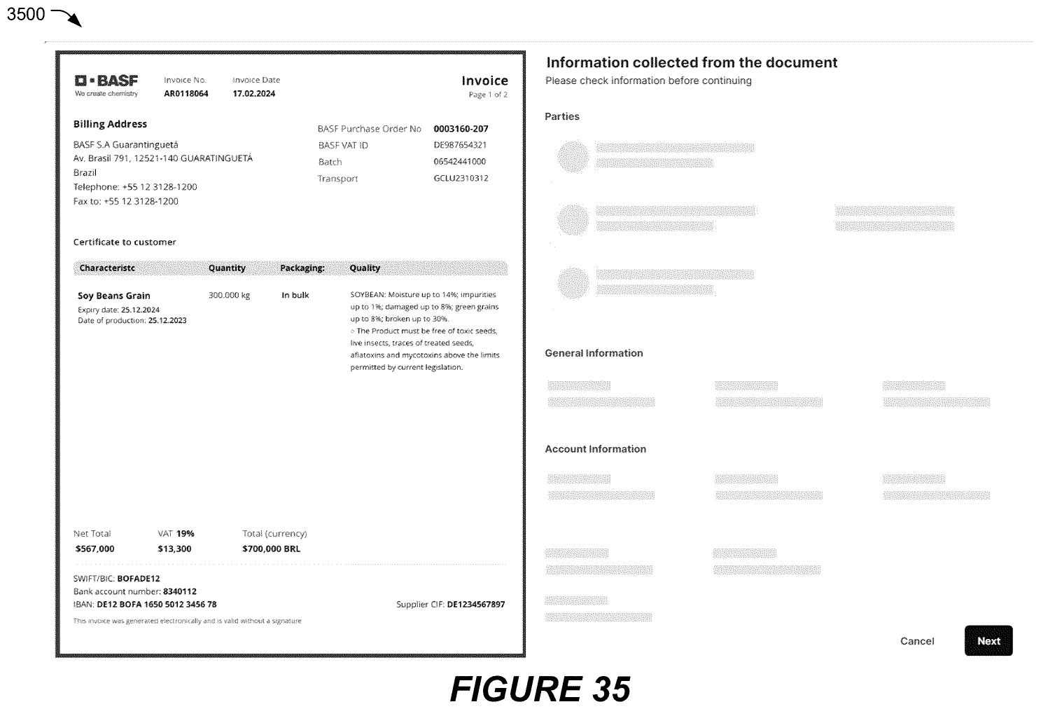

FIG. 35 depicts an example of a GUI 3500 to display an invoice. For example, the invoice may include or correspond to the document information 186. The GUI 3500 may include a first portion that displays or presents the invoice, such as the document information 186, received from a payee (e.g., a recipient). The invoice may be associated with an agreement, such as an agreement represented by the agreement information 110. The GUI 3500 may also include a second portion that indicates information to be collected from the displayed invoice.

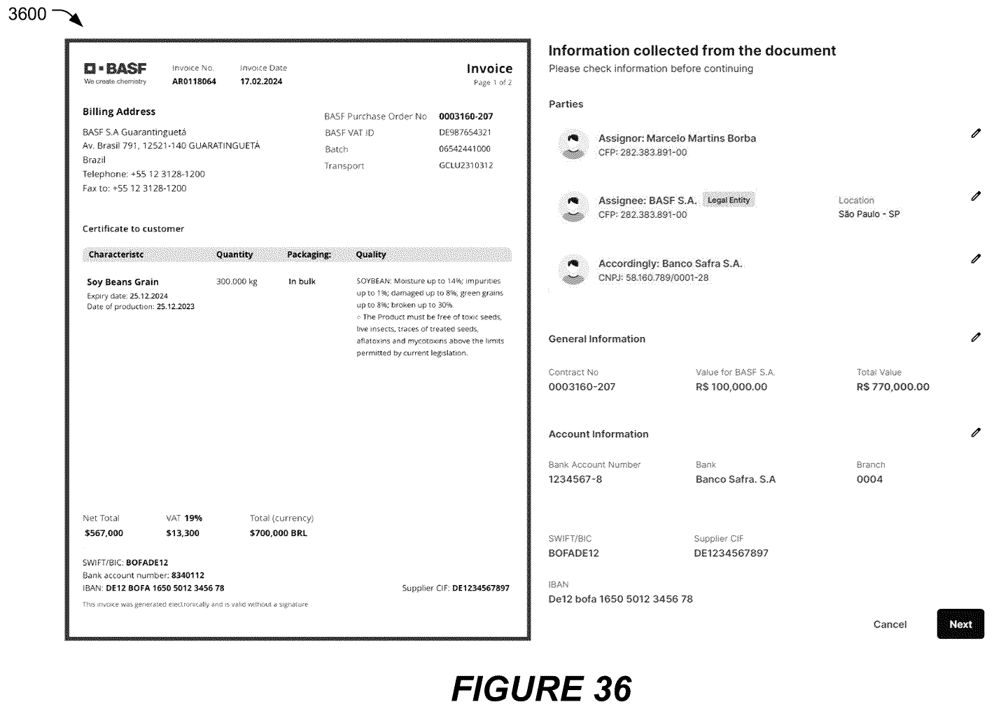

FIG. 36 depicts an example of a GUI 3600 to display information collected from an invoice. The GUI 3600 may include or correspond to the GUI 3500 after the information is collected from the invoice, displayed in a first portion of the GUI 3600, and populated in a second portion of the GUI 3600. In some implementations, some of the information in the second portion may be generated by a server (e.g., the clearance server 116). For example, the server may obtain user information from a database, such as the database 126, for display in the second portion of the GUI 3600.

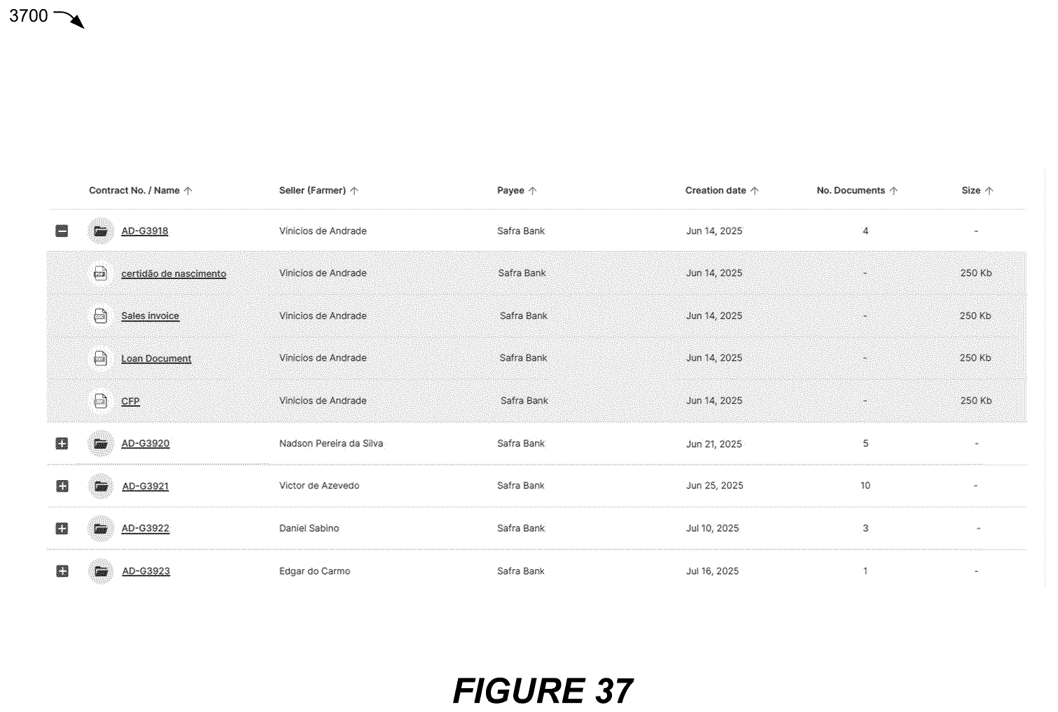

FIG. 37 depicts an example of a GUI 3700 to present a user dashboard associated with one or more contracts. In some implementations, the GUI 3700 is associated with a first user, such as a producer (e.g., seller). For each contract, the GUI 3700 may enable additional information to be presented or retrieved related to the respective contract. For example, as shown in FIG. 37, the contract AD-G3918 has four documents which include a user identity information document, a sales invoice, a loan document, and a contract for purchase (CFP) document, and one or more of the documents may be selected via the GUI 3700 to cause display of the selected document.

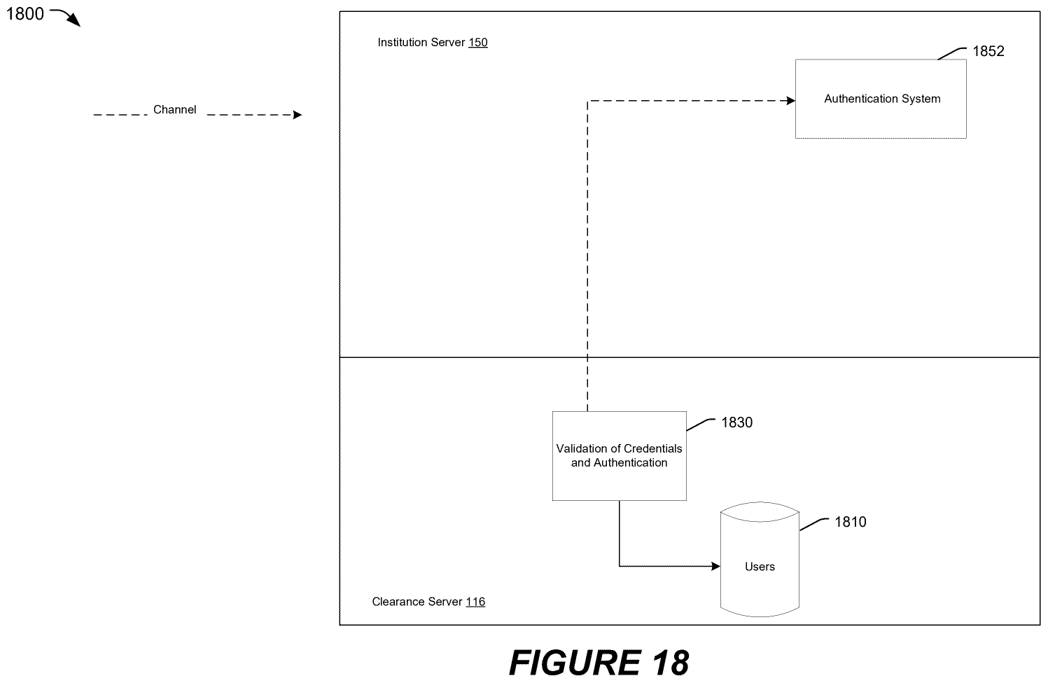

Referring to FIGS. 18-23, FIGS. 18-23 illustrate operations of the system 100 (e.g., a clearance system) and/or the system 200, according to one or more aspects. For example, each system of FIGS. 18-23 may include or correspond to the system 100 or 200. It is noted that with reference to FIGS. 18-23, in some implementations, that the clearance server 116 may include the core server 250. Alternatively, with reference to FIGS. 18-23, in some implementations, one or more operations described with reference to the clearance server 116 may alternatively be performed by the core server 250 which is separate from the clearance server 116.

FIG. 18 is an example of a system 1800 having architecture showing one or more communication channels according to one or more aspects. The system 1800 includes the clearance server 116 and the institution server 150. Based on technical feasibility, a secure sockets layer (SSL) encrypted communication channel for communications sent or received by the clearance server 116 may occur over or via the Internet, or over a secured IPSec virtual private network (VPN) for an additional layer of security. In some implementations, one or more endpoint calls may also be protected for authentication flow(s) established at the server side (e.g., the institution server 150) and implemented at the client side (e.g., the clearance server 116). An authentication flow may be associated with a machine-to-machine open authorization standard (“M2M Oauth2”), an API token, etc.

In some implementations, the clearance server 116 may receive and store users 1810 (e.g., user information), such as the user information 240, associated with the user. Additionally, or alternatively, the users 1810 may be stored at the database 126. The clearance server 116 may validate the user based on the users 1810. To validate the user, the clearance server 116 may perform a validation of credentials and authentication operation 1830 in which the clearance server 116 provides at least a portion of the users 1810 to the institution server 150 for authentication/validation by an authentication system 1852 of the institution server 150. In some implementations, the authentication system 1852 of the institution server may include or correspond to a KYC service and/or may be configured to confirm/authenticate a financial account of the user at the financial institution associated with the institution server 150 or a financial account at another financial institution.

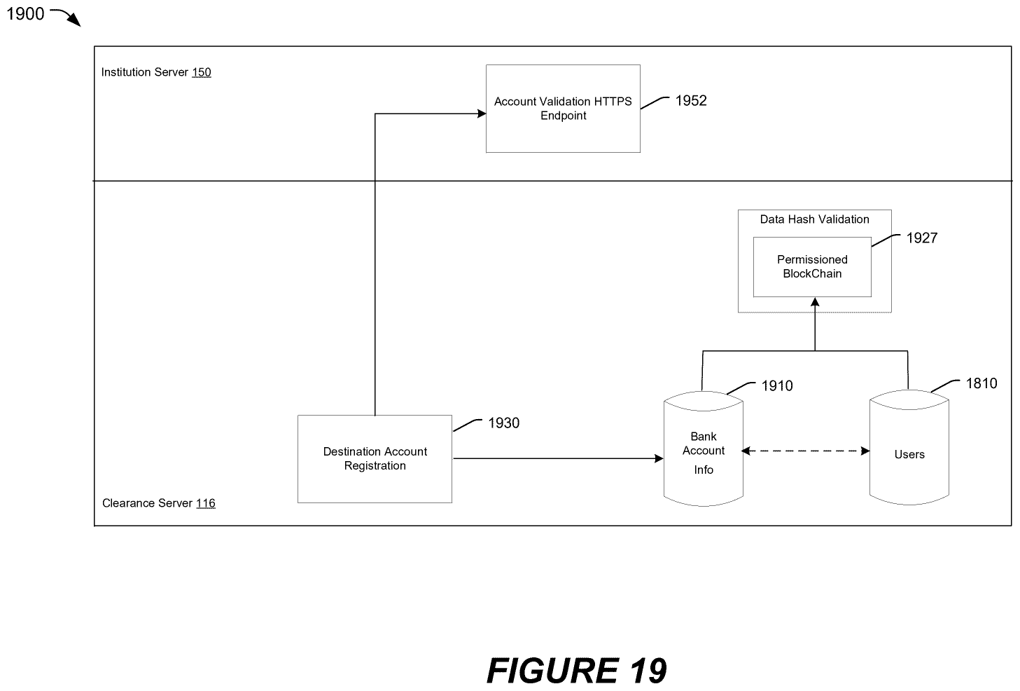

FIG. 19 is an example a system 1900 having an architecture for destination bank account verification according to one or more aspects. The system 1900 includes the clearance server 116 and the institution server 150. In some implementations, the system 1900 has already onboarded (e.g., authenticated) a user as described with reference to FIG. 18. In FIG. 19, the system 1900 is configured to perform a process of registering a destination banking account where funds will be disbursed to the authenticated user after the funds are received in a financial account (e.g., a fiduciary account). For example, a participant (e.g., a lien holder, a recipient, an assignee, etc.) to an agreement may be identified to receive funds from the financial account. In some implementations, the participant to receive the funds may be onboarded as a user of the clearance server 116 directly or indirectly.

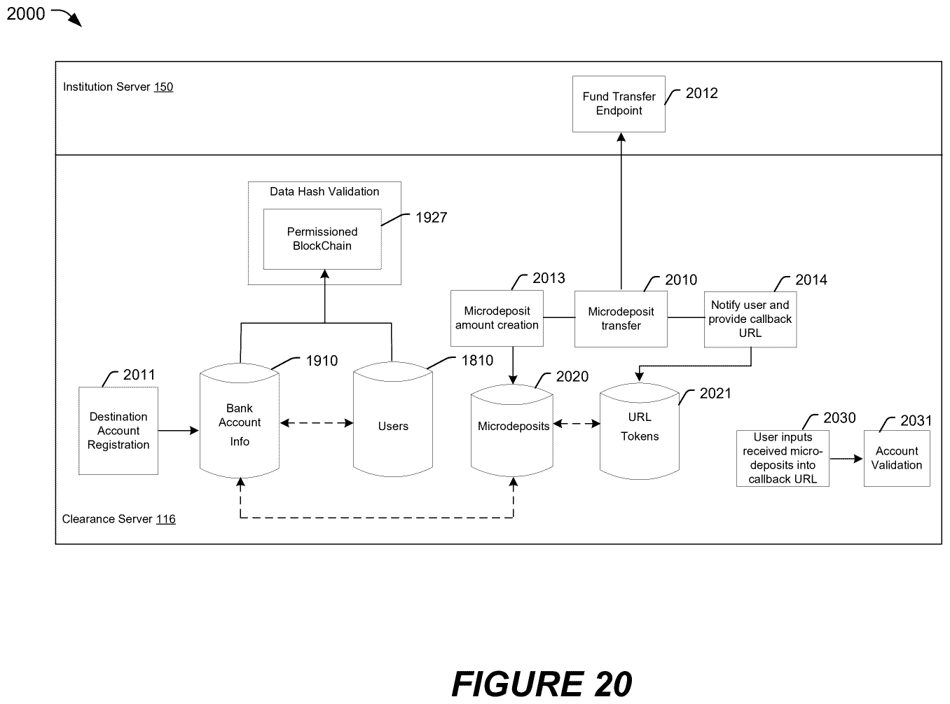

To enable the participant to receive funds, the clearance system 116 determines or identifies a destination bank account associated with the participant needs to be specified. The clearance server 116 may receive bank account information 1910 (e.g., destination bank account information) from the user and the bank account information 1910 of the user may be linked to the users 1810. The bank account information 1910 may indicate a destination account of the user. In some implementations, the destination bank account is required to be included in a particular national banking system. The clearance server 116 may validate the destination bank account using an account validation endpoint 1952 of the institution server 150. For example, the clearance server 116 may initiate a destination account registration operation 1930 via the account validation endpoint 1952, such as an account validation HTTPS endpoint, to validate whether the user has control over the account indicated by the banking information 1910. An example of a system to validate the account is described herein with reference to FIG. 20.

Based on a validated account, the clearance server 116 may store the linked bank account information 1910 and the users 1810 to a permission blockchain 1927. The permission blockchain 1927 may include or correspond to the ledger 127. Access to the permission block chain 1927 may be performed based on a data hash validation operation.

FIG. 20 is another example of a system 2000 having an architecture for destination bank account verification or funds transfer according to one or more aspects. The system 2000 includes the clearance server 116 and the institution server 150. The clearance server 116 may perform a destination account registration operation 2011 by initiating one or more microdeposit transfers 2010—e.g., the clearance server may indicate the number of micro deposits to be transferred, the amount of each microdeposit, or a combination thereof. For example, the clearance server 116 may access the fund transfer endpoint 2012 of the institution server 150 to perform the microdeposit transfers 2010 to the bank account identified by the user. In some implementations, the microdeposit transfers 2010 may be deposited to the bank account from an account owned by an entity that operates the clearance server 116.

The clearance server 116 may perform a micro deposit amount creation operation 2013 that generates microdeposit information 2020 that is stored at the database 126. The microdeposit information 2020 may be linked to the bank account (represented by the bank account information 1910) to which the microdeposit is made. Additionally, the clearance server 116 may perform a notification operation 2014 in which the server notifies the user of the microdeposits (e.g., the microdeposit transfers 2010). In some implementations, the notification operation 2014 may generate a callback uniform resource locator (URL) that is provided to the user to enable the user to enter the amounts that are to be deposited into the identified bank account. The clearance server 116 receives user inputs 2030 via the callback URL, and the user inputs 2030 indicate the value of the microdeposits. The value of the microdeposits may be stored as URL token information 2021 that is compared to the microdeposit information 2020. If the amount indicated by the URL token information 2021 matches the amount indicated by the microdeposit information 2020, the clearance server 116 performs an account validation operation and validates the bank account of the user.

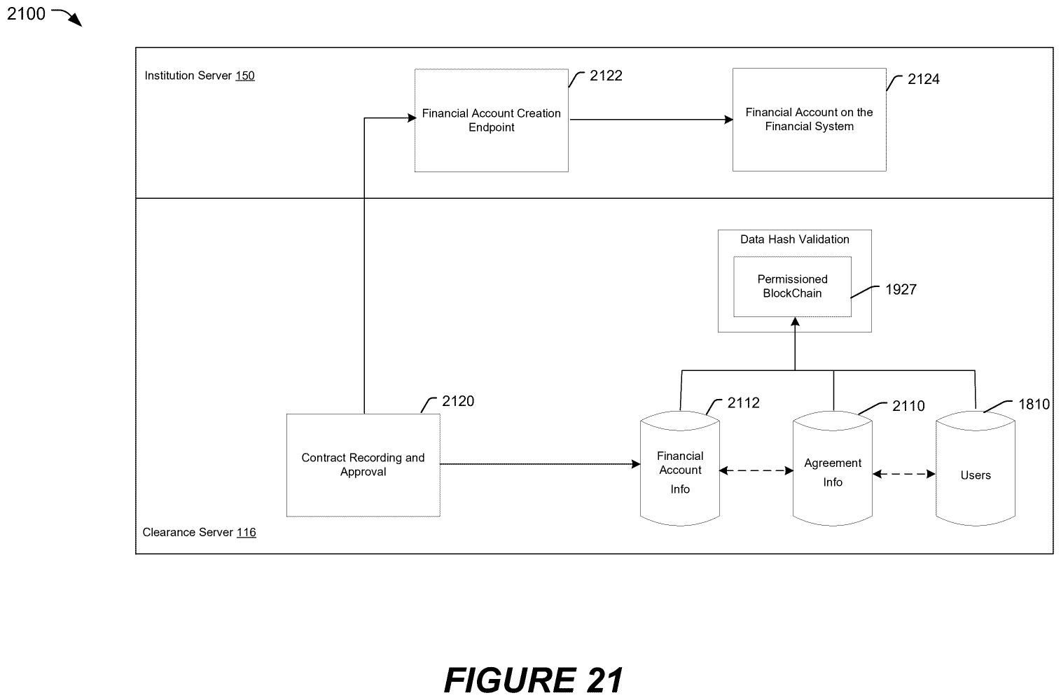

FIG. 21 is another example of a system 2100 having an architecture for account creation (e.g., a financial account) according to one or more aspects. The system 2100 includes the clearance server 116 and the institution server 150. After a contract (e.g., a forward contract) is negotiated and establish between participants, a clearance account (e.g., a financial account) is to be created, where the funds coming from the participant(s) with the paying responsibility can be deposited, based on the nature of the relation to the participant(s). From this account, smart contracts code will settle and disburse the funds according to the rules established.

The clearance server 116 may receive agreement information 2110 associated with a contract from a user. To illustrate, after negotiating and establishing (approving) a term contract between the participants, the term contract may be recorded with the clearance server 116, such that the agreement information 2110 represents the term contract. In some implementations, the agreement information 2110 may include or correspond to the agreement information 110. The agreement information 2110 may be linked to the users 1810. The clearance server 116 may perform a contract recordation operation and approval operation 2120 to confirm the agreement information 2110 is authentic as described at least with reference to FIG. 1A. In some implementations, the agreement information 2110 may indicate a status of an agreement, a change (e.g., a timestamp) of a change in status, or a combination thereof.

Additionally, after the agreement information 2110 is authenticated/validated, the clearance server 116 may initiate or request that the financial account is created with the institution server 150. For example, the clearance server 116 may access a financial account creation endpoint 2122 of the institution server 150 to cause the institution server 150 to create a financial account 2124 on the institution server 150. The clearance server 116 may store financial account information 2112 that indicates the financial account 2124. The financial account information 2112 may be linked to the agreement information 2110, the users 1810, or both.

The financial account information 2112, the agreement information 2110, and the users 1810 (e.g., the participants) are also recorded as one or more entries, and such information is stored to the permission blockchain 1927 (e.g., the ledger 127).

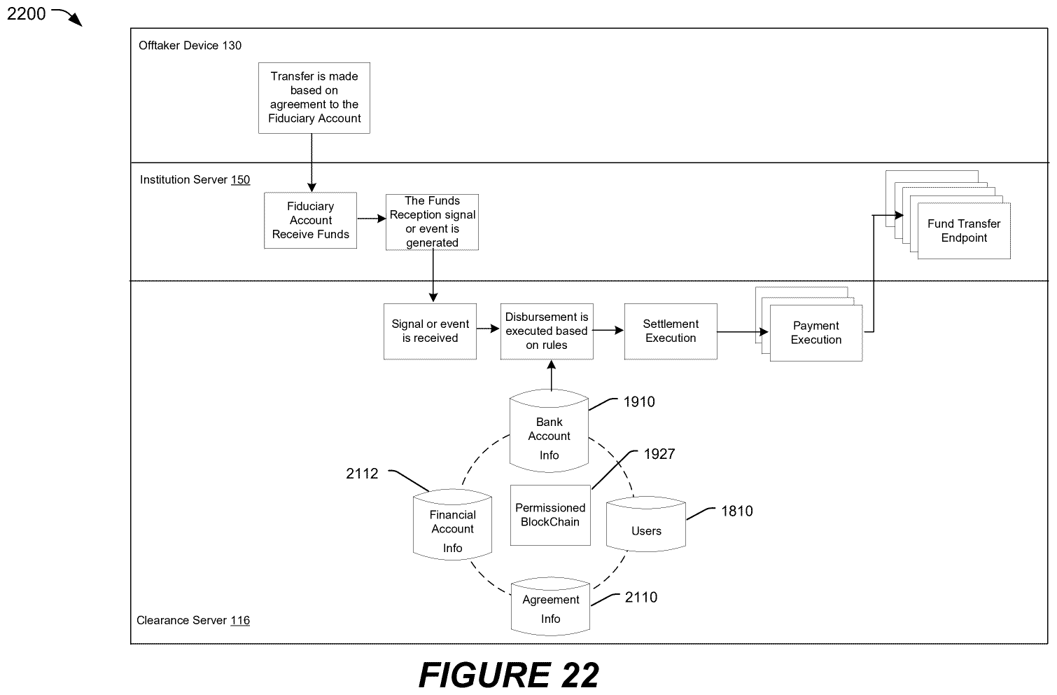

FIG. 22 is an example of a system 2200 having an architecture for funds flow execution according to one or more aspects. The system 2100 includes the clearance server 116, the institution server 150, and the offtaker device 130.

In some implementations, an offtaker (associated with the offtaker device 130) may make a payment to the financial account 2124. The institution server 150 may send an indication (e.g., a signal or an event) to the clearance server 116 that the payment (e.g., the funds) has been deposited to the financial account 2124.

The clearance server 116 may receive the indication and determine a disbursement amount from the financial account 2124 to a destination bank account. The destination bank account may be determined or identified based on the bank account information 1910. The disbursement amount may include one or more amounts to different accounts of different users based on execution of the smart contract. Stated differently, based on one or more terms of the term contract (e.g., represented by the agreement information 2110), one or more portions (or an entirety) of the payment may be allocated for distribution by the clearance server 116 in accordance with a smart contract (e.g., disbursed in accordance with established rules). In some implementations, the clearance server 116 (or the core server 250) may determine an order (e.g., an order of release) in which funds are transferred out to one or more parties. The clearance server 116 may perform a settlement execution operation and perform one or more payment execution operations that are provided to the institution server 150. The institution server 150 may disburse the funds, via a fund transfer endpoint of the institution server 150, from the financial account 2124 to the destination accounts identified by the clearance server 116 and associated with the payments received from the clearance server 116.

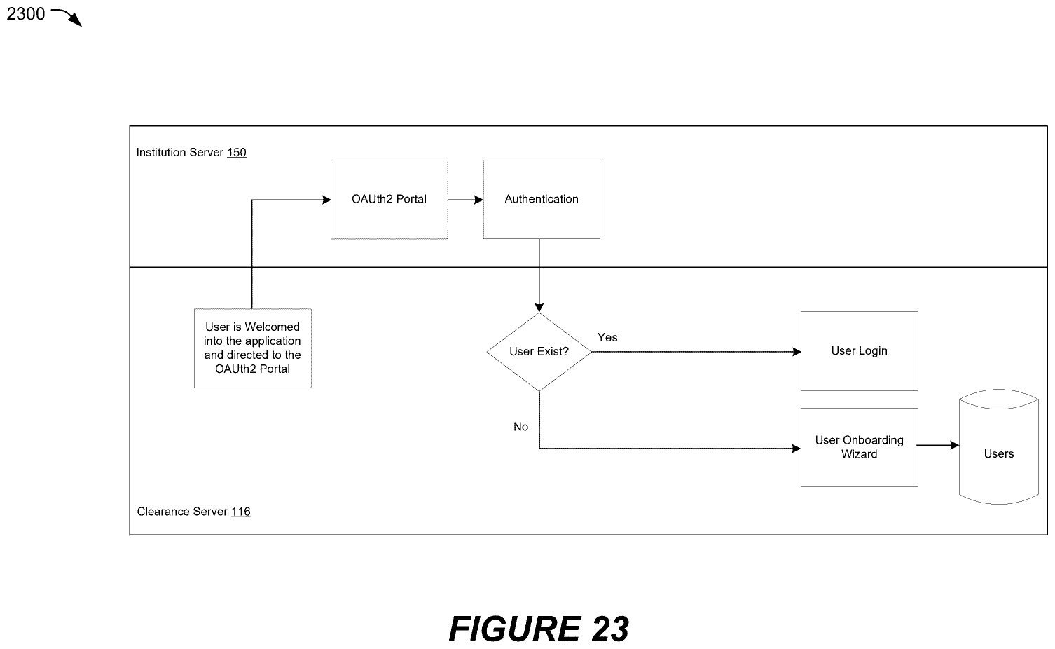

FIG. 23 is an example of a system 2300 having an architecture for user authentication. As shown in FIG. 23, the clearance server 116 (or the core server 250) is configured to operate with an Oauth2 flow available to the institution server 150. In some implementations, the clearance server 116 (or the core server 250) includes an API (e.g., the API 128) in order to authenticate a user that accesses the clearance server 116. A user may access the clearance server 116 and be welcomed into the application and directed to an OAuth2 portal of the institution server 150. The institution server 150 performs an authentication of the user and provides an output that indicates whether the user is authenticated. If the output indicates that the user is authenticated—e.g., that the user authenticated as an existing user—the user is logged in by the clearance server 116. Alternatively, if the output indicates that the user is not authenticated, the clearance server 116 launches (or enables the user to launch) an onboarding wizard to register the user in a user database. In some implementations, the operations of the system 2300 of FIG. 23 may be performed in association with one or more operations of the system 1800 of FIG. 18. Additionally, or alternatively, the operations of the system 2300 of FIG. 23 may be performed prior to one or more operations of the system 1900 of FIG. 19.

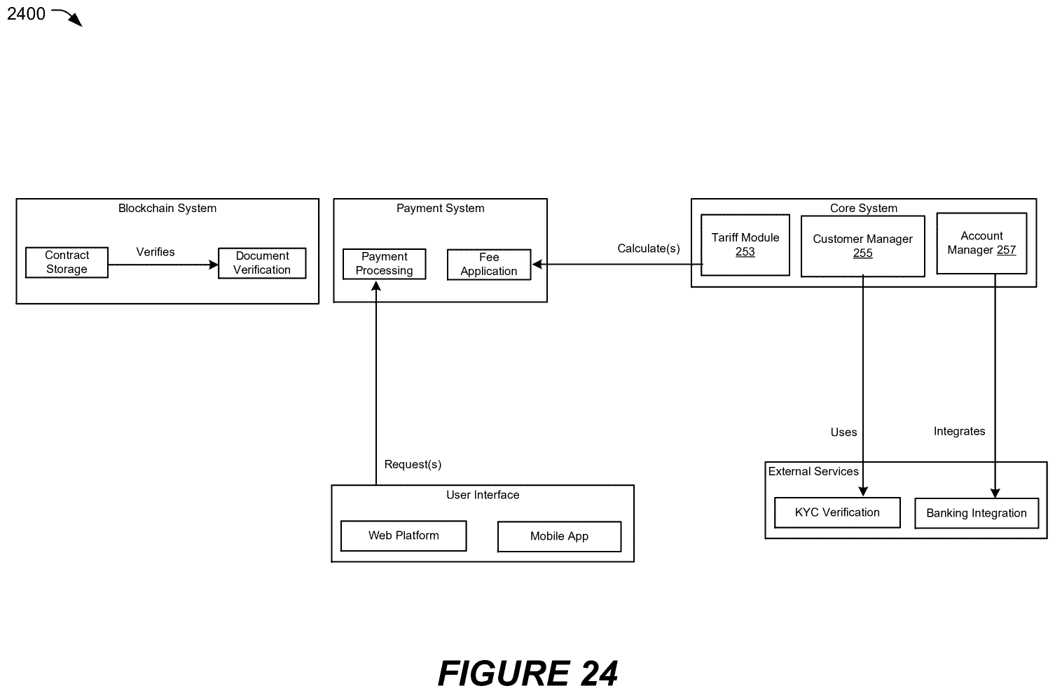

FIG. 24 is a block diagram of an example of a system 2400 according to one or more aspects. The system 2400 includes a blockchain system, a payment system, a core system (e.g., the core server 250), a user interface, and external services.

The blockchain system is configured to perform or provide contract storage. For example, the blockchain system may include or correspond to the ledger 127. The document storage provided by the blockchain system may enable verification of one or more documents, such as document verification by one or more entities or systems.

The user interface may include or correspond to an interface of a device, such as the producer device 102, the offtaker device 130, or the recipient device 140. The user interface may include or use a web platform or a mobile application to interact with one or more systems. For example, the user interface may enable the respective device to interact with the clearance server 116. In some implementations, the user interface may enable the respective device to send a request to another device or system, such as the payment system. In some such implementations, the request may be sent directly to the payment system or to the payment system via the clearance server 116 and/or the core system (e.g., the core server 250).

The payment system includes or is configured to perform payment processing and to apply one or more fees. For example, the payment system may be configured to receive and process one or more payments. The fee application of the payment system may be configured to determine and/or apply the one or more fees, which may be charged to the same financial account(s) as the processed payments. In some implementations, the fee may include a fee associated with use of the clearance server 116 or a tariff (as calculated by the tariff module 253).

The core banking system, such as the core server 250, includes the tariff module 253, the customer manager 255, and the account manager 257. The customer manager 255 may be configured to perform KYC verification using the KYC verification provided by the external services. The account manager 257 may be configured to perform one or more operations with respect to a financial institution (e.g., the institution server 150) using the banking integration of the external services.

The external services may include KYC verification and banking integration. The banking integration may enable the core banking system to interact with (e.g., integrate operations with) a financial institution, such as the institution server 150. In some implementations, the external services may be included in or provided by the institution server 150.

In some implementations, before settlement in a financial account at the financial institution, one or more operations/transactions can be carried out by the core banking system (e.g., the core server 250). For example, the one or more operations/transactions can include a fund reserve operation in which the core banking system ensures that funds are available and set aside for a transaction. The one or more operations/transactions can include an intermediate clearing operation in which the core banking system processes any necessary financial clearing among different correlate accounts according to the smart contracts, thereby preparing the amounts for final settlement. Additionally, or alternatively, the one or more operations/transactions can include validations and authorizations in which the core banking system ensures that transactions meet the criteria established in the smart contracts and that all necessary authorizations have been obtained.

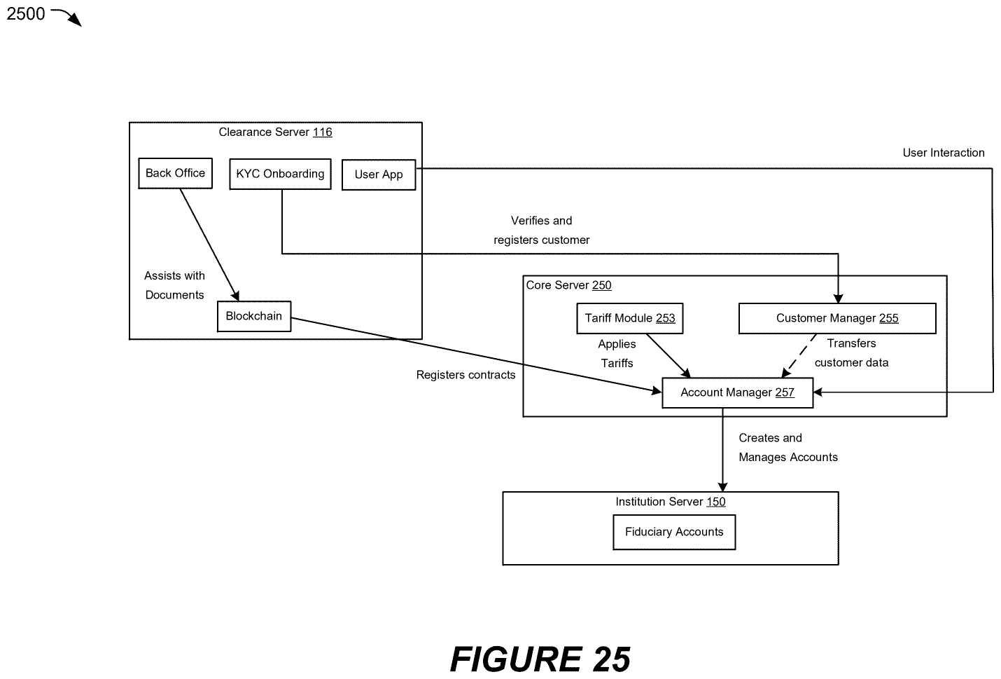

FIG. 25 is a block diagram of an example of a system 2500 according to one or more aspects. The system 2500 includes the clearance server 116, the core server 250, and the institution server 150.

The clearance server 116 includes components or modules configured to enable or perform back-office operations, KYC onboarding, or a combination thereof. The back office may be configured to enable assistance to a user with document procurement and/or storage of documents to a blockchain (e.g., the ledger 127). Registered contracts may be provided to or accessible from the core server 250 (e.g., the account manager 257). The KYC onboarding may be configured to perform one or more onboarding operations associated with a user. The KYC onboarding may include verifying and registering a user with the core server 250 (e.g., the customer manager 255). The clearance server 116 may also include or support a user application to enable and/or facilitate user interaction with the core server 250 (e.g., the account manager 257).

The core server 250 includes the tariff module 253, the customer manager 255, and the account manager 257. The tariff module 253 is configured to apply or determine tariffs or fees associated with payments, transfers, or disbursements. The tariff module 253 may indicate an amount of a tariff or fee to the account manager 257. The customer manager 255 may be configured to provide customer (e.g., user or participant) data to the account manager 257. The account manager 257 is configured to create and manage accounts. For example, the account manager 257 may be configured to initiate creation of one or more financial accounts by the institution server 150. The institution server 150 is configured to manage the one or more financial accounts.

In some implementations, a cloud-based service (e.g., an AWS cloud, as a non-limiting example) may host web and mobile applications associated with the clearance server 116. The cloud-based service may also include or support a payment system and a blockchain system. The payment system may include a fee application, payment processing, or a combination thereof. The blockchain system (e.g., the ledger 127) may include or support document verification, contract storage, transaction history data, or a combination thereof. The cloud-based service may also include or support the core server 250 (e.g., a core banking system) that includes the customer manager 255, the account manager 257, the tariff module 253, or a combination thereof. In some implementations, the payment system, the blockchain system, or both, may be accessible to or integrated within the core banking system. Additionally, or alternatively, the core server 250 may be configured to access one or more external services, such as a KYC verification service, a financial institution (e.g., the institution server 150), or the like.

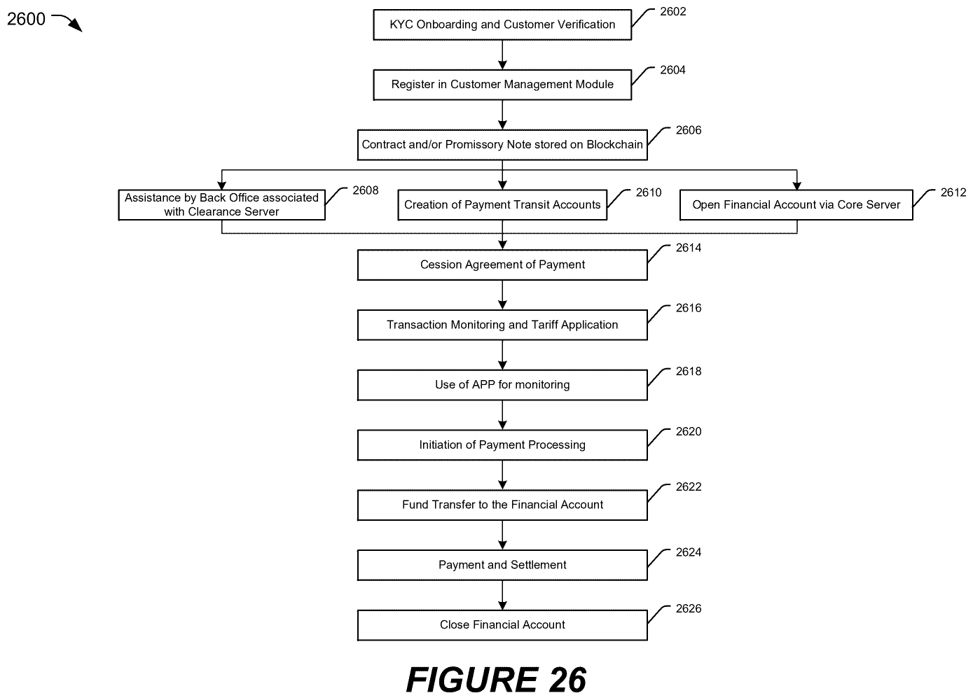

FIG. 26 is a flow diagram illustrating another example process 2600 that supports operation of a clearance system according to one or more aspects. Operations of process 2600 may be performed by a device or system, such as the system 100 or 200. Additionally, or alternatively, the device or system may include or correspond to a clearance platform. In some implementations, the clearance platform includes or corresponds to clearance server 116 described above with reference to FIG. 1.

The process 2600 may be performed at or by the system 100 or 200, as illustrative, non-limiting examples. In some implementations, the process 2600 represents a process from the beginning of opening a financial account with a financial institution to closing the financial account. Operations of the process 2600 may be performed by one or more devices, one or more servers, one or more entities, or a combination thereof.

At block 2602, the process 2600 includes performing KYC onboarding and customer verification. For example, the clearance server 116, the core server 250, the institution server 150, external services, or a combination thereof may perform KYC onboarding and customer verification.

At block 2604, the process 2600 includes registering a user using/with a customer management module. For example, the customer management module may include or correspond to the customer manager 255.

At block 2606, the process 2600 includes receiving and storing a contract and promissory note on a blockchain. For example, the blockchain may include or correspond to the ledger 127 or a blockchain system.

At block 2608, the process 2600 optionally includes providing assistance by a back office (e.g., an agent, employee, administrator, or other authorized user) associated with the clearance server 116. For example, the clearance server 116 may be configured to enable or provide assistance to one or more users with respect to registration and/or providing documents, such as a contact and/or promissory note.

At block 2610, the process 2600 includes creating a payment transit account. For example, the clearance server 116 and/or the core server 250 may create a payment transit account for a user. To illustrate, the clearance server 116 and/or the core server 250 may generate a payment transit account for a user and may manage the account using the account manager 257. In some implementations, the operations at block 2610 are optional.

At block 2612, the process 2600 includes opening a financial account via the core server 250 (e.g., a core banking service). For example, the core server 250 (or the clearance server 116 via the core server 250) may open a financial account with a financial institution (e.g., the institution server 150). The clearance server 116 and/or the core server 250 may have agency over the financial account that is associated with the contract.

At block 2614, the process 2600 includes receiving a cession agreement of payment. For example, the clearance server 116 may receive the cession agreement. The cession agreement may be stored at the blockchain in association with a contract, one or more accounts, and/or one or more users. Additionally, or alternatively, the cession agreement may be provided to or be accessible by the core server 250.

At block 2616, the process 2600 includes performing transaction monitoring and tariff application. For example, the clearance server 116 and/or the core server 250 may monitor one or more transactions and apply the tariff. Additionally, at block 2618, the process 2600 includes using the application (APP) for monitoring the financial account. For example, a user of a device, such as producer device 102, the offtaker device 130, or the recipient device 140, may monitor his or her respective financial account.

At block 2620, the process 2600 includes initiating payment processing. For example, the payment processing may be initiated based on detection of a transfer (e.g., the transfer 192) of funds. In some implementations, the payment processing may be performed by a third party that receives a payment (e.g., the transfer 192) to be provided to a financial account, such as a producer associated with the producer device 102. At block 2622, the process 2600 includes transferring funds to the financial account.

At block 2624, the process 2600 includes performing payment and settlement. For example, the clearance server 116 and/or the core server 250 may determine one or more fees or tariffs, determine one or more users or individuals to receive funds according to a smart contract and/or documents, or a combination thereof, and funds may be deposited in the accounts of the identified users or individuals as well as fees may be deducted from the financial account. After the payment and settlement of funds from the financial account to one or more other accounts, at block 2626, the process 2600 includes closing the financial account.

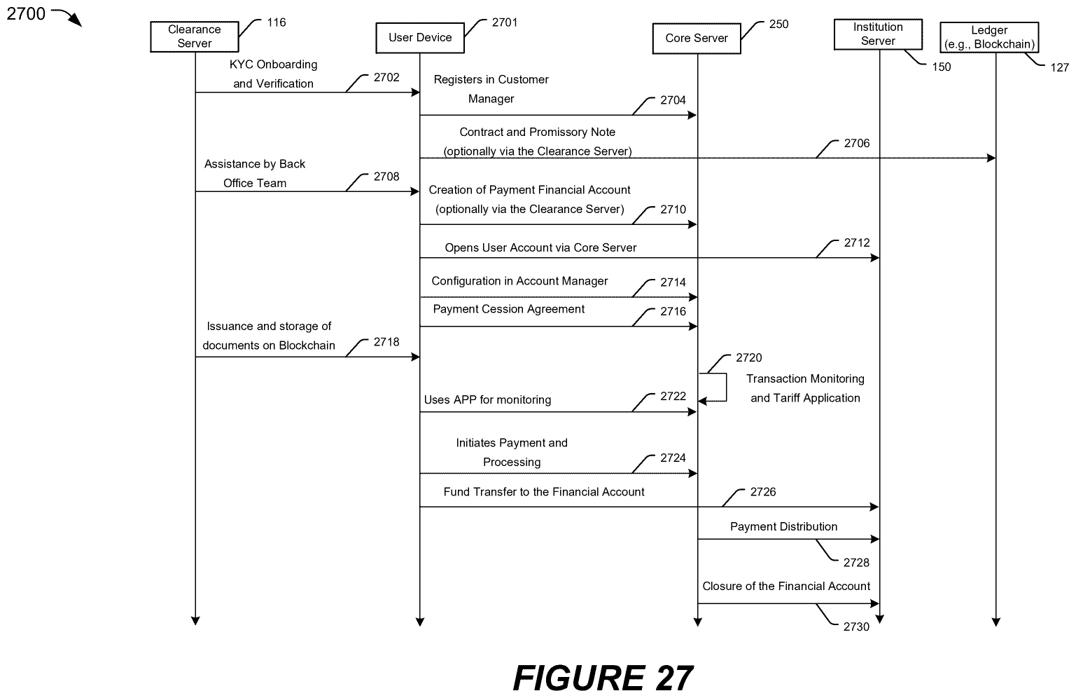

FIG. 27 is a ladder diagram illustrating an example of a system 2700 that supports operation of a clearance system according to one or more aspects. The system 2700 may include or correspond to the system 100 or 200. The system 2700 includes the clearance server 116, a user device 2701, the core server 250, the institution server 150, and the ledger 127 (e.g., a blockchain). The user device 2701 may include or correspond to a user, such as a user of the producer device 102, the offtaker device 130, the recipient device 140 (e.g., a user of the user device 2701 may include or correspond to a user of the producer device 102, the offtaker device 130, or the recipient device 140). It is noted that one or more operations described with respect to the user device 2701 may be performed via the clearance server 116 and/or the core server 250, such as via communications between the user device 2701 and the respective server, interactions with one or more APIs supported by the respective server, or the like. The operations shown in the ladder diagram may be associated with a process from KYC onboarding to the final closure of a financial account.

The clearance server 116 performs, at 2702, KYC onboarding and verification with the user device 2701 (e.g., a user). At 2704, the user device 2701 (e.g., the user) is registered in the customer manager 255 (e.g., a customer management module) of the core server 250. At 2706, the user device 2701 (e.g., the user) stores a contract and/or promissory note at the ledger 127 (e.g., a blockchain).

The clearance server 116 may optionally provide back-office team assistance to a user of the user device 2701, at 2708. The back-office team assistance may provide support or guidance to the user of the user device 2701 to perform one or more operations, such as uploading documents, signing documents, establishing one or more accounts, etc.

The user device 2701 creates a payment transit account with the core server 250, at 2710. The payment transit account may enable the core server 250 to initiate a transfer of funds from a financial account at a financial institution or to another account at the same or a different financial institution. At 2712, the user device 2701 may open a financial account (e.g., a fiduciary account) with a financial institution associated with the institution server 150. For example, the financial account may be opened via the core server 250. Additionally, or alternatively, the user device 2701 may establish a configuration in an account management module (e.g., 257) of the core server 250, at 2714. The configuration in the account management module may link the payment transit account and the financial account. At 2716, the user device 2701 provides a payment cession agreement to the core server 250 and/or to the clearance server 116. In some implementations, information (e.g., identifying information) of the payment transit account, the financial account, the payment cession agreement, or a combination thereof, may be stored at the ledger 127 (e.g., a blockchain).

The clearance server 116 may provide documents to the user device 2701, where the documents are issued and stored document on the ledger 127 (e.g., a blockchain), at 2718. Accordingly, a user of the user device 2701 may have full transparency to documents and obligations related to a financial account associated with the user.

The core server 250 may monitor transaction and/or a tariff application associated with a payment system and/or the financial account, at 2720. For example, the core server 250 may perform monitoring to determine whether or not funds (e.g., a payment) are deposited to the financial account. Additionally, or alternatively, the core server 250 may apply a tariff application to withdraw a tariff from funds at the financial account. Additionally, at 2722, the user of the user device 2701 may use an application (e.g., an application supported by the clearance server 116) to monitor the payment transfer account of the user, the financial account associated with the agreement, documents, balances, or a combination thereof.

The user device 2701 may initiate a payment and processing associated with the contract and/or the financial account, at 2724. For example, if the user is an offtaker, the offtaker may initiate a payment to the financial account of a producer. At 2726, a user of the user device 2701 transfers funds to the financial account. In some implementations, the funds may be transferred from a financial institution associated with the user to the financial account that is managed by a financial institution associated with the institution server 150. In some implementations, the financial institution associated with the user and the financial institution associated with the institution server 150 are the same financial institution or different financial institutions.

At 2728, the core server 250 may initiate a payment distribution from the financial account based on and/or in accordance with the cession agreement, a tariff module, a fee structure, or a combination thereof. After the distribution and the contract are completed, the core server 250 may initiate closure of the financial account by the institution server 150, at 2730.

The system 2700 can utilize the ledger 127 (e.g., a blockchain) for contract storage and also for the issuance and storage of documents, thereby integrating these actions into the payment process.

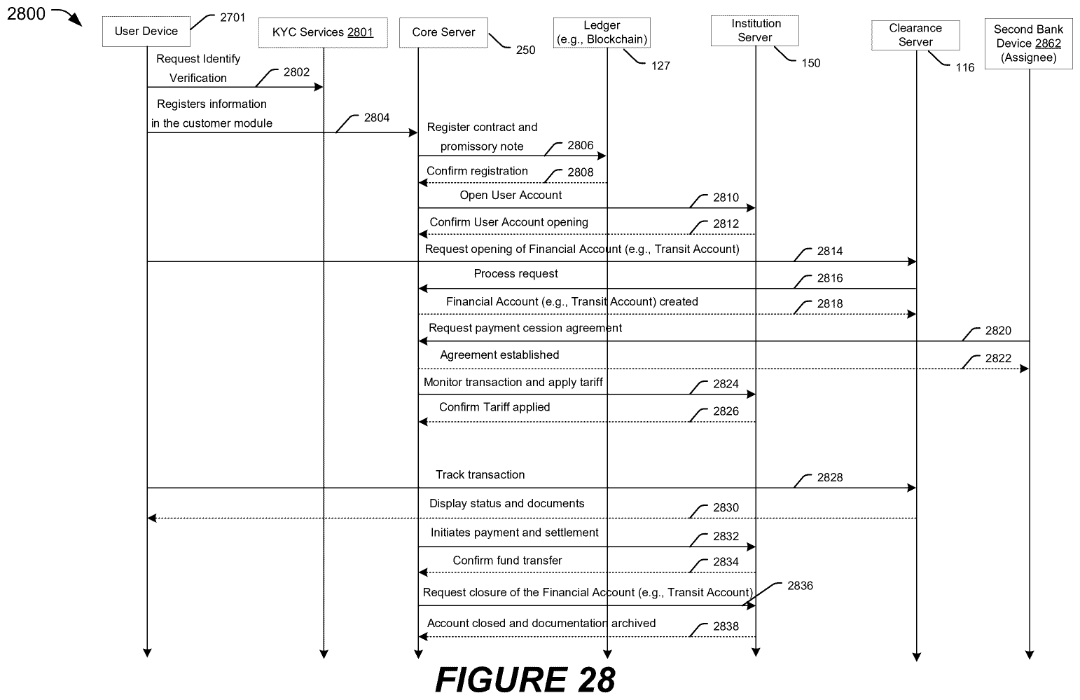

FIG. 28 is a ladder diagram illustrating an example of a system 2800 that supports operation of a clearance system according to one or more aspects. The system 2800 may include or correspond to the system 100 or 200. The system 2800 includes the user device 2701, KYC services 2801, the core server 250, the ledger 127 (e.g., a blockchain), the institution server 150, the clearance server 116, and a second bank device 2862. The KYC services 2801 may include or correspond to the KYC verification of the external services of FIG. 24. The second bank device 2862 may include or correspond to the first bank device 160, the second bank device 162, the recipient device 140, a recipient associated with the recipient device 140, or a combination thereof. In some implementations, the user device 2701 includes or corresponds to the producer device 102. It is noted that one or more operations described with respect to the user device 2701 may be performed via the clearance server 116 and/or the core server 250, such as via communications between the user device 2701 and the respective server, interactions with one or more APIs supported by the respective server, or the like The operations shown in the ladder diagram may be associated with a process from KYC onboarding to the final closure of a financial account.

The user device 2701 requests identify verification with the KYC services 2801, at 2802. In some implementations, the request for verification may occur via the clearance server 116, the core server 250, or a combination thereof. Based on successful identity verification, the user device 2701, at 2804, registers information in the customer manager 255 of the core server 250. In some implementations, the core server 250 may receive an indication of the successful identity verification by the KYC services 2801.

The core server 205 (and/or the clearance server 116) may register a contract and/or a promissory note with the ledger 127 (e.g., a blockchain), at 2806. The core server 250 (and/or the clearance server 116) may optionally receive a confirmation of registration (of the contract and/or the promissory note) from the ledger 127 (e.g., a blockchain), at 2808.

The core server 250 (and/or the clearance server 116) may request that the institution server 150 open a user account, at 2810. The user account may be a personal banking account that the user has agency over. The core server 250 (and/or the clearance server 116) may optionally receive a confirmation of opening of the user account, at 2812.

The user device 2701 may request the clearance server 116 to cause a financial account (e.g., a transit account or fiduciary account) to be opened for a user of the user device 2701, at 2814. The financial account (e.g., a fiduciary account) may be associated with the agreement (e.g., the registered contract) and the clearance server 1116 and/or the core server 250 may have agency over the account for the benefit of the user. The clearance server 116 may instruct the core server 250 to open the financial account (e.g., the transit account), at 2816. The core server 250 may, optionally, transmit, to the clearance server 116, a confirmation that the financial account (e.g., the transit account) account is created, at 2818.

The second bank device 2862 (e.g., a user associated with the second bank device 2862 or a device of the user associated with the second bank device 2862) sends a request to record a cession agreement to the core server 250, at 2820. The core server 250 may, optionally, transmit, to second bank device 2862 (e.g., a user associated with the second bank device 2862 or a device of the user associated with the second bank device 2862), a confirmation that the agreement is established and/or recorded at the ledger 127 (e.g., a blockchain), at 2822.

The core server 250 may, at 2824, monitor one or more transactions and/or indicate/identify a tariff to be applied by the institution server 150. The institution server 150 may, optionally, provide confirmation that the tariff is applied and/or recorded with respect to a financial account, at 2826.

The user device 2701 may track, at 2828, one or more transactions via the clearance server 116. To enable the user device 2701 to track the one or more transactions, the clearance server 116 may optionally provide a display of a status and/or documents associated with a user of the user device 2701 at 2830. The status may include a status of the financial account (e.g., the transit account) associated with the user of the user device 2701.

After a payment is made to the financial account, the core server 250 may initiate payment and settlement (associated with the financial account) by the institution server 150 at 2832. The institution server 150 optionally confirms, to the core server 250, transfer of funds at 2834.

The core server 250 may request closure of the financial account (e.g., the transit account) by the institution server 150, at 2836. The institution server 150 may optionally confirm, to the core server 250, that the account is closed, that documentation is archived, or a combination thereof, at 2838.

In some implementations, the system 2800 enables KYC identify verification. Additionally, or alternatively, the system 2800 provides interaction between the core server 250 and the ledger 127 (e.g., a blockchain) for contract registration and/or promissory note management. The system 2800 further enables opening of both the user account and the financial account (e.g., the transit account or fiduciary account) for management by the core server 250. Additionally, or alternatively, the system 2800 enables establishment of a payment cession agreement with a financial institution, transaction monitoring, and tariff applications.

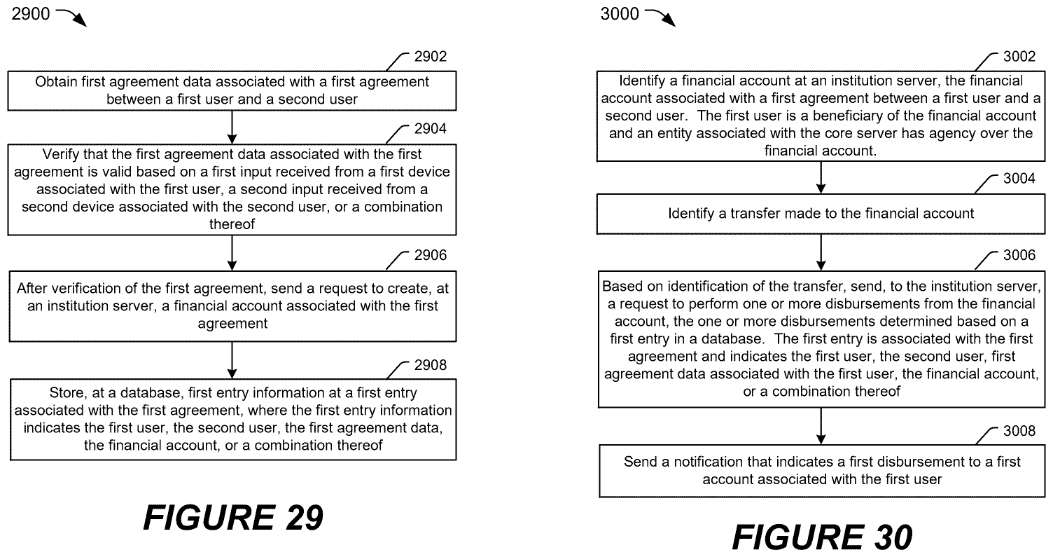

Referring to FIG. 29, FIG. 29 is a flow diagram illustrating an example process 2900 of a server that supports operation of a clearance system according to one or more aspects. Operations of the process 2900 may be performed by a server, such as the clearance server 116 described above with reference to FIG. 1 or 2 and/or the core server 250 described above with reference to FIG. 2. The clearance system may include or correspond to at least one or more aspects of the system 100 or 200.

At block 2902, the server obtains first agreement data associated with a first agreement between a first user and a second user. For example, the first agreement data may include or correspond to the agreement information 110. In some implementations, the first agreement includes or corresponds to a contract. The contract may be a sales contract, such as a forward contract or a future contract, as illustrative, non-limiting examples. The first agreement (e.g., the contract) indicates a payor and a payee. For example, the first agreement may indicate that the second user owes the first user a payment amount based on delivery of an object by the first user. In some implementations, the first user includes or corresponds to the producer associated with the producer device 102, and the second user includes or corresponds to the offtaker associated with the offtaker device 130. In some other implementations, the first user includes or corresponds to the offtaker associated with the offtaker device 130, and the second user includes or corresponds to the producer associated with the producer device 102.

In some implementations, the first agreement may be between the first agreement is further between the first user, the second user, and an entity associated with the institution server (e.g., the institution server 150). For example, the entity associated with the institution server may agree to provide a financial account associated with the first agreement, and the first and second users may agree to use the financial account for the first agreement.

In some implementations, to obtain the first agreement data, the server receives the first agreement data from the first device. Alternatively, in some other implementations, to obtain the first agreement data, the server generates the first agreement data. For example, the server may generate a draft of the first agreement (e.g., a contract). In some such examples, the server may obtain digital signatures from the first and second users to establish the first agreement. In such examples, obtaining the digital signatures may include or constitute verification of the first agreement (e.g., the first agreement data).

At block 2904, the server verifies that the first agreement data associated with the first agreement is valid based on a first input received from a first device associated with the first user, a second input received from a second device associated with the second user, or a combination thereof. The first input may include an indication that the first agreement data or a summary (e.g., a standardized summary of the first agreement data) is correct, a first digital signature of the first user, or a combination thereof, as illustrative, non-limiting examples. Additionally, the second input may include an indication that the first agreement data or a summary (e.g., a standardized summary of the first agreement data) is correct, a second digital signature of the second user, or a combination thereof, as illustrative, non-limiting examples.

At block 2906, the server, after verification of the first agreement, sends a request to create, at an institution server, a financial account associated with the first agreement. The institution server may include or correspond to the institution server 150. The request to create the financial account may include or correspond to the account request 172. The financial account may include or correspond to the account information 158 or the account ID 174.

In some implementations, the request to create the financial account associated with the first agreement is sent to via institution server via a core server. For example, the server may send a request to the core server to create the financial account associated with the first agreement. The core server may include or correspond to the core server 250.

In some implementations, the server receives, from the institution server or the core server, an identifier associated with the financial account. For example, the identifier may include or correspond to the account ID 174. The indicator may include or indicate an account number of the financial account, a routing number associated with the financial account, a name of an entity that provides the financial account, a name of a beneficiary of the financial account, a quick response (QR) code or barcode associated with the financial account, or a combination thereof. The server can send the indicator to the payor (e.g., the second device associated with the second user), store the indicator at a first entry, or a combination thereof.

In some implementations, the request to create the financial account is or includes a request to reserve the financial account, designate the first user as a beneficiary of the financial account, designate an entity (e.g., of the clearance server 116 or the core server 205) as having agency over the financial account, link the financial account to the first agreement, or a combination thereof. In some examples, the first user requests to reserve the financial account for purposes of forming the first agreement with the second user. The first agreement data may identify or indicate the financial account to make a payment associated with the first agreement. In some such implementations, after verification of the first agreement, an additional agreement may be made between the first user, the second user, and an entity (e.g., a bank) associated with the server, an entity associated with the institutional server, or both. In other examples, the request for the financial account is performed during contract formation. In some such implementations, the first agreement is made between the first user, the second user, and the entity associated with the server, the entity associated with the institutional server, or both.

At block 2908, the server stores, at a database, first entry information at a first entry associated with the first agreement. The database may include or correspond to the database 126, the ledger 127 or a blockchain, or a combination thereof. The first entry may include or correspond to the entry 3880. In some implementations, at least a portion of the first entry is immutable. In other implementations, an entirety of the first entry is immutable. The first entry information indicates the first user, the second user, the first agreement data, the financial account, or a combination thereof.

In some implementations, the server generates a smart contract based on the first agreement. The smart contract may be a computer program that executes (e.g., automatically executes) the terms of an agreement when certain conditions are met. In some examples, the server stores the smart contract at the first entry.

In some implementations, as part of the process 2900, after verification of the first agreement, the server initiates formation of a second agreement associated with use of the financial account in association with the first agreement. For example, the second agreement may be between the first user, the second user, and an entity associated with the institution server. Additionally, the second agreement may indicate that the payor will make a payment to the payee using the financial account provided (e.g., hosted) by the entity associated with the institution server. The server may verify that the second agreement is complete, such as based on receiving a digital signature of each of (or a representative of) the first user, the second user, and the entity associated with the institution server. After verification that the second agreement is complete, the server can store, at the database, second agreement data (associated the completed second agreement) at the first entry.

To form the second agreement, as part of the process 2900, the server may generate a first version (e.g., a draft version or unsigned/unexecuted version) of the second agreement based on the first agreement, the financial account, or a combination thereof. The server provides (e.g., sends), to each of the first user, the second user, and the entity, a request to sign the second agreement. The verified second agreement may include or correspond to a second version (e.g., an executed version or final version) of the second agreement that is signed by each of (or a representative of) the first user, the second user and the entity.

In some implementations, prior to verification (or execution) of the second agreement, if the financial account has been created by the institution server, the financial account has a reserved status. For example, the institution server may maintain a status of the financial account as reserved and unable to receive funds. After verification of the second agreement, the institution server may transition the status of the financial account to active. To illustrate, the server may send, to the institution server, a status change request to change the financial account from the reserved status to an active status. Alternatively, the institution server may access the database (e.g., the first entry associated with the first entry), via an API of the database or the server, and determine that the second agreement is verified (e.g., executed). Based on a determination that the second agreement is verified, the institution server changes the status of the financial account to active and available to receive funds.

In some implementations, as part of the process 2900, the server receives, from the first device associated with the first user, first user information associated with the first user. The server may receive the first user information (or a portion thereof) as part of a registration process performed with the first user, as part of verification of the first agreement, or a combination thereof. The first user information may indicate first bank account information that indicates a first bank account associated with the first user, a bank name that provides the first bank account, a routing number associated with the first bank account, an account type of the first bank account, a holder name of the first bank account, or a combination thereof. Additionally, or alternatively, the first user information can indicate a name of the first user, a company associated with the first user, a birthday of the first user, a nationality of the first user, a government identification number associated with the first user, a tax ID associated with the first user, an email address associated with the first user, a phone number associated with the first user, a fax number associated with the first user, an address associated with the first user, sustainability information associated with the first user, or a combination thereof. The server may store at least a portion of the first user information at the database. For example, the portion of the first user information may be stored as part of the first entry or may be linked to the first entry.

In some implementations, the server sends, to a core server, a first indicator that indicates first user information associated with the first user. For example, the server may send the first indicator along with or included in a request to authenticate or verify the first user. The server may then receive, from the core server, an indicator that indicates the first user is verified or that the first user is not verified.

In some implementations, the server receives, from the second device associated with the second user, second user information associated with the second user. The server may receive the second user information (or a portion thereof) as part of a registration process performed with the second user, as part of verification of the first agreement, or a combination thereof. The second user information may indicate second bank account information associated with the second user. For example, the second bank account information may include or indicate a bank account of the second user, a bank name that provides the second bank account, a routing number associated with the second bank account, an account type of the second bank account, a holder name of the second bank account, or a combination thereof. Additionally, or alternatively, the second user information can indicate a name of the second user, a company associated with the second user, a birthday of the second user, a nationality of the second user, a government identification number associated with the second user, a tax ID associated with the second user, an email address associated with the second user, a phone number associated with the second user, a fax number associated with the second user, an address associated with the second user, sustainability information associated with the second user, or a combination thereof. The server may store at least a portion of the first user information at the database. For example, the portion of the second user information may be stored as part of the first entry or may be linked to the first entry.

In some implementations, as part of the process 2900, the server receives, from a third device associated with a third user, a payment request associated with the first agreement. For example, the payment request includes document data, a request amount, or a combination thereof. The document data may include or correspond to an invoice, a receipt, the document information 186, or a combination thereof. To illustrate, the document data may include or correspond to another agreement, such as an assignment or cession agreement, of at least a portion of a payment of the first agreement.

The server may verify and record the third agreement at the database. The server can send, to a device of the payee (e.g., the first user device) of the first agreement, an approval request based on the payment request. If the server receives, from the device of the payee (e.g., the first user device), an approval message responsive to the approval request, and updates the first entry based on the approval message to indicate that the third user is to receive a portion of the payment amount paid by the payor (e.g., the second user) in accordance with the first agreement. Alternatively, if the server receives from the device of the payee (e.g., the first user device), a denial/rejection message responsive to the approval request, the server may inform the third user of the denial/rejection message. In some examples, the server may record the denial/rejection message at the first entry.

In some implementations, as part of the process 2900, the server receives, from the third device associated with the third user, third user information associated with the third user. The server may receive the third user information (or a portion thereof) as part of a registration process performed with the third user, as part of verification of the third agreement, or a combination thereof. The third user information may indicate third bank account information that indicates a third bank account associated with the third user, a bank name that provides the third bank account, a routing number associated with the third bank account, an account type of the third bank account, a holder name of the third bank account, or a combination thereof. Additionally, or alternatively, the third user information can indicate a name of the third user, a company associated with the third user, a birthday of the third user, a nationality of the third user, a government identification number associated with the third user, a tax ID associated with the third user, an email address associated with the third user, a phone number associated with the third user, a fax number associated with the third user, an address associated with the third user, sustainability information associated with the third user, or a combination thereof. The server may store at least a portion of the third user information at the database. For example, the portion of the third user information may be stored as part of the first entry or may be linked to the first entry.

In some implementations, as part of the process 2900, the server obtains, from a device associated with the payor (e.g., the second device associated with the second user), third agreement data associated with a third agreement between the second user and another user. The server may verify, based on an input received from a fourth device associated with the other user, that the third agreement data associated with the third agreement is valid. In some examples, activation of the third agreement is triggered based on an event associated with the first agreement. For example, the third agreement may be contingent upon the second user receiving (e.g., a change in possession of) a commodity from the first user under the first agreement. The server may store second entry information associated with the third agreement data at the database. The second entry information may indicate the second user, the third user, the first agreement data, the third agreement data, or a combination thereof. The second entry information may be stored at the first entry, or may be stored at a second entry associated with the third agreement. If the third agreement data is stored at the second entry, the second entry can be linked to the first entry in the database.

In some implementations, as part of the process 2900, the server identifies the financial account (associated with the first agreement between the first user and the second user) at the institution server. For example, the server may identify the financial account based on identification of a change in status (e.g., from pending to delivered) of the object indicated by the first entry, based on receipt (e.g., from the first user or the second user) of invoice data associated with the first agreement, or a combination thereof. The server may access the database, such as through an API of the database, and determine, based on the first entry associated with the first agreement in the database, one or more disbursements to be made from the financial account. In some implementations, the one or more disbursements are determined based on the first entry and/or identification of the change in status of the object indicated by the first entry. The one or more disbursements can include at least a first disbursement to a payee of the first agreement (e.g., to a first account associated with first user).

The server can send, to the institution server, a request to perform the one or more disbursements. For example, the request may include or correspond to the push request 196. In some implementations, the request is sent to the institution server via the core server. Additionally, or alternatively, the server may receive a notification that indicates a first disbursement from the financial account to the payee (e.g., a first account associated with the first user) is initiated or completed. The notification may be received from the institution server or the core server. In some implementations, the server may send a notification that indicates the first disbursement to the payee (e.g., the first account associated with the first user) is initiated and/or complete. To illustrate, the notification may be sent to the payee.

In some implementations, as part of the process 2900, the server receives, from the institution server, a transfer request notification of a transfer request associated with the payor (e.g., the second user). For example, the transfer request may include to correspond to the transfer 192. Additionally, or alternatively, the server can receive, from the institution server, a transfer completion notification that indicates completion of a transfer to the financial account based on the transfer request. In some implementations, transfer completion notification is received prior to delivery of an object associated with the first agreement from the first user to the second user. For example, the transfer completion may be associated with an initial payment or a pre-payment associated with the first agreement.

In some implementations, the server receives sensor data associated with an object to be provided from the first user to the second user in accordance with the first agreement. For example, the sensor data may be received from a sensor associated with the first user, a silo system, a sensor associated with the second user, agricultural equipment, a transportation device (e.g., a truck), a tracking device, or a combination thereof. The server may, based on the sensor data, store or update a status of the first entry. Based on the status, the sensor data, or a combination thereof, the server may determine whether to determine or indicate (e.g., to the institution server) one or more distributions associated with the financial account.

In some implementations, the server receives a status request from a user, such as the first user, the second user, a third user, etc., associated with the first agreement. Based on the status request, the server may access the database to obtain entry information based on the first entry, and obtain status information based on the first entry information. Additionally, or alternatively, the server may send a status information request (or forward the status request) to the core server and, in response, receive the status information from the core server. The status information may include or indicate an amount due associated with the first agreement, one or more distribution amounts, one or more fee amounts, other information associated with or indicated by the first entry, or a combination thereof. The server can send the status information to the first device or the second device to a device of the user that initiated the status request.

In some implementations, the server generates, based on one or more entries of the database, historical data associated with a user, such as the first user or the second user. The historical data may include an aggregation of data from the one or more entries, a result of one or more analysis of the one or more entries, or a combination there. For example, based on the historical data, user information associated with the user, or a combination thereof, the server determining one or more metrics associated with the user. The one or more metrics may include a risk score (e.g., a liability score) associated with the user, an on-time delivery rate associated with the user, a number of defaults of the user, a total volume of product sold or received by the user, one or more quality indicators of the product produced by the user, or a combination thereof. In some implementations, the historical data and/or the one or more metrics may have a standard format, or the server may generate a report (e.g., a standardized report) that includes or indicates the historical data, the one or more metrics, or a combination thereof. Additionally, or alternatively, the server may provide the historical data, the one or more metrics, the user information, a combination thereof, or a report thereof, to another entity, such as the user or another user, the core server, the financial institution, another entity (e.g., an insurance provider, a seller, a lender, etc.), or a combination thereof.

In some implementations, the server may use the historical data, the one or more metrics, the risk score, the user information, or a combination thereof, to determine one or more fees associated with the user (e.g., the first user or the second user). For example, the lower the risk score, the lower a fee may be. As another example, the risk score may be used as a weight value that is applied to a standard fee to determine a fee for a user. Additionally, or alternatively, the server may, for at least one service of a set of services, determine a respective fee based on the one or metrics associated with the user, and send, to a device of the user, an indication of the service and the respective fee. For example, the service may be an insurance product, such as an insurance product associated with the first agreement.

In some implementations, the server may generate one or more reports associated with the first agreement. For example, based on execution and completion of the first agreement, the server may generate a summary report of payments and distributions, one or more fees, or a combination thereof. In some such implementations, the report may include a regulatory report, a compliance report, a tax report, or a combination thereof, that is associated with the first agreement, one or more users associated with the first agreement, or a combination thereof.

Referring to FIG. 30, FIG. 30 is a flow diagram illustrating an example process 3000 of a server that supports operation of a clearance system according to one or more aspects. Operations of the process 3000 may be performed by a server, such as the clearance server 116 described above with reference to FIG. 1 or 2 and/or the core server 250 described above with reference to FIG. 2. The clearance system may include or correspond to at least one or more aspects of the system 100 or 200.

At block 3002, the server identifies a financial account at an institution server, the financial account associated with a first agreement between a first user and a second user. The first user is a beneficiary of the financial account, and an entity associated with the core server has agency over the financial account. For example, the institution server may include or correspond to the institution server 105. The first agreement data may include or correspond to the agreement information 110. In some implementations, the first agreement includes or corresponds to a contract.

In some implementations, the first user includes or corresponds to the producer associated with the producer device 102, and the second user includes or corresponds to the offtaker associated with the offtaker device 130. In some other implementations, the first user includes or corresponds to the offtaker associated with the offtaker device 130, and the second user includes or corresponds to the producer associated with the producer device 102.

At block 3004, the server identifies a transfer made to the financial account. For example, the transfer may include or correspond to the transfer 192. Additionally, or alternatively, the transfer is performed from a second account associated with the second user to the financial account. In some implementations, to identify the transfer, the server may receive a transfer notification (e.g., the transfer notification 194) from the institution server, or the server may monitor the financial account, such as by using an API of the institution server.

In some implementations, to identify the transfer, the server receives a transfer request (e.g., the transfer 292) from a device associated with the second user. The server may then initiate, based on the transfer request, the transfer to the financial account.

At block 3006, the server, based on identification of the transfer, sends, to the institution server, a request to perform one or more disbursements from the financial account, the one or more disbursements determined based on a first entry in a database. For example, the request may include or correspond to the disbursement information 260. The database may include or correspond to the database 126. The first entry may include or correspond to the entry 3880. The first entry is associated with the first agreement and indicates the first user, the second user, first agreement data associated with the first user, the financial account, or a combination thereof. For example, the entry may include or indicate entry information associated with the first agreement. The entry information may include or indicate the first entry includes entry information associated with the first agreement, the entry information indicates one or more payment amounts, one or more fees, or a combination thereof. In some examples, at least a portion of the entry information is immutable. In some implementations, the database includes a blockchain ledger that stores the first entry, and the first entry includes a smart contract based on the first agreement.

In some implementations, the server obtains an indicator that indicates the one or more disbursements. For example, the indicator may be obtained (e.g., received) from another device or server, such as the database 126 or the clearance server 116. To illustrate, the server may access the database to obtain at least the portion of the entry information. The server may send the request (to perform one or more disbursements) to the institution server based on or in response to receipt of the indicator.

At block 3008, the server sends a notification that indicates a first disbursement to a first account associated with the first user. For example, the server may send the notification to a device of the first user, to the database (to be stored at the first entry), to a clearance server, to a device of the second user, or a combination thereof.

In some implementations, the server identifies, based on the entry information, a third user associated with the first agreement. For example, the third user may include or correspond to the recipient associated with the recipient device 140. In such examples, the one or more disbursements include a second disbursement to a third account associated with the third user. Additionally, or alternatively, the server may determine, based on the entry information, a fee associated with first agreement, a fee associated with another agreement (related to or linked to the first agreement), or a combination thereof. In some examples, the one or more disbursements include a third disbursement to a fourth account associated with an entity associated with the clearance server, the server, or the institution server. The third disbursement may be based on the fee, such as a service fee, a regulatory fee, or a combination thereof.

In some implementations, the server receives, from the clearance server, a first indicator that indicates first user information associated with the first user, a request to create the financial account associated with the first agreement, or a combination thereof. In some implementations, the server receives, from a clearance server, a request to verify the first user. In some such implementations, the request includes or indicates first user information associated with the first user. The server may send, to the institution server, at least a portion of the first user information and receive, from the institution server and based on at the portion of the first user information, a verification response that indicates that the first user is verified or not verified. If the first user is verified, the server can send, to the clearance server, an indicator that indicates the first user is verified. Additionally, or alternatively, in some implementations, the server may send, to the institution server, an account creation request. For example, the account creation request may include or correspond to the account request 172. In some examples, the account creation request may be sent via an application programming interface (API) of the institution server.

The server may receive, from the institution server, an identifier associated with the financial account. For example, the identifier may include or correspond to the account ID 174. The indicator may include or indicate an account number of the financial account, a routing number associated with the financial account, a name of an entity that provides the financial account, a name of a beneficiary of the financial account, a quick response (QR) code or barcode associated with the financial account, or a combination thereof. The server can send the indicator to the clearance server, the payor (e.g., the second device associated with the second user), store the indicator at the first entry, or a combination thereof.

In some implementations, the server obtains, from the institution server, a confirmation of performance of the one or more disbursements. Additionally, or alternatively, the server can send, to the institution server and based on the confirmation, a request to close the financial account. The request to close the financial account may include or correspond to the closure request 262. To illustrate, the server may receive the confirmation and access the first entry of the database to determine whether the first agreement has been satisfied (e.g., whether a status of the first entry indicates completed or satisfied). If the first agreement is satisfied, the server may send the request to close the financial account.

In some implementations, the server receives, from the clearance server, a status request associated with the first agreement. Responsive to the status request, the server can access the database to obtain at least a portion of the entry information based on the first entry. The server may generate status information based on the entry information and send the status information to the clearance server. The status information may include or indicate an amount due associated with the first agreement, one or more distribution amounts, one or more fee amounts, or a combination thereof.

It is noted that one or more blocks (or operations) described with reference to FIG. 2, 9, 26, 29, or 30 may be combined with one or more blocks (or operations) described with reference to another of the figures. For example, one or more blocks (or operations) of FIG. 2 may be combined with one or more blocks (or operations) of FIG. 9. As another example, one or more blocks (or operations) of FIG. 2 may be combined with one or more blocks (or operations) of FIG. 29. As another example, one or more blocks associated with FIG. 2 or 9 may be combined with one or more blocks (or operations) associated with FIG. 29 or 30. Additionally, or alternatively, one or more operations described above with reference to FIGS. 3-8, 10-25, 27, or 28 may be combined with one or more operations described with reference to FIG. 1A, 1B, 2, 9, 26, 29, or 30. Additionally, or alternatively, one or more operations described above with reference to FIG. 1 or 1B may be combined with one or more operations described with reference to FIGS. 2-38.

Referring to FIG. 38, a block diagram of an example of the database 126 of a clearance system according to one or more aspects. The clearance system may include or correspond to the system 100 or 200.

The database 126 includes the users 1810, device information 3838, the bank account information 1910, the agreement information 2110, the financial account information 2112, sensor information 3840, and an entry 3880. The entry may include or correspond to the entry (e.g., the first entry), as described herein at least with reference to FIGS. 1, 2, 29, and 30. The device information 3838 may include or indicate a device ID, a registered device ID, a device type (e.g., smart phone, laptop, desktop, etc.), a manufacturer, an operating system, or a combination thereof. The sensor information 3840 may include or indicate, for a sensor, a senor ID, a sensor location, a sensor owner, a sensor signature, certification results of a sensor, lab certification and/or test results, sensor data received from the sensor, or a combination thereof.

In some implementations, information (e.g., data) stored in the users 1810, the device information 3838, the bank account information 1910, the agreement information 2110, the financial account information 2112, sensor information 3840, and/or an entry 3880 may have a unique reference number (e.g., an index value, a reference value, an address value, or a combination thereof). The clearance server 116 and/or the database 126 may link or associate information based on the unique reference numbers. For example, a user indicated by the users 1810 may include a first unique reference number of a device included in the device information 3838.

In some implementations, each user indicated in the users 1810 may have respective user access rights (e.g., read access rights, write access rights, or a combination thereof). The user access rights may indicate the same or different access rights for the users 1810, the device information 3838, the bank account information 1910, the agreement information 2110, the financial account information 2112, the sensor information 3840, and/or the entry 3880.

The entry 3880 may include or indicate a buyer 3891, a seller 3892, a contract ID 3893, a financial account ID 3894, and a smart contract 3895. Although the entry 3880 is described as including the smart contract 3895, in other implementations, the entry 3880 may not include the smart contract 3895. In some implementations, the entry 3880 may optionally include a payee 3896, tracking information 3897, or a combination thereof.

The buyer 3891 may be populated based on or reference the users 1810, the device information 3838, the bank account information 1910, or a combination thereof. The seller 3892 may be populated based on or reference the users 1810, the device information 3838, the bank account information 1910, or a combination thereof. The payee 3896 may be populated based on or reference the users 1810, the device information 3838, the bank account information 1910, or a combination thereof.

The contract ID 3893 may be populated based on or reference the agreement information 2110. The financial account ID 3894 may be populated based on or reference the financial account information 2112. The tracking information 3897 may be populated based on or reference the sensor information 3840.

The smart contract 3895 may be generated based on the users 1810, the bank account information 1910, the agreement information 2110, the financial account information 2112, or a combination thereof. In some implementations, one or more operations of the smart contract 3895 may be triggered or executed based on the financial account information 2112, the sensor information 3840, or a combination thereof.

In some implementations, the database 126 may include the ledger 127. The ledger 127 may include the users 1810, the device information 3838, the bank account information 1910, the agreement information 2110, the financial account information 2112, the sensor information 3840, and the entry 3880. In a particular implementation, the ledger 127 includes one or more entries (including the entry 3880) that are immutable. The entry 3880 may be generated or populated based on at least the users 1810, the device information 3838, the bank account information 1910, the agreement information 2110, the financial account information 2112, the sensor information 3840, or a combination thereof.

In some embodiments of FIGS. 1-38, an individual or entity that sends or transfers money may be referred to as a remitter. A person or entity that has a legal right or interest in a property may be referred to as a lien holder. A legal document that entitles a recipient to a future payment, including a promissory note, a forward contract, an invoice, a debenture. may be referred to as a contract. Financial accounts (e.g., fiduciary accounts) are dedicated accounts and have a 1 to 1 relationship with a contract. A financial account's primary purpose is to distribute payments received from the remitter to the recipient and assignee(s). After full settlement of the account, it is closed. A financial institution (e.g., Banco do Brasil) that holds the financial account may be referred to as a bank. An individual or entity that receives money from the remitter into a financial account may be referred to as a recipient. An individual or entity designated to receive payment on behalf of another from the financial account may be referred to as an assignee. An individual or entity that is the ultimate recipient of the payment rights, having received these rights after potentially multiple transfers or assignments from the original payee or recipient, may be referred to as a final assignee. A legally binding contract signed by the remitter, the recipient, and the bank, and that includes a summary of the original contract between the recipient and the remitter, and serves as an acknowledgement that the contract is valid and enforceable, may be referred to as a notification of credit assignment (e.g., a notice). A document (e.g., a legally binding agreement signed by the remitter and the recipient) that authorizes the disbursement of funds from a financial account to a specified assignee may be referred to as a payment assignment agreement. A graphic user interface for the platform (e.g., the clearance server 116) may be referred to as an app. Support staff (e.g., employees or agents) of an entity that manages the app and/or the clearance server 116 and account executives associated with facilitating financial account setup, verification of documents and assisting in obtaining signatures, may be referred to as a back office staff. An individual that engages with the app to access its services, features, or content may be referred to as a user.

With reference to one or more of the embodiments disclosed herein, such as with reference to the system 200 of FIG. 1B, the clearance server 116 may be configured to assist one or more users (e.g., a remitter, a recipient, an assignee, a producer, an offtaker, or a combination thereof). For example, the clearance server 116 may assist the user through one or more communications (e.g., notifications, requests, or instructions) to identify another participant, confirm a contract or agreement, generate a smart contract, or a combination thereof. The clearance server 116, and optionally the back-office features of the clearance server 116, may ensure documents are in place before a settlement process gets started and may streamline a contract settlement process.

The clearance server 116 may be configured to obtain and/or aggregate transactional data associated with a user. To illustrate, the clearance server 116 is able to determine historical data (e.g., agreements, parties involved in agreements, terms, payments, settlements, etc.) for a user that would not otherwise be available to the user and/or to a third party other than the user. In some examples, the historical data may provide an alternative or an improvement to obtaining a credit report. In some implementations, the clearance server 116 may be configured to generate (e.g., calculate) a score, such as a credit score, based on the data associated with a user. Based on the data obtained by the clearance server 116, a user may be able to obtain loans more easily from the bank and/or from an assignee. The opportunity to obtain financing and/or a loan based on the data obtained by the clearance server 116 may empower a user by eliminating the need to request credit assignments from other parties, which can place the user in a position of vulnerability vis-à-vis their debtors. Additionally, the bank and/or an assignee may benefit by having historical data and/or a credit score of the user that the bank or assignee would not typically have. For example, the bank and/or assignee may reduce or eliminate a risk of default by having access to the data from the clearance server 116.

Through use of the clearance server 116 (and/or, optionally, the core server 250), an assignee may be able to lower the risk of non-payment. For example, the use of the financial account may provide certainty that the assignee will receive payment once the financial account is funded by ensuring that another user (that owes the assignee) may not interfere with after the financial account is funded. Additionally, the assignee may gain transparency on the order of payment (cash waterfall) and/or receive a notification of notice of any issues, such as another or new lien holder, that may impede payment to the assignee. The clearance server 116 (and/or the core server 250) may also enable the assignee to more easily apply for loans and/or reassign their payment to another user.

Through use of the clearance server 116 (and/or the core server 250), an assignee may be able to participate in new transactions currently taking place outside of the bank. For example, the clearance server 116 (and/or the core server 250) may provide a process flow that is not present in conventional financial systems. The ability of the bank to be involved in the process flow may provide additional information/data to the bank regarding individual users, create new revenue streams, increase competitive differentiation and relevance in marketplace due to innovative products, or a combination thereof.

In some implementations, the clearance server 116 and/or the core server 250 (e.g., the tariff module 253) may be configured to implement a fee (e.g., a cost). The fee may be applied based on one or more services or operations provided by the clearance server 116 and/or the core server 250, and/or may be applied/implemented to funds provided to the financial account. In some examples, a user can be charged a fee to set up a financial account. However, if the user obtains financing through the clearance server 116 (e.g., the app) and/or adds an assignee, then the fee is waived, and the service is free for the user. Additionally, or alternatively, an assignee may be charged a fee that is applied to a portion of funds from the settlement for the assignee, a loan success fee is paid by lenders who provide loans to users, or a combination thereof. Fees for one or more parties may be reduced or eliminated based on an amount of funds provided to the financial account, a frequency of use of the clearance server 116 for agreements, etc.

In some implementations, the clearance server 116 that supports the app is configured to interact with the institution server 150 (e.g., a financial institution or the bank). For example, the clearance server 116 may interact with an endpoint or API of the institution server 150 to authenticate a user, manage an account with the financial institution, initiate a money transfer or settlement of a financial account, or a combination thereof. It is noted that in some implementations, a transfer of funds out of or a closing of a financial account may be controlled by the clearance server 116 and/or the core server 250—e.g., one or more parties to receive funds from the financial account may not be able to (directly) initiate a transfer of funds out of the financial account or close the financial account. However, one or more parties associated with the financial account may be able to view information (e.g., a report and/or a balance) associated with the financial account via the app.

In an illustrative example, a user is the recipient associated with a transaction and has an existing unpaid contract with a remitter. The user may log into the app. For example, the user may log into the app using bank login credentials of the user. While using the app, the user may have a GUI (e.g., a dashboard) that includes or indicates one or more contracts and corresponding financial accounts. Additionally, the user may have the ability to create a new financial account via the app. To create the new financial account the user may upload a contract or term sheet. The user may fill out a form (via the app) with information pertaining to the contract and with information about the remitter associated with the contract. In some implementations, the remitter may be contacted via the app to confirm the contract. Additionally, or alternatively, the app (e.g., the clearance server 116 and/or the core server 250) may generate a notice document and automatically send out a request for digital signatures from the recipient, the remitter, and the bank. It is noted that in other implementations, the remitter may log into the app and upload the contract in order for the financial account to be created.

Based on the contract, the app may create a new dedicated financial account in the bank (e.g., the financial institution associated with the institution server 150). The financial account may include or correspond to the contract. The financial account may be opened before or after the notice document is fully executed by the remitter, the recipient, and the bank. In such implementations, the financial account that is created may be inactive until after the notice document is fully executed. After notice document is fully executed, the financial account is active and ready to receive payment from the remitter (or another party). It is noted that the financial account may have one or more statuses, such as active, inactive, in consultation, suspended, closed, blocked or locked, unlocked, or another status.

The user may have the ability to add an assignee. For example, using the app, the user may select a particular active financial account, and may select an option (via the app) to ‘add assignee’, such that the added assignee will receive a payment from the selected financial account. After selecting the add option, the user may fill out a form with information on the payment destination, amount, and assignee contact information. The app may generate a payment assignment agreement using the information collected in the form. This agreement is automatically sent for digital signature collection from the receiver and the assignee. After the full execution of the agreement via the app, the assignee is added with full effect. In some such examples, the executed payment assignment agreement is stored at the ledger 127 in association with the contract and/or financial account.

After the financial account is created and activated, funds may be deposited in the financial account. The app (e.g., the clearance server 116 and/or the core server 250) may receive a notification via an endpoint or API of the institution server 150 of payment into the financial account. Additionally, or alternatively, the app (e.g., the clearance server 116 and/or the core server 250) may provide a notification (e.g., a push notification) to the recipient, the remitter, one or more assignees, or a combination thereof, of confirmation of the payment.

The clearance server 116 and/or the core server 250 may initiate a distribution process from the financial account according to the order and instruction defined in the setup process and/or additions (e.g., a payment assignment agreement) associated with the contract. In some implementations, the app (e.g., the clearance server 116 and/or the core server 250) may send a settlement notification to one or more parties associated with the financial account. It is noted that the distribution process may also include applicable fees and/or tariffs being applied to the funds and transferred to an appropriate account(s). After the transfer of funds, the clearance server 116 and/or the core server 250 may determine whether or not the contract is satisfied (e.g., all payment amounts are resolved) or is still outstanding. Based on a determination that the contract is satisfied, the clearance server 116 and/or the core server 250 requests/instructs the institution server 150 to close the financial account.

Certain features that are described in this specification in the context of separate implementations also can be implemented in combination in a single implementation. Conversely, various features that are described in the context of a single implementation also can be implemented in multiple implementations separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

Those of skill in the art would understand that information, message, and signals may be represented using any of a variety of different technologies and techniques. For example, data, instructions, commands, information, and signals that may be referenced throughout the above description may be represented by voltages, currents, electromagnetic waves, magnetic fields or particles, optical fields or particles, or any combination thereof.

Components, the functional blocks, and the modules described herein with the figures include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. The various illustrative logics, logical blocks, modules, circuits and algorithm processes described in connection with the implementations disclosed herein may be implemented as electronic hardware, computer software, or combinations of both. In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Additionally, the operations of a method or algorithm may reside as one or any combination or set of codes and instructions on a machine readable medium and computer-readable medium, which may be incorporated into a computer program product.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise.

The term “about” as used herein can allow for a degree of variability in a value or range, for example, within 10%, within 5%, or within 1% of a stated value or of a stated limit of a range, and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes 0.1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. Unless stated otherwise, the word or as used herein is an inclusive or and is interchangeable with “and/or,” such that when “or” is used in a list of two or more items, means that any one of the listed items can be employed by itself, or any combination of two or more of the listed items can be employed. To illustrate, A, B, or C includes: A alone, B alone, C alone, a combination of A and B, a combination of A and C, a combination of B and C, or a combination of A, B, and C. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”). As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any implementation of any of the systems, methods, and article of manufacture can consist of or consist essentially of—rather than comprise/have/include—any of the described steps, elements, or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”.

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

The claims are not intended to include, and should not be interpreted to include, means-plus- or step-plus-function limitations, unless such a limitation is explicitly recited in a given claim using the phrase(s) “means for” or “step for,” respectively.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure and following claims are not intended to be limited to the examples and designs described herein but is to be accorded the widest scope consistent with the principles and novel features disclosed herein.

1. A method for implementing a clearance service, the method comprising:
obtaining first agreement data associated with a first agreement between a first user and a second user;
verifying that the first agreement data associated with the first agreement is valid based on:
a first input received from a first device associated with the first user;
a second input received from a second device associated with the second user; or
a combination thereof;
after verification of the first agreement, sending a request to create, at an institution server, a financial account associated with the first agreement; and
storing, at a database, first entry information at a first entry associated with the first agreement, wherein the first entry information indicates the first user, the second user, the first agreement data, the financial account, or a combination thereof.

2. The method of claim 1, further comprising:
generating a smart contract based on the first agreement,
wherein:
the database includes a blockchain ledger that stores the first entry; and
the first entry includes the smart contract;
at least a portion of the first entry is immutable;
the first agreement is further between the first user, the second user, and an entity associated with the institution server;
the first input includes a first digital signature and the second input includes a second digital signature; and
obtaining the first agreement data includes receiving the first agreement data from the first device or generating the first agreement data.

3. (canceled)

4. The method of claim 1, further comprising:
after verification of the first agreement, initiating formation of a second agreement associated with use of the financial account in association with the first agreement, the second agreement between the first user, the second user, and an entity associated with the institution server, wherein prior to verification of the second agreement, the financial account has a reserved status;
verifying that the second agreement is complete;
storing, at the database, second agreement data at the first entry, wherein the second agreement data is associated with the second agreement; and
after verification of the second agreement, sending, to the institution server, a status change request to change the financial account from the reserved status to an active status.

5. The method of claim 4, further comprising:
generating a first version of the second agreement based on the first agreement, the financial account, or a combination thereof; and
sending, to each of the first user, the second user, and the entity, a request to sign the first version of the second agreement,
wherein the verified second agreement is a second version of the second agreement that is signed by each of the first user, the second user, and the entity.

6-7. (canceled)

8. The method of claim 1, further comprising:
receiving, from the first device associated with the first user, first user information associated with the first user, wherein the first user information indicates:
a first bank account associated with the first user, and
a name of the first user, a company associated with the first user, a birthday of the first user, a nationality of the first user, a government identification number associated with the first user, an email address associated with the first user, a phone number associate with the first user, a fax number associated with the first user, an address associated with the first user, or a combination thereof; and
storing, at the database, first bank account information that indicates the first bank account a bank name, an account type, a holder name, or a combination thereof, and
wherein the first agreement indicates that the second user owes the first user a payment amount.

9. The method of claim 1, further comprising:
receiving, from the second device associated with the second user, second user information associated with the second user, wherein the second user information indicates a second bank account associated with the second user;
storing, at the database, second bank account information that indicates the second bank account, and wherein the first agreement indicates that the second user owes the first user a payment amount;
receiving, from a third device associated with a third user, third user information associated with the third user, wherein the third user information indicates a third bank account associated with the third user;
storing, at the database, third bank account information that indicates the third bank account
receiving, from the third device associated with the third user, a payment request associated with the first agreement, wherein the payment request includes document data, a request amount, or a combination thereof;
sending, to a first user device associated with the first user, an approval request based on the payment request;
receiving, from the first user device, an approval message responsive to the approval request; and
updating the first entry to indicate that the third user is to receive a portion of the payment amount paid by the second user in accordance with the first agreement.

10-14. (canceled)

15. The method of claim 1, further comprising:
identifying the financial account at the institution server, the financial account associated with the first agreement between the first user and the second user;
determining, based on the first entry in the database, one or more disbursements from the financial account, the one or more disbursements including a first disbursement to a first account associated with first user, wherein the first entry is associated with the first agreement;
sending, to the institution server, a request to perform the one or more disbursements;
sending a notification that indicates the first disbursement to the first account associated with the first user;
receiving, from the institution server, a transfer request notification of a transfer request associated with the second user; and
receiving, from the institution server, a transfer completion notification that indicates completion of a transfer to the financial account based on the transfer request;
the transfer completion notification is received prior to delivery, from the first user to the second user, of an object associated with the first agreement; and
determining the one or more disbursements is performed based on identification of a change in status of the object indicated by the first entry.

16-18. (canceled)

19. The method of claim 1, further comprising:
receiving, from the institution server, an indicator associated with the financial account, wherein the indicator includes an account number of the financial account, a routing number, a quick response (QR) code, or a combination thereof;
sending the indicator to the second device associated with the second user; and storing the indicator at the first entry.

20-24. (canceled)

25. The method of claim 1, further comprising:
sending, to a core server, a first indicator that indicates first user information associated with the first user;
sending, to the core server, a request to verify the first user;
receiving, from the core server, an indicator that indicates the first user is verified
sending, to the core server, a request to create the financial account associated with the first agreement;
receiving, from the core server, an identifier associated with the financial account; and
sending the identifier to a device associated with the second user, the database for storage at the first entry, or a combination thereof.

26. (canceled)

27. The method of claim 1, further comprising:
receiving, from the first device or the second device, a status request associated with the first agreement;
accessing the database to obtain first entry information based on the first entry;
obtaining status information based on the first entry information, wherein the status information indicates an amount due associated with the first agreement, one or more distribution amounts, one or more fee amounts, or a combination thereof; and
sending the status information to the first device or the second device.

28-29. (canceled)

30. The method of claim 1, further comprising:
receiving sensor data associated with an object to be provided from the first user to the second user in accordance with the first agreement;
storing, based on the sensor data, a status to the first entry; and
determining, based on the status, the sensor data, or a combination thereof, whether to indicate one or more distributions associated with the financial account.

31-44. (canceled)

45. A system comprising:
a clearance server configured to:
obtain first agreement data associated with a first agreement between a first user and a second user;
verify that the first agreement data associated with the first agreement is valid based on:
a first input received from a first device associated with the first user;
a second input received from a second device associated with the second user; or
a combination thereof;
based on verification of the first agreement, send a request to create, at an institution server, a financial account associated with the first agreement; and
store, at a database, first entry information at a first entry associated with the first agreement, wherein the first entry information indicates the first user, the second user, the first agreement data, the financial account, or a combination thereof.

46. The system of claim 45, further comprising:
a core server communicatively coupled to the clearance server via a network, the core server configured to:
identify the financial account at the institution server, wherein the first user is a beneficiary of the financial account, and wherein an entity associated with the core server has agency over the financial account;
identify a transfer made to the financial account;
after identification of the transfer, send, to the institution server, a request to perform one or more disbursements from the financial account, the one or more disbursements determined based on a first entry in a database, wherein the first entry is associated with the first agreement and indicates the first user, the second user, the first agreement data, the financial account, or a combination thereof; and
send a notification that indicates a first disbursement to a first account associated with the first user.

47-69. (canceled)

70. The system of claim 45, wherein:
the request to create the financial account associated with the first agreement is sent to the institution server via a core server; and
the clearance server is further configured to:
sending, to a core server, a request to verify the first user, wherein the request includes first user information associated with the first user;
receiving, from the core server, an indicator that indicates the first user is verified; and
receive, from the core server, a notification that indicates a first disbursement from the financial account to a first account associated with the first user.

71-74. (canceled)

75. The system of claim 45, wherein the clearance server is further configured to:
receive, from the first device or the second device, a status request associated with the first agreement;
access the database to obtain first entry information based on the first entry;
in response to receiving the status request, send, to a core server, a status information request;
receive status information from the core server in response to the status information request, wherein the status information is based on the first entry information, and wherein the status information indicates an amount due associated with the first agreement, one or more distribution amounts, one or more fee amounts, or a combination thereof; and
send the status information to the first device or the second device.

76-78. (canceled)

79. A server comprising:
a memory storing processor-readable instructions; and
at least one processor coupled to the memory, the processor configured to:
identify a financial account at an institution server, the financial account associated with a first agreement between a first user and a second user, wherein the first user is a beneficiary of the financial account and an entity associated with the server has agency over the financial account;
identify a transfer made to the financial account;
based on identification of the transfer, send, to the institution server, a request to perform one or more disbursements from the financial account, the one or more disbursements determined based on a first entry in a database, wherein the first entry is associated with the first agreement and indicates the first user, the second user, first agreement data associated with the first user, the financial account, or a combination thereof; and
send a notification that indicates a first disbursement to a first account associated with the first user.

80-82. (canceled)

83. The server of claim 79, wherein the processor is further configured to:
access the database to obtain at least a portion of entry information, wherein the entry information indicates one or more payment amounts, one or more fees, or a combination thereof, and wherein the transfer is performed from a second account associated with the second user to the financial account; and
identify, based on the entry information, a third user associated with the first agreement, wherein the one or more disbursements include a second disbursement to a third account associated with the third user.

84. (canceled)

85. The server of claim 83, wherein the processor is further configured to:
access the database to obtain at least the portion of the entry information, wherein the entry information indicates one or more payment amounts and one or more fees, and wherein the transfer is performed from a second account associated with the second user to the financial account; and
determine, based on the entry information, a fee associated with the first agreement, wherein the fee includes a service fee, a regulatory fee, or a combination thereof, and
wherein the one or more disbursements include a third disbursement to a fourth account associated with an entity associated with a clearance server, the server, or the institution server, and
wherein the third disbursement is based on the fee.

86-87. (canceled)

88. The server of claim 79, wherein the processor is further configured to:
receive, from a clearance server, a first indicator that indicates first user information associated with the first user;
receive, from the clearance server, a request to create the financial account associated with the first agreement;
send, to the institution server, an account creation request, wherein the account creation request is sent via an application program interface (API) of the institution server;
receive, from the institution server, an identifier associated with the financial account, wherein the identifier associated with the financial account includes an account number, a routing number, a bank name, a beneficiary name, a quick response (QR) code, or a combination thereof;
send, to the clearance server, a device associated with the second user, the database for storage at the first entry, or a combination thereof, the identifier;
obtain, from the institution server, a confirmation of performance of the one or more disbursements; and
send, to the institution server and based on the confirmation, a request to close the financial account.

89-90. (canceled)

91. The server of claim 79, wherein the processor is further configured to:
receive, from a clearance server, a request to verify the first user, wherein the request includes first user information associated with the first user;
send, to the institution server, the first user information;
receive, from the institution server and based on the first user information, a verification response that indicates that the first user is verified;
send, to the clearance server, an indicator that indicates the first user is verified;
receive, from the clearance server, a status request associated with the first agreement;
access the database to obtain entry information based on the first entry;
generate status information based on the entry information, wherein the status information indicates an amount due associated with the first agreement, one or more distribution amounts, one or more fee amounts, or a combination thereof; and
send the status information to the clearance server.

92. (canceled)
